(19) United States
(12) Patent Application Publication
(10) Pub. No.: US 2026/0116000 A1
(43) Pub. Date: Apr. 30, 2026

(54) Additive 3D Manufacturing Using Light-Cured Resin

(71) Applicant: Grow OTB Ltd., Modi'in-Maccabim-Re'ut (IL)

(72) Inventor: Gil LITICHEVER, Modi'in-Maccabim-Re'ut (IL)

(21) Appl. No.: 19/141,098

(22) PCT Filed: Feb. 15, 2024
(86) PCT No.: PCT/IL2024/050180

§ 371 Date: Jun. 19, 2025

Related U.S. Application Data
(60) Provisional application No. 63/450,680, filed on Mar. 8, 2023.

(51) Int. Cl. B29C 64/135; B29C 64/336; B29C 64/393; B33Y 10/00; B33Y 40/00; B33Y 50/02

(52) U.S. Cl. CPC B29C 64/135; B29C 64/336; B29C 64/393; B33Y 10/00; B33Y 40/00; B33Y 50/02

(57) ABSTRACT

High speed, accurate, scalable, and dimension-insensitive additive manufacturing of a Three-Dimensional (3D) object may use incrementally solidifying light-sensitive resin layers. A new layer is formed by supplying the resin liquid via a cavity in the formed 3D object, and curing the supplied resin by a focused light beam, such as a laser beam. The added layers are formed by supplying, 2024/184876 using a pump, the light-cured resin fluid to one or more bottom openings to be output from the top opening (or to multiple openings) via a vertical cavity (or multiple cavities) of the 3D object. The curing is by focusing a light beam to the area of the resin output from the top opening, while keeping the top opening non-cured, so that resin can be passed via the cavity. Such 3D printing may be directly applied to any surface, such as a floor, wall, wing structure, or machined part.

### RELATED APPLICATION

This patent application claims priority from U.S. Provisional Application Ser. No. 63/450,680 that was filed on Mar. 8, 2023 and entitled: “3D PRINTING USING PRINTED VOLUME AS MEDIUM FOR RESIN”, which is hereby incorporated herein by reference in its entirety.

### TECHNICAL FIELD

This disclosure generally relates to an apparatus and method for forming Three-Dimensional (3D) objects by 3D printing in which photosensitive materials are cured layer by layer until the final, highly-detailed part is achieved, and in particular to printing layers by curing light-cured resin conveyed via a cavity in the formed 3D object.

### BACKGROUND

Unless otherwise indicated herein, the materials described in this section are not prior art to the claims in this application and are not admitted to be prior art by inclusion in this section.

Additive manufacturing (3D printing) is the construction of a three-dimensional object from a CAD model or a digital 3D model. It can be done in a variety of processes in which material is deposited, joined or solidified under computer control, with the material being added together (such as plastics, liquids or powder grains being fused), typically layer by layer. In one example, a Fused Deposition Modeling (FDM) is a process that uses a continuous filament of a thermoplastic material. Filament is fed from a large spool through a moving, heated printer extruder head, and is deposited on the growing work. The print head is moved under computer control to define the printed shape. Usually, the head moves in two dimensions to deposit one horizontal plane, or layer, at a time; the work or the print head is then moved vertically by a small amount to begin a new layer.

Other methods for 3D printing are SLA (Stereo-lithography) 3d printing. SLA is a form of 3D printing technology used for creating models, prototypes, patterns, and production parts in a layer-by-layer fashion using photo-chemical processes by which light causes chemical monomers and oligomers (a.k.a. resin) to cross-link together to form polymers. Those polymers then make up the body of a three-dimensional solid. Most SLA based 3d printing devices use UV or near UV light sources, while there are devices that use other light sources in other wavelengths. SLA printers may include laser-based printers. DLP projector-based printer using DLP projector as a light source (for example acer p1266 DLP projector). Other methods for 3D printing, include, Selective Laser Sintering (SLS): SLS uses a laser to sinter powdered material, such as plastic or metal, creating solid structures. This technique is capable of producing parts with complex geometries and does not require support structures.

Practicalities and potential of 3D printing, resin, DLP, SLA, slicing software, additively manufacturing, additive layer manufacturing, photopolymer, and photopolymerization, are described in a book by Christopher Barnatt published 2016 by ExplainingTheFuture.com entitled: “3D PRINTING” (Third Edition), which is incorporated in its entirety for all purposes as if fully set forth herein.

Seven current categories of additive manufacturing printing methods used are described in a book entitled by Element14 published January 2023 and entitled: “The State of 3D Printing in 2023” by Newark Corporation [WF-3174410], which is incorporated in its entirety for all purposes as if fully set forth herein. These include stereolithography (SLA), Selective Laser Sintering (SLS), Fused Deposition Modeling (FDM), Direct Metal Laser Sintering (DMLS), PolyJet 3D Printing, Binder Jetting, and Continuous Liquid Interface Production (CLIP). 3D printing is a process of making three-dimensional solid objects from a digital file. The process involves melting a material (plastic, metal, or other) and depositing it layer-by-layer according to the object's shape. The material is melted using a laser, an electron beam, or another heat source, and then applied to the desired shape. This process is repeated until the entire object is created. After the creation of the object is complete, it can be polished or finished as desired.

Stereolithography. Stereolithography (known as SLA, SL, vat photopolymerization, optical fabrication, photo-solidification, or resin printing) is a form of 3D printing technology used for creating models, prototypes, patterns, and production parts in a layer-by-layer fashion using photochemical processes by which light causes chemical monomers and oligomers to cross-link together to form polymers. Those polymers then make up the body of a three-dimensional solid. Stereolithography is an additive manufacturing process that, in its most common form, works by focusing an UltraViolet (UV) laser on to a vat of photopolymer resin. With the help of computer aided manufacturing or computer-aided design (CAM/CAD) software, the UV laser is used to draw a pre-programmed design or shape on to the surface of the photopolymer vat. Photopolymers are sensitive to ultraviolet light, so the resin is photochemically solidified and forms a single layer of the desired 3D object. Then, the build platform lowers one layer and a blade recoats the top of the tank with resin. This process is repeated for each layer of the design until the 3D object is complete. Completed parts must be washed with a solvent to clean wet resin from their surfaces.

It is also possible to print objects “bottom up” by using a vat with a transparent bottom and focusing the UV or deep-blue polymerization laser upward through the bottom of the vat. An inverted stereolithography machine starts a print by lowering the build platform to touch the bottom of the resin-filled vat, then moving upward the height of one layer. The UV laser then writes the bottom-most layer of the desired part through the transparent vat bottom. Then the vat is “rocked”, flexing and peeling the bottom of the vat away from the hardened photopolymer; the hardened material detaches from the bottom of the vat and stays attached to the rising build platform, and new liquid photopolymer flows in from the edges of the partially built part. The UV laser then writes the second-from-bottom layer and repeats the process. An advantage of this bottom-up mode is that the build volume can be much bigger than the vat itself, and only enough photopolymer is needed to keep the bottom of the build vat continuously full of photopolymer. This approach is typical of desktop SLA printers, while the right-side-up approach is more common in industrial systems.

A system for generating three-dimensional objects by creating a cross-sectional pattern of the object to be formed at a selected surface of a fluid medium, is described in U.S. Pat. No. 4,575,330 to Hull entitled: “Apparatus for production of three-dimensional objects by stereolithography”, which is incorporated in its entirety for all purposes as if fully set forth herein. The fluid medium is capable of altering its physical state in response to appropriate synergistic stimulation by impinging radiation, particle bombardment or chemical reaction, successive adjacent laminae, representing corresponding successive adjacent cross-sections of the object, being automatically formed and integrated together to provide a step-wise laminar buildup of the desired object, whereby a three-dimensional object is formed and drawn from a substantially planar surface of the fluid medium during the forming process.

Stereolithography (SLA) is an additive manufacturing-commonly referred to as 3D printing-technology, and is described in a guide entitled: “The Ultimate Guide to Stereolithography (SLA) 3D Printing”, published March 2017 by FormLabs in ‘THE ULTIMATE GUIDE TO STEREOLITHOGRAPHY (SLA) 3D PRINTING’, which is incorporated in its entirety for all purposes as if fully set forth herein. The 3D printing converts liquid materials into solid parts, layer by layer, by selectively curing them using a light source in a process called photopolymerization. SLA is widely used to create models, prototypes, patterns, and production parts for a range of industries from engineering and product design to manufacturing, dentistry, jewelry, model making, and education. In this comprehensive guide, you'll learn about the different SLA systems, various materials and their characteristics, and how SLA compares to other technologies on the market.

A process and device for fabricating a three-dimensional object from a light curable liquid resin, by irradiating a light to a surface of the liquid resin to form successive cross-sectional layers of the cured resin superimposed on each other, are described in U.S. Pat. No. 5,139,711 to Nakamura et al. entitled: “Process of and apparatus for making three dimensional objects”, which is incorporated in its entirety for all purposes as if fully set forth herein. An open top enclosure surrounds the entire circumference of the preceding cured layer and a top upper end face of the enclosure is kept at the same horizontal level as that of the preceding cured layer. The liquid resin is supplied over the preceding layer, over the enclosure and into a space defined therebetween in such a manner as to positively overflow a portion of the liquid resin outwardly over the top end of the enclosure, thereby leaving a continuous coat of the liquid resin extending horizontally over from the preceding cured layer and to the enclosure. The continuous liquid resin coat may have a droop only at an outer perimeter of the enclosure such that it can have an equal thickness and flat surface area extending from the top surface of the preceding cured layer to at least the inner periphery of the top face of the enclosure. Thus, an additional cured layer of uniform thickness can be readily formed and superimposed on the preceding layer. The enclosure may be formed by the light irradiation toward the liquid resin so as to self-grow incrementally each time an additional cross-sectional layer is formed.

FIG. 1 of U.S. Pat. No. 5,139,711 that discloses fabricating of a three-dimensional object is shown as a view 10 in FIG. 1. The process utilizes a device including a vessel (VAT) 10″ filled with a light curable resin 20″, a light beam 30″ which is directed to the surface of the liquid resin 20″ (curing surface) to form thereat a cured layer 41″, and a base plate (build plate) connected to an elevator arm 52″ to be vertically movable within the vessel 10″. The liquid resin includes an ultraviolet light curable resin such as denatured polyurethanemethacrylate, oligoesteracrylate, urethaneacrylate, epoxyacrylate, photosensitive polyimide, aminoalkyd, or the like generally utilized in the art for the fabrication of proto-types or product models. The light beam 30″, for example, He—Cd laser beam is directed from a light source 31″ through a shutter 32″, a convergent lens 33″, and scan mirrors (scan head) 34″ to the surface of the liquid resin 20″ so that it can move in X-Y directions to draw any desired two-dimensional pattern or configuration for solidification of the liquid resin into such pattern or configuration.

Resin. The liquid materials used for SLA printing are commonly referred to as “resins” and are thermoset polymers. A wide variety of resins are commercially available and it is also possible to use homemade resins to test different compositions for example. Material properties vary according to formulation configurations: “materials can be soft or hard, heavily filled with secondary materials like glass and ceramic, or imbued with mechanical properties like high heat deflection temperature or impact resistance”. It is possible to classify the resins in the following categories: Standard resins, for general prototyping; Engineering resins, for specific mechanical and thermal properties; Dental and medical resins, for biocompatibility certifications; Castable resins, for zero ash-content after burnout; and Biomaterial resins, formulated as aqueous solutions of synthetic polymers like polyethylene glycol, or biological polymers such as gelatin, dextran, or hyaluronic acid.

SLA uses a UV laser to cure liquid resin into hardened plastic in a process called photopolymerization. Different combinations of monomers, oligomers, photoinitiators, and various other additives that comprise a resin result in different material properties. SLA typically produces parts from thermoset polymers.

Curing is a chemical process employed in polymer chemistry and process engineering that produces the toughening or hardening of a polymer material by cross-linking of polymer chains, reaching the ultimate properties of the finished material. Even if it is strongly associated with the production of thermosetting polymers, the term “curing” can be used for all the processes where a solid product is obtained from a liquid solution, such as with PVC plastisols. During the curing process, single monomers and oligomers, mixed with or without a curing agent, react to form a tridimensional polymeric network. In the very first part of the reaction branches of molecules with various architectures are formed, and their molecular weight increases in time with the extent of the reaction until the network size is equal to the size of the system. The system has lost its solubility and its viscosity tends to infinite. The remaining molecules start to coexist with the macroscopic network until they react with the network creating other crosslinks. The crosslink density increases until the system reaches the end of the chemical reaction.

Curing can be induced by heat, radiation, electron beams, or chemical additives. To quote from IUPAC: curing “might or might not require mixing with a chemical curing agent”. Thus, two broad classes are curing induced by chemical additives (also called curing agents, hardeners) and curing in the absence of additives. An intermediate case involves a mixture of resin and additives that requires external stimulus (light, heat, radiation) to induce curing. The curing methodology depends on the resin and the application. Particular attention is paid to the shrinkage induced by the curing. Usually small values of shrinkage (2-3%) are desirable. A photo-polymer or light-activated resin is a polymer that changes its properties when exposed to light, often in the ultraviolet or visible region of the electromagnetic spectrum. These changes are often manifested structurally, for example hardening of the material occurs as a result of cross-linking when exposed to light.

Standard Resin. Standard resin offers rigid, high-resolution prints with a smooth surface finish. Standard resin is very affordable, which makes it an excellent option for rapid prototyping applications. One exciting aspect of standard SLA resin is that its color has some degree of bearing over its properties. For example, white resin is great for parts that demand a smooth surface finish, whereas gray resin is best for parts with intricate features.

Clear Resin. Clear resin has the ability to be near transparent after post-processing. Clear resin has similar mechanical properties to standard resin, which means it's great for rapid prototypes with intricate details. Additionally, clear resin offers smooth surface finishes. Clear resin is commonly used in applications such as fluidic devices and LED housings.

Engineering SLA Resins. Engineering resins can produce parts and prototypes similar to injection-molded plastic parts. It's important to note that all engineering resins must undergo post-curing under UV light in order to obtain optimal mechanical properties.

Tough Resin. Tough resin is intended for applications that involve high degrees of stress and applied force. In this respect, tough resins are similar to ABS. In fact, parts that are SLA printed with tough resin have tensile strength of 55.7 MPa and a modulus of elasticity of 2.7 GPa—both of which are similar to ABS material. Moreover, tough resins are shatter-resistant, which makes them great for applications such as rugged prototypes or enclosures with snap-fit joints.

Durable Resin. As the name implies, durable resin is extremely resistant to wear and tear. It's also very flexible, which makes its properties similar to that of polypropylene (PP). Additionally, durable resins offer very smooth surface finishes, which makes them a great option for rapid prototyping consumer products, low-friction moving parts, and ball joints.

Heat Resistant Resin. Heat-resistant resins are excellent candidates for SLA 3D printing applications that demand high thermal stability and the toleration of high temperatures. Specifically, heat-resistant resins provide a heat-deflection temperatures between 200-300° C. This property makes them excellent options for mold prototypes, hot fluid flow equipment, heat-resistant fixtures, and casting and thermoforming tooling.

Flexible Resin. Flexible resin enables product and part engineers to mimic rubber parts. As such, flexible resin offers high elongation at break and a low tensile modulus. These properties make this resin an excellent candidate for parts that will be compressed or bent. Moreover, flexible resins are great for ergonomic add-ons to applications such as stamps, packaging, handles, wearable prototyping, grips, and over molds.

Rigid Ceramic-Filled Resin. These resins are reinforced with ceramic particles such as glass, which produces a high degree of rigidity and smooth surfaces in the prints. Plus, rigid resins offer thermal stability and heat resistance. Moreover, these resins offer resistance to deformation over time. These properties make rigid ceramic-filled resins great for applications such as jigs, molds and tooling, fixtures, manifolds, and housings for automotive and electrical components.

Dental and Medical SLA Resins. Class I Biocompatible: Custom Medical Appliances Resin. Class I biocompatible resins are commonly utilized in custom medical equipment applications such as surgical guides. The advantage of SLA parts using Class I biocompatible resins is that they can withstand sterilization from an autoclave, which allows them to be utilized in medical operating rooms. Moreover, these resins offer a high degree of precision and smooth surface finishes, which makes them great for surgical applications. Class Ila Biocompatible: Dental Long-Term Biocompatible Resin. Class Ila biocompatible resins are specifically designed for long-term dental and orthodontic applications. In fact, these resins can be in contact with human bodies for a maximum of one year. These resins are resistant to fracturing, making them ideal for orthodontic retainers.

Castable SLA Resins. Castable Resin Used to Make Jewelry. Castable SLA resins are excellent for 3D printing parts with intricate details and smooth finishes. Additionally, castable resins will burn out cleanly without leaving behind residue. These properties make castable resins great for use in producing small, intricate products such as jewelry.

Water-soluble resin. Water-soluble resin includes a resin polymer that is capable of dissolving in water; and the water-based resin includes both a water soluble resin and a water dispersible resin (or emulsion), and the polymer is dispersed in the water phase in the form of an emulsion, while not swelling. Water-washable 3D printing resins offer quick and easy cleaning by simply washing with water, and are available in a variety of colors and materials and provide high-accuracy and detail for printed parts. They are suitable for various applications, from prototyping and functional parts to creating artwork and jewelry.

An example of a water-soluble resin is ‘3Dresyn Perfect Case WS1 Water Soluble resin’ available from 3Dresyn Resyner Technologies S.L., of Barcelona, Spain. The 3Dresyn Perfect Cast WS1 Water Soluble has these features and benefits: It is ideal for Direct investment Casting (DC); after printing is soluble in water and with steam; is supplied in clear and cyan, magenta, yellow, black and white colors, where cyan, magenta, yellow and especially black provide higher resolution than clear and white; designed for high detail applications; supports high resolution up to 20 microns; is castable with excellent burn out without any imperfections even with cheap gypsums; supports no expansion and contraction imperfections during burn out after resin removal with water or steam; permits easy and clean burn out with negligible residual ash content <0.0001%; having very low viscosity (<30 cps at 25° C.); has fast solubility in water; tack free finishes after light box postcuring; has tensile strength <40 MPa; provides high rigidity (Young modulus >2000 MPa) to permit printing of thin rigid mold walls to maximise solubility speed and minimum resin consumption; is non-brittle at injection temperatures; supports elongation <3%; supports high resolution once tuned to the printer specifications and after full workflow implementation; has very low shrinkage; is printable by most commercial and professional SLA, DLP & LCD 3D printers; provides improved water solubility is achieved with low light power printers, such as standard LCD printers; and is metal and organo-tin free.

Conductive resin. Conductive resin (a.k.a. electrically conductive resin) are electro-conductive resins made up of synthetic resin and a conductive filler, and are used to connect various electrical contacts and for conduction. Such resin can connect multiple electrical contacts simultaneously and make it possible to create an electrical connection in materials that cannot be soldered. Silver, nickel, and carbon are typically used as the electro-conductive fillers, and epoxy resin, urethane resin, silicone resin, and synthetic rubber are used as binders. Conductive resin commonly has excellent dispersibility and stability, without agglomeration issues, of pre /d/ or post added metallic, inorganic and organic conductive and semiconductive materials, for ultra fast additive manufacturing of high-performance electronic devices such as OLEDs, OPVs, OTFTs, PCBs, etc 3D printed at micron resolution (<20-30 microns) with SLA, DLP, LCD and Inkjet 3D printing.

An example of a conductive resin is ‘3D-ADD GrapEK1 Bio’, available from 3Dresyn Resyner Technologies S.L., of Barcelona, Spain. It is a nano-graphene additive resin, which is biocompatible electrically (and thermally) conductive nano-graphene additive for 3D printing conductive materials for electronics, such as antennas for IoT applications (HF, UHF), RFID and NFC tags, OLED, OPVs, flexible PCBs, and flexible cables. Typical achievable values at 5% dosage by weight at 250 microns include a sheet resistance >150 kΩ/square, a resistivity >40 Ω/m, and conductivity <30 mS/m. The ‘3D-ADD GrapEK1 Bio’ provides the featured of: being pre-dispersed conductive graphene additive in powder form; being easy and optimum dispersion in 3D resins with Cowles or vortex mixers at 1500 rpm for 5 minutes, having excellent compatibility with most 3D resins, having improved biocompatibility and conductivity can be achieved when used with: 3Dresyn NSEK Bio; supports Z layer thickness of <20-40 microns (<0.02-0.04 mm) as recommended at high dosages in low power LCD printers; and is compatible and can be mixed and used together with other resins to get synergistic properties of clarity and conductivity.

DLP. Digital Light Processing (DLP) is a set of chipsets based on optical micro-electro-mechanical technology that uses a Digital Micromirror Device (DMD). In DLP projectors, the image is created by microscopically small mirrors laid out in a matrix on a semiconductor chip, known as a digital micromirror device (DMD). These mirrors are so small that DMD pixel pitch may be 5.4 μm or less. Each mirror represents one or more pixels in the projected image. The number of mirrors corresponds to the resolution of the projected image (often half as many mirrors as the advertised resolution due to wobulation). 800×600, 1024×768, 1280×720, and 1920×1080 (HDTV) matrices are some common DMD sizes. These mirrors can be repositioned rapidly to reflect light either through the lens or onto a heat sink (called a light dump in Barco terminology). An Introduction to the Digital Light Processing (DLP™) Technology is described in a paper authored by Lars A. Yoder of Texas Instruments downloaded December 2023 from https://blogs.epfl.ch/mems/documents/119_Intro_Digital_Light_Processing.pdf and entitled: “An Introduction to the Digital Light Processing (DLP™) Technology”, which is incorporated in its entirety for all purposes as if fully set forth herein.

DLP projectors using DLP (Digital Light Processing) elements that use DMD (Digital Micromirror Device) developed by Texas Instruments, Inc. in the United States. Many micromirrors (for example, hundreds of thousands) are integrated on a single chip, and each micromirror is integrated. By turning ON/OFF the digital input signal to the direction, the direction of each micromirror is tilted by about 10° to 12°, and the light reflection direction is switched. An image is drawn by operating the micromirror at a speed of several thousand times per second. A DLP projector can be reduced in size like a liquid crystal projector, and has an advantage that high contrast can be easily obtained because light is attenuated with little reflection. In such a DLP projector, light of each color of R (red), B (blue), and G (green) and possibly white light is projected in a time-sharing manner on a single plate-like spatial light modulator. A single-plate method for projecting a color image, and generally R (red), B (blue), and G (green) light is projected onto each of the three spatial light modulators, and modulated light for each color, and a method of projecting a color image by combining them.

A DMD chip has on its surface several hundred thousand microscopic mirrors arranged in a rectangular array which correspond to the pixels in the image to be displayed. The mirrors and supporting mechanical structures are constructed using surface micromachining. The mirrors can be individually rotated ±10-12°, to an on or off state. In the on state, light from the projector bulb is reflected into the lens making the pixel appear bright on the screen. In the off state, the light is directed elsewhere (usually onto a heatsink), making the pixel appear dark. To produce greyscales, the mirror is toggled on and off very quickly, and the ratio of on time to off time determines the shade produced (binary pulse-width modulation). Some DMD chips can produce up to 1024 shades of gray (10 bits). The mirrors themselves are made of aluminum and are around 16 micrometers across. Each mirror is mounted on a yoke which in turn is connected to two support posts by compliant torsion hinges. In this type of hinge, the axle is fixed at both ends and twists in the middle. Because of the small scale, hinge fatigue is not a problem, and tests have shown that even 1 trillion operations do not cause noticeable damage.

Laser. A laser (an acronym for “Light Amplification by Stimulated Emission of Radiation”) is a technology or device that emits light through a process of optical amplification based on the stimulated emission of electromagnetic radiation, where the term “light” includes electromagnetic radiation of any frequency, not only just the visible light, such as infrared laser, ultraviolet laser, or X-ray laser. A laser differs from other sources of light in that it emits light coherently. Spatial coherence allows a laser to be focused to a tight spot, and further allows a laser beam to stay narrow over great distances (collimation), enabling applications such as laser pointers. Lasers can also have high temporal coherence, which allows them to emit light with a very narrow spectrum, i.e., they can emit a single color of light. Temporal coherence can be used to produce pulses of light as short as a femtosecond. Lasers are distinguished from other light sources by their coherence. Spatial coherence is typically expressed through the output being a narrow beam, which is diffraction-limited. Laser beams can be focused to very tiny spots, achieving a very high irradiance, or they can have very low divergence in order to concentrate their power at a great distance.

Temporal (or longitudinal) coherence implies a polarized wave at a single frequency whose phase is correlated over a relatively great distance (the coherence length) along the beam. A beam produced by a thermal or other incoherent light source has an instantaneous amplitude and phase that vary randomly with respect to time and position, thus having a short coherence length. Lasers are commonly characterized according to their wavelength in a vacuum, and most “single wavelength” lasers actually produce radiation in several modes having slightly differing frequencies (wavelengths), often not in a single polarization. Although temporal coherence implies monochromaticity, there are lasers that emit a broad spectrum of light or emit different wavelengths of light simultaneously. There are some lasers that are not single spatial mode and consequently have light beams that diverge more than is required by a diffraction limit. However, all such devices are classified as “lasers” based on their method of producing light, i.e., stimulated emission. Lasers are typically employed in applications where light of the required spatial or temporal coherence could not be produced using simpler technologies.

Reflection of light is either specular (mirror-like), backscattered, or diffused (retaining the energy, but losing the image) depending on the nature of the interface. In specular reflection the phase of the reflected (or backscattered) waves depends on the choice of the origin of coordinates, but the relative phase between s and p (TE and TM) polarizations is fixed by the properties of the media and of the interface between them. A mirror provides the most common model for specular light reflection, and typically consists of a glass sheet with a metallic coating where the reflection actually occurs. Reflection is commonly enhanced in metals by suppression of wave propagation beyond their skin depths. Reflection also occurs at the surface of transparent media, such as water or glass. In fact, reflection of light may occur whenever light travels from a medium of a given refractive index into a medium with a different refractive index. In the most general case, a certain fraction of the light is reflected from the interface, and the remainder is refracted. Solving Maxwell's equations for a light ray striking a boundary allows the derivation of the Fresnel equations, which can be used to predict how much of the light is reflected (or backscattered), and how much is refracted in a given situation. This is analogous to the way impedance mismatch in an electric circuit causes reflection of signals. Total internal reflection of light from a denser medium occurs if the angle of incidence is above the critical angle. When light reflects off a material denser (with higher refractive index) than the external medium, it undergoes a polarity inversion. In contrast, a less dense, lower refractive index material will reflect light in phase.

When light strikes the surface of a (non-metallic) material, it bounces off in all directions due to multiple reflections by the microscopic irregularities inside the material (e.g., the grain boundaries of a polycrystalline material, or the cell or fiber boundaries of an organic material) and by its surface, if it is rough. Thus, an ‘image’ is not formed, and this is called diffuse reflection. The exact form of the reflection depends on the structure of the material. One common model for diffuse reflection is Lambertian reflectance, in which the light is reflected with equal luminance (in photometry) or radiance (in radiometry) in all directions, as defined by Lambert's cosine law. The light sent to our eyes by most of the objects seen is due to diffuse reflection from their surface, so that this is our primary mechanism of physical observation. Various laser wavelengths and technologies are described in a book by Marvin J. Weber of Lawrence Berkeley National Laboratory published 1999 by CRC Press LLC (ISBN: 0-8493-3508-6) entitled: “Handbook of Laser Wavelengths”, which is incorporated in its entirety for all purposes as if fully set forth herein.

Gas Laser. A gas laser is a laser in which an electric current is discharged through a gas to produce coherent light. The first gas laser, the Helium-neon laser (HeNe), produced a coherent light beam in the infrared region of the spectrum at 1.15 micrometers. The helium-neon (HeNe) laser can be made to oscillate at over 160 different wavelengths by adjusting the cavity Q to peak at the desired wavelength, by adjusting the spectral response of the mirrors or by using a dispersive element (Littrow prism) in the cavity. The efficiency of a CO2 laser is over 10%, and units operating at 633 nm are very common because of their low cost and near perfect beam qualities. Carbon dioxide lasers, or CO2 lasers can emit hundreds of kilowatts at 9.6 μm and 10.6 μm, and are often used in industry for cutting and welding. Carbon monoxide or “CO” lasers have the potential for very large outputs, but the use of this type of laser is limited by the toxicity of carbon monoxide gas. Argon-ion lasers emit light in the range 351-528.7 nm. Depending on the optics and the laser tube a different number of lines is usable but the most commonly used lines are 458 nm, 488 nm and 514.5 nm. A nitrogen transverse electrical discharge in gas at atmospheric pressure (TEA) laser is an inexpensive gas laser producing UV light at 337.1 nm. Copper laser (copper vapor, and copper bromide vapor), with two spectral lines of green (510.6 nm) and yellow (578.2 nm), is the most powerful laser with the highest efficiency in the visible spectrum.

Metal-ion lasers are gas lasers that typically generate ultraviolet wavelengths. Helium-silver (HeAg) 224 nm neon-copper (NeCu) 248 nm and helium-cadmium (HeCd) 325 nm are three examples. These lasers have particularly narrow oscillation linewidths of less than 3 GHZ (0.5 picometers), making them candidates for use in fluorescence suppressed Raman spectroscopy. Examples of gas lasers are Helium-Neon (HeNe) laser operating at 632.8 nm, 543.5 nm, 593.9 nm, 611.8 nm, 1.1523 μm, 1.52 μm, or 3.3913 μm, Argon laser working at 454.6 nm, 488.0 nm, 514.5 nm, 351 nm, 363.8, 457.9 nm, 465.8 nm, 476.5 nm, 472.7 nm, or 528.7 nm, also frequency doubled to provide 244 nm and 257 nm, Krypton laser working at 416 nm, 530.9 nm, 568.2 nm, 647.1 nm, 676.4 nm, 752.5 nm, or 799.3 nm, Xenon ion laser working at visible spectrum extending into the UV and IR, Nitrogen laser working at 337.1 nm, Carbon dioxide laser working at 10.6 μm, or 9.4 μm, and Carbon monoxide laser working at 2.6 to 4 μm or 4.8 to 8.3 μm.

Solid-State Laser. A solid-state laser is a laser that uses a gain medium that is a solid, rather than a liquid such as in dye lasers, or a gas as in gas lasers. Semiconductor-based lasers are also in the solid state, but are generally considered as a separate class from solid-state lasers. Generally, the active medium of a solid-state laser consists of a glass or crystalline “host” material to which is added a “dopant” such as neodymium, chromium, erbium, or ytterbium. Many of the common dopants are rare earth elements, because the excited states of such ions are not strongly coupled with the thermal vibrations of their crystal lattices (phonons), and their operational thresholds can be reached at relatively low intensities of laser pumping. There are hundreds of solid-state media in which laser action has been achieved, but relatively few types are in widespread use. Of these, probably the most common is neodymium-doped yttrium aluminum garnet (Nd:YAG). Neodymium-doped glass (Nd:glass) and ytterbium-doped glasses or ceramics are used at very high power levels (terawatts) and high energies (megajoules) for multiple-beam inertial confinement fusion. The first material used for lasers was synthetic ruby crystals. Ruby lasers are still used for a few applications, but they are not common because of their low power efficiencies. At room temperature, ruby lasers emit only short pulses of light, but at cryogenic temperatures, they can be made to emit a continuous train of pulses.

Some solid-state lasers can also be tunable using several intracavity techniques which employ etalons, prisms, and gratings, or a combination of these. Titanium-doped sapphire is widely used for its broad tuning range, 660 to 1080 nanometers. Alexandrite lasers are tunable from 700 to 820 nm, and they yield higher-energy pulses than titanium-sapphire lasers because of the gain medium's longer energy storage time and higher damage threshold.

Ruby laser typically operates at 694.3 nm, Nd:YAG and NdCrYAG laser typically operates at 1.064 μm or 1.32 μm, Er:YAG laser typically operates at 2.94 μm, Neodymium YLF (Nd:YLF) solid-state laser typically operates at 1.047 and 1.053 μm, Neodymium doped Yttrium orthovanadate (Nd:YVO4) laser operates at 1.064 μm, Neodymium doped yttrium calcium oxoborate Nd:YCa4O(BO3)3 (Nd:YCOB) operates at ˜1.060 μm or ˜530 nm, Neodymium glass (Nd:Glass) laser typically operates at ˜1.062 μm (Silicate glasses) or ˜1.054 μm (Phosphate glasses), Titanium sapphire (Ti:sapphire) laser operates at 650-1100 nm, Thulium YAG (Tm:YAG) laser operates at 2.0 μm, Ytterbium YAG (Yb:YAG) laser operates at 1.03 μm, Ytterbium:2O3 (glass or ceramics) laser operates at 1.03 μm, Ytterbium doped glass laser (rod, plate/chip, and fiber) operates at 1. Mm, Holmium YAG (Ho:YAG) laser operates at 2.1 μm, Chromium ZnSe (Cr:ZnSe) laser operates at 2.2-2.8 μm range, Cerium doped lithium strontium (or calcium) aluminum fluoride (Ce: LiSAF, Ce: LiCAF) operates at ˜280 to 316 nm range, Promethium 147 doped phosphate glass (147Pm+3:Glass) solid-state laser operates at 933 nm or 1098 nm, Chromium doped chrysoberyl (alexandrite) laser operates at the range of 700 to 820 nm, and Erbium doped and erbium-ytterbium codoped glass lasers operate at 1.53-1.56 μm.

Laser Diode. A laser diode, or LD, is an electrically pumped semiconductor laser in which the active laser medium is formed by a p-n junction of a semiconductor diode similar to that found in a light-emitting diode. The laser diode is the most common type of laser produced with a wide range of uses that include fiber optic communications, barcode readers, laser pointers, CD/DVD/Blu-ray Disc reading and recording, laser printing, laser scanning and increasingly directional lighting sources. A laser diode beam forming is described in Chapter 2: “Laser Diode Beam Basics” of a Book by Sun, H. published 2015 by Springer (ISBN: 978-94-017-9782-5) entitled: “A Practical Guide to handling Laser Diode Beams”, which is incorporated in its entirety for all purposes as if fully set forth herein.

A laser diode is electrically a P-i-n diode, where the active region of the laser diode is in the intrinsic (I) region and the carriers (electrons and holes) are pumped into that region from the N and P regions respectively. While initial diode laser research was conducted on simple P-N diodes, all modern lasers use the double-heterostructure implementation, where the carriers and the photons are confined in order to maximize their chances for recombination and light generation. Unlike a regular diode, the goal for a laser diode is to recombine all carriers in the (I) region, and produce light. Thus, laser diodes are fabricated using direct bandgap semiconductors. The laser diode epitaxial structure is grown using one of the crystal growth techniques, usually starting from an N doped substrate, and growing the (I) doped active layer, followed by the P doped cladding, and a contact layer. The active layer most often consists of quantum wells, which provide lower threshold current and higher efficiency.

Laser diodes form a subset of the larger classification of semiconductor p-n junction diodes. Forward electrical bias across the laser diode causes the two species of charge carrier—holes and electrons—to be “injected” from opposite sides of the p-n junction into the depletion region. Holes are injected from the p-doped, and electrons from the n-doped, semiconductor. A depletion region, devoid of any charge carriers, is formed because of the difference in electrical potential between n- and p-type semiconductors wherever they are in physical contact. Due to the use of charge injection in powering most diode lasers, this class of lasers is sometimes termed “injection lasers” or “Injection Laser Diode” (ILD). As diode lasers are semiconductor devices, they may also be classified as semiconductor lasers. Either designation distinguishes diode lasers from solid-state lasers. Another method of powering some diode lasers is the use of optical pumping. Optically Pumped Semiconductor Lasers (OPSL) use an III-V semiconductor chip as the gain medium, and another laser (often another diode laser) as the pump source. OPSL offer several advantages over ILDs, particularly in wavelength selection and lack of interference from internal electrode structures. When an electron and a hole are present in the same region, they may recombine or “annihilate” producing a spontaneous emission—i.e., the electron may re-occupy the energy state of the hole, emitting a photon with energy equal to the difference between the electron's original state and hole's state. (In a conventional semiconductor junction diode, the energy released from the recombination of electrons and holes is carried away as phonons, i.e., lattice vibrations, rather than as photons.) Spontaneous emission below the lasing threshold produces similar properties to an LED. Spontaneous emission is necessary to initiate laser oscillation, but it is one among several sources of inefficiency once the laser is oscillating.

As in other lasers, the gain region is surrounded with an optical cavity to form a laser. In the simplest form of laser diode, an optical waveguide is made on that crystal's surface, such that the light is confined to a relatively narrow line. The two ends of the crystal are cleaved to form perfectly smooth, parallel edges, forming a Fabry-Pérot resonator. Photons emitted into a mode of the waveguide will travel along the waveguide and be reflected several times from each end face before they exit. As a light wave passes through the cavity, it is amplified by stimulated emission, but light is also lost due to absorption and by incomplete reflection from the end facets. Finally, if there is more amplification than loss, the diode begins to “lase”. Some important properties of laser diodes are determined by the geometry of the optical cavity. Generally, the light is contained within a very thin layer, and the structure supports only a single optical mode in the direction perpendicular to the layers. In the transverse direction, if the waveguide is wide compared to the wavelength of light, then the waveguide can support multiple transverse optical modes, and the laser is known as “multi-mode”. These transversely multi-mode lasers are adequate in cases where one needs a very large amount of power, but not a small diffraction-limited beam; for example, in printing, activating chemicals, or pumping other types of lasers.

In Double heterostructure lasers, a layer of low bandgap material is sandwiched between two high bandgap layers. One commonly used pair of materials is gallium arsenide (GaAs) with aluminum gallium arsenide (AlxGa(1−x)As). Each of the junctions between different bandgap materials is called a heterostructure, hence the name “Double Heterostructure laser” or DH laser. The kind of laser diode described in the first part of the article may be referred to as a homojunction laser, for contrast with these more popular devices. The advantage of a DH laser is that the region where free electrons and holes exist simultaneously, the active region, is confined to the thin middle layer. This means that many more of the electron-hole pairs can contribute to amplification—not so many are left out in the poorly amplifying periphery. In addition, light is reflected from the heterojunction; hence, the light is confined to the region where the amplification takes place.

Quantum Well Laser. If the middle layer is made thin enough, it acts as a quantum well. This means that the vertical variation of the electron's wave function, and thus a component of its energy, is quantized. The efficiency of a quantum well laser is greater than that of a bulk laser because the density of states function of electrons in the quantum well system has an abrupt edge that concentrates electrons in energy states that contribute to laser action. Lasers containing more than one quantum well layers are known as multiple quantum-well lasers. Multiple quantum wells improve the overlap of the gain region with the optical waveguide mode.

Quantum Cascade Laser. In a quantum cascade laser, the difference between quantum well energy levels is used for the laser transition instead of the bandgap. This enables laser action at relatively long wavelengths, which can be tuned simply by altering the thickness of the layer. They are heterojunction lasers.

Separate Confinement Heterostructure Laser. The problem with the simple quantum well diode described above is that the thin layer is simply too small to effectively confine the light. To compensate, another two layers are added on the outside of the first three. These layers have a lower refractive index than the center layers, and hence confine the light effectively. Such a design is called a separate confinement heterostructure (SCH) laser diode. Almost all commercial laser diodes since the 1990s have been SCH quantum well diodes.

A Distributed Bragg Reflector laser (DBR) is a type of single frequency laser diode. It is characterized by an optical cavity consisting of an electrically or optically pumped gain region between two mirrors to provide feedback. One of the mirrors is a broadband reflector and the other mirror is wavelength selective so that gain is favored on a single longitudinal mode, resulting in lasing at a single resonant frequency. The broadband mirror is usually coated with a low reflectivity coating to allow emission. The wavelength selective mirror is a periodically structured diffraction grating with high reflectivity. The diffraction grating is within a non-pumped, or passive region of the cavity. A DBR laser is a monolithic single chip device with the grating etched into the semiconductor. DBR lasers can be edge emitting lasers or VCSELs. Alternative hybrid architectures that share the same topology include extended cavity diode lasers and volume Bragg grating lasers, but these are not properly called DBR lasers.

A Distributed FeedBack laser (DFB) is a type of single frequency laser diode. DFBs are the most common transmitter type in DWDM-systems. To stabilize the lasing wavelength, a diffraction grating is etched close to the p-n junction of the diode. This grating acts like an optical filter, causing a single wavelength to be fed back to the gain region and lase. Since the grating provides the feedback that is required for lasing, reflection from the facets is not required. Thus, at least one facet of a DFB is anti-reflection coated. The DFB laser has a stable wavelength that is set during manufacturing by the pitch of the grating, and can only be tuned slightly with temperature. DFB lasers are widely used in optical communication applications where a precise and stable wavelength is critical. The threshold current of this DFB laser, based on its static characteristic, is around 11 mA. The appropriate bias current in a linear regime could be taken in the middle of the static characteristic (50 mA).

Vertical-Cavity Surface-Emitting Lasers (VCSELs) have the optical cavity axis along the direction of current flow rather than perpendicular to the current flow as in conventional laser diodes. The active region length is very short compared with the lateral dimensions so that the radiation emerges from the surface of the cavity rather than from its edge as shown in the figure. The reflectors at the ends of the cavity are dielectric mirrors made from alternating high and low refractive index quarter-wave thick multilayer. Such dielectric mirrors provide a high degree of wavelength-selective reflectance at the required free surface wavelength λ if the thicknesses of alternating layers d1 and d2 with refractive indices n1 and n2 are such that n1d1+n2d2=λ/2 which then leads to the constructive interference of all partially reflected (or backscattered) waves at the interfaces. Because of the high mirror reflectivity, VCSELs have lower output powers when compared to edge-emitting lasers.

There are several advantages to producing VCSELs when compared with the production process of edge-emitting lasers. Edge-emitters cannot be tested until the end of the production process. If the edge-emitter does not work, whether due to bad contacts or poor material growth quality, the production time and the processing materials have been wasted. Additionally, because VCSELs emit the beam perpendicular to the active region of the laser as opposed to parallel as with an edge emitter, tens of thousands of VCSELs can be processed simultaneously on a three-inch gallium arsenide wafer. Furthermore, even though the VCSEL production process is more labor- and material-intensive, the yield can be controlled to a more predictable outcome. However, they normally show a lower power output level.

Vertical External-Cavity Surface-Emitting Lasers, or VECSELs, are similar to VCSELs. In VCSELs, the mirrors are typically grown epitaxially as part of the diode structure, or grown separately and bonded directly to the semiconductor containing the active region. VECSELs are distinguished by a construction in which one of the two mirrors is external to the diode structure. As a result, the cavity includes a free-space region. A typical distance from the diode to the external mirror would be 1 cm. One of the most interesting features of any VECSEL is the small thickness of the semiconductor gain region in the direction of propagation, less than 100 nm. In contrast, a conventional in-plane semiconductor laser entails light propagation over distances of from 250 μm upward to 2 mm or longer. The significance of the short propagation distance is that it causes the effect of “antiguiding” nonlinearities in the diode laser gain region to be minimized. The result is a large-cross-section single-mode optical beam which is not attainable from in-plane (“edge-emitting”) diode lasers.

Optically pumped VECSELs were demonstrated, used in for many applications including high power sources for use in industrial machining (cutting, punching, etc.) because of their unusually high power and efficiency when pumped by multi-mode diode laser bars. Typically, because of their lack of p-n junction, optically-pumped VECSELs are not considered “diode lasers”, and are classified as semiconductor lasers. Electrically pumped VECSELs have also been demonstrated. Applications for electrically pumped VECSELs include projection displays, served by frequency doubling of near-IR VECSEL emitters to produce blue and green light. External-cavity diode lasers are tunable lasers which use mainly double heterostructures diodes of the AlxGa(1−x)As type. The first external-cavity diode lasers used intracavity etalons and simple tuning Littrow gratings. Other designs include gratings in grazing-incidence configuration and multiple-prism grating configurations.

Chemical Laser. Chemical lasers are powered by a chemical reaction, and can achieve high powers in continuous operation. For example, in the hydrogen fluoride laser (2700-2900 nm) and the deuterium fluoride laser (3800 nm) the reaction is the combination of hydrogen or deuterium gas with combustion products of ethylene in nitrogen trifluoride. Chemical lasers are powered by a chemical reaction permitting a large amount of energy to be released quickly. Continuous wave chemical lasers at very high-power levels, fed by streams of gasses, have been developed and have some industrial applications. As examples, in the hydrogen fluoride laser (2700-2900 nm) and the deuterium fluoride laser (3800 nm), the reaction is the combination of hydrogen or deuterium gas with combustion products of ethylene in nitrogen trifluoride.

Excimer laser. Excimer lasers are powered by a chemical reaction involving an excited dimer, or excimer, which is a short-lived dimeric or heterodimeric molecule formed from two species (atoms), at least one of which is in an excited electronic state. They typically produce ultraviolet light, and are used in semiconductor photolithography and in LASIK eye surgery. Commonly used excimer molecules include F2 (fluorine, emitting at 157 nm), and noble gas compounds (ArF [193 nm], KrCl [222 nm], KrF [248 nm], XeCl [308 nm], and XeF [351 nm]). Valve. Valves are devices that work to control, regulate, or direct flow of liquids, solids, gasses, or anything in between, within a system or process, such as by opening, closing, or partially obstructing various passageways. Valves commonly provide several functions, such as starting or stopping flow based on the valve state, regulating flow and pressure within a piping system, controlling the direction of flow within a piping system, throttling flow rates within a piping system, and improving safety through relieving pressure or vacuum in a piping system In most cases, valves fall into one of three categories: Manual Valves-Typically adjusted by hand, these valves use handwheels, hand levels, gear wheels, or chains to actuate; Actuated Valves-Often connected to electric motors, air or pneumatic systems, hydraulic systems, or solenoids, these valves allow remote control and automation for high-precision or large-scale applications; and Automatic Valves-Valves that activate when a specific flow condition is met. Examples include check valves closing during backflow or pressure release valves activating when an over-pressure condition is detected.

Common types of valves include ball valve, butterfly valve, check valve, gate valve, knife gate valve, globe valve, needle valve, pinch valve, plug valve, and pressure relief valve. Ball valves are predominantly equipped with quick-acting 90-degree turn handles, and these valves typically use a ball to control flow to provide easy on-off control, and are generally considered to be faster and easier to operate than gate valves. These valves typically utilize a hollow, perforated, and pivoting ball to control fluid flow, and are ideal for on/off control with low-pressure drop. Butterfly valves are compact and are based on a quick-acting rotary motion valve that utilizes a disk rotating on a diametrical axis inside a pipe, and are suitable for regulating flow, in particular for tight spaces due to its wafer type design. Check valves are used to prevent backflow, by allowing fluid to flow in one direction but close automatically to prevent flow in the opposite direction (non-return). These valves are typically self-activated allowing the valve automatically opens when media passes through the valve in the intended direction and close should flow reverse. Gate valves use linear motion to start and stop the flow, typically by using a flat closure element that slides into the flow stream to provide shut-off. These valves are typically not used for flow regulation, but are used in the fully open or closed positions.

Knife gate valves are typically used for controlling flow of media containing solids, and the knife gate valve features a thin gate controlled through linear action which can cut through materials and create a seal. These valves may be used with grease, oils, paper pulp, slurry, wastewater, and other media which might obstruct the operation of other valve types. Globe valves typically employ a movable disk-type element and a stationary ring seat to regulate flow, are typically available in three body types: T-body, Y-Pattern, and Angle body, and are typically applied in modulating control operations, such as regulating flow or pressures as well as for on/off control. Needle valves use a conical disc and are typically used in small diameter piping systems when fine, accurate flow control is needed. Pinch valves use a linear motion and are often used for handling solid materials, slurries, and liquids with suspended solids, pinch valves. Typically, pinch valves feature an internal sleeve to isolate the media. Plug valves use a quick-acting quarter-turn valve handle, and control flow using tapered or cylindrical plugs, providing a reliable tight shutoff in high-pressure or high-temperature environments. Pressure relief valve are safety devices that are spring-automated for returning a system to the desired pressure during over-pressure events, and are designed to open at a predetermined pressure to protect other components of the system from excessive pressure.

Common valve connections and ends include: Screwed or Threaded—Often used in instrument connections or sample points, Flanged—The most common ends for piping use, Butt Welded—Typically used in high-pressure or high-temperature operations, Socket Welded—Commonly used on small bore piping where threaded connections are not permitted, and Wafer and Lug—Often used for compact valves installed in systems with limited space.

Electrically controlled valves are a subset of valves that use an electric actuator to control the valve opening or closing. This actuator can be controlled remotely, providing precise control over the flow of fluid in response to an electrical control signal. Examples include solenoid valves, which use an electromagnetic solenoid to actuate the valve, and motorized valves, which use an electric motor to open or close the valve mechanism. A solenoid valve is an electromechanically operated valve. Such a valve may use a two-port design to regulate a flow or use a three- or-more port design to switch flows between ports. Multiple solenoid valves can be placed together on a manifold. Solenoid valves are the most frequently used control elements in fluidics. Their tasks are to shut off, release, dose, distribute or mix fluids. Solenoid valves are described in a catalogue PUB124-003-00 issued May 2019 by Rotork Instruments Italy Srl headquartered in Italy, entitled: “Solenoid Valves”, which is incorporated in its entirety for all purposes as if fully set forth herein.

A selection of valves for a specific application that meet design parameters of a process service, that is based on function, material suitability, design pressure/temperature extremities, plant life, end connections, operation, weight, availability, maintenance, and cost, is described in a handbook Authored by Peter Smith and R. W. Zappe, published 2004 [ISBN: 0-7506-7717-1] and entitled: “VALVE SELECTION HANDBOOK—selecting the right valve”, which is incorporated in its entirety for all purposes as if fully set forth herein. Valves are the components in a fluid flow or pressure system that regulate either the flow or the pressure of the fluid. This duty may involve stopping and starting flow, controlling flow rate, diverting flow, preventing back flow, controlling pressure, or relieving pressure. These duties are performed by adjusting the position of the closure member in the valve. This may be done either manually or automatically. Manual operation also includes the operation of the valve by means of a manually controlled power operator. The valves discussed in the handbook are manually operated valves for stopping and starting flow, controlling flow rate, and diverting flow; and automatically operated valves for preventing back flow and relieving pressure. The manually operated valves are referred to as manual valves, while valves for the prevention of back flow and the relief of pressure are referred to as check valves and pressure relief valves, respectively.

Manual valves are divided into four groups according to the way the closure member moves onto the seat: Stopper type closure (globe, needle); Vertical slide (gate); Rotary type (ball, plug, butterfly); and Flexible body (diaphragm). Each valve group consists of a number of distinct types of valves that, in turn, are made in numerous variations. The many types of check valves are also divided into four groups according to the way the closure member moves onto the seat: Lift check; Swing check (single and double plate); Tilting disc; and Diaphragm. The basic duty of these valves is to prevent back flow. However, the valves should also close fast enough to prevent the formation of a significant reverse-flow velocity, which on sudden shut-off, may introduce an undesirably high surge pressure and/or cause heavy slamming of the closure member against the seat. In addition, the closure member should remain stable in the open valve position.

Pressure relief valves are divided into two major groups: direct-acting pressure relief valves that are actuated directly by the pressure of the system fluid, and pilot-operated pressure relief valves in which a pilot controls the opening and closing of the main valve in response to the system pressure. Direct-acting pressure may be provided with an auxiliary actuator that assists valve lift on valve opening and/or introduces a supplementary closing force on valve reseating. Lift assistance is intended to prevent valve chatter while supplementary valve loading is intended to reduce valve simmer. The auxiliary actuator is actuated by a foreign power source. Should the foreign power source fail, the valve will operate as a direct-acting pressure relief valve. Pilot-operated pressure relief valves may be provided with a pilot that controls the opening and closing of the main valve directly by means of an internal mechanism. In an alternative type of pilot-operated pressure relief valve, the pilot controls the opening or closing of the main valve indirectly by means of the fluid being discharged from the pilot. A third type of pressure relief valve is the powered pressure relief valve in which the pilot is operated by a foreign power source. This type of pressure relief valve is restricted to applications only that are required by code.

As control valves are an increasingly vital component of modern manufacturing around the world, properly selecting and maintaining control valves increase efficiency, safety, profitability, and ecology. Information on control valve performance is described in a handbook by Emerson/Fisher Flow Controls, published August 2023 [Document number D101881X012] and downloaded from https://www.emerson.com/documents/automation/control-valve-handbook-en-3661206.pdf, entitled: “CONTROL VALVE HANDBOOK—Sixth Edition”, which is incorporated in its entirety for all purposes as if fully set forth herein. The handbook describes how modern processing plants utilize a vast network of control loops to produce an end product for market, and these control loops are designed to keep a process variable (i.e., pressure, flow, level, temperature, etc.) within a required operating range to ensure a quality end product is produced. Each of these loops receives and internally creates disturbances that detrimentally affect the process variable (PV). Interaction from other loops in the network also provide disturbances that influence the process variable. The control valve is a critical part of the control loop. The control valve assembly typically consists of the valve body, the internal trim parts, an actuator to provide the motive power to operate the valve, and a variety of additional valve accessories, which can include transducers, supply pressure regulators, manual operators, snubbers, or limit switches. There are two main types of control valve designs, depending on the action of the closure member: sliding-stem or rotary.

Pump. A pump is a device that moves fluids (liquids or gases), or sometimes slurries, by mechanical action, typically converted from electrical energy into hydraulic energy. Mechanical pumps serve in a wide range of applications such as pumping water from wells, aquarium filtering, pond filtering and aeration, in the car industry for water-cooling and fuel injection, in the energy industry for pumping oil and natural gas or for operating cooling towers and other components of heating, ventilation and air conditioning systems. In the medical industry, pumps are used for biochemical processes in developing and manufacturing medicine, and as artificial replacements for body parts, in particular the artificial heart and penile prosthesis. When a pump contains two or more pump mechanisms with fluid being directed to flow through them in series, it is called a multi-stage pump. Terms such as two-stage or double-stage may be used to specifically describe the number of stages. A pump that does not fit this description is simply a single-stage pump in contrast.

Pumps can be classified by their method of displacement into electromagnetic pumps, positive-displacement pumps, impulse pumps, velocity pumps, gravity pumps, steam pumps and valveless pumps. There are three basic types of pumps: positive-displacement, centrifugal and axial-flow pumps. In centrifugal pumps the direction of flow of the fluid changes by ninety degrees as it flows over an impeller, while in axial flow pumps the direction of flow is unchanged. Pump selection, sizing, system analysis, and other aspects of pump hydraulics, are described in a book by Michael Volk published 2014 CRC Press [International Standard Book Number-13: 978-1-4665-6309-4] entitled: “Pump Characteristics and Applications—THIRD EDITION”, which is incorporated in its entirety for all purposes as if fully set forth herein. The book provides general understanding of pumps and to provide the tools to allow them to properly select, size, operate, and maintain pumps.

A pump is typically used herein to move (or compress) fluids or liquids, commonly by pressure or suction actions. Pumps commonly consume energy to perform mechanical work by moving the fluid or the gas, where the activating mechanism is often reciprocating or rotary. Pumps may be operated in many ways, including manual operation, electricity, a combustion engine of some type, and wind action. A sump pump is used for the removal of liquid from a sump or sump pit. A fuel pump is commonly used to move transport the fuel through a pipe, and a vacuum pump is a device that removes gas molecules from a sealed volume in order to leave behind a partial vacuum. A gas compressor is a mechanical device that increases the pressure of a gas by reducing its volume. A pump may be a valveless pump, where no valves are present to regulate the flow direction, and are commonly used in biomedical and engineering systems. Pumps can be classified into many major groups, for example according to their energy source or according to the method they use to move the fluid, such as direct lift, impulse, displacement, velocity, centrifugal, and gravity pumps.

A positive displacement pump causes a fluid to move by trapping a fixed amount of it and then forcing (displacing) that trapped volume into the discharge pipe. Some positive displacement pumps work using an expanding cavity on the suction side and a decreasing cavity on the discharge side. The liquid flows into the pump as the cavity on the suction side expands, and the liquid flows out of the discharge as the cavity collapses. The volume is constant given each cycle of operation. A positive displacement pump can be further classified according to the mechanism used to move the fluid: A rotary-type positive displacement type such as internal gear, screw, shuttle block, flexible vane or sliding vane, circumferential piston, helical twisted roots (e.g., Wendelkolben pump) or liquid ring vacuum pumps, a reciprocating-type positive displacement type, such as a piston or diaphragm pumps, and a linear-type positive displacement type, such as rope pumps and chain pumps. The positive displacement principle applies also to a rotary lobe pump, a progressive cavity pump, a rotary gear pump, a piston pump, a diaphragm pump, a screw pump, a gear pump, a hydraulic pump, and a vane pump.

A rotary positive displacement pumps can be grouped into three main types: Gear pumps where the liquid is pushed between two gears, Screw pumps where the shape of the pump internals usually two screws turning against each other pump the liquid, and Rotary vane pumps, which are similar to scroll compressors, and are consisting of a cylindrical rotor enclosed in a similarly shaped housing. As the rotor turns, the vanes trap fluid between the rotor and the casing, drawing the fluid through the pump.

Reciprocating positive displacement pumps cause the fluid to move using one or more oscillating pistons, plungers or membranes (diaphragms). Typical reciprocating pumps include plunger pumps type, which are based on a reciprocating plunger that pushes the fluid through one or two open valves, closed by suction on the way back, diaphragm pumps type which are similar to plunger pumps, where the plunger pressurizes hydraulic oil which is used to flex a diaphragm in the pumping cylinder, diaphragm valves type that are used to pump hazardous and toxic fluids, piston displacement pumps type that are usually simple devices for pumping small amounts of liquid or gel manually, and radial piston pumps type.

A pump may be an impulse pump which uses pressure created by gas (usually air). In some impulse pumps the gas trapped in the liquid (usually water), is released and accumulated somewhere in the pump, creating a pressure which can push part of the liquid upwards. Impulse pump types include: a hydraulic ram pump type, which use a pressure built up internally from a released gas in a liquid flow; a pulser pump type which runs with natural resources by kinetic energy only; and an airlift pump type which runs on air inserted into a pipe, pushing up the water, when bubbles move upward, or on a pressure inside the pipe pushing the water up.

A velocity pump may be a rotodynamic pump (a.k.a. dynamic pump) which is a type of velocity pump in which kinetic energy is added to the fluid by increasing the flow velocity. This increase in energy is converted to a gain in potential energy (pressure) when the velocity is reduced prior to or as the flow exits the pump into the discharge pipe. This conversion of kinetic energy to pressure is based on the First law of thermodynamics or more specifically by Bernoulli's principle. A pump may be a centrifugal pump which is a rotodynamic pump that uses a rotating impeller to increase the pressure and flow rate of a fluid. Centrifugal pumps are the most common type of pump used to move liquids through a piping system. The fluid enters the pump impeller along or near to the rotating axis and is accelerated by the impeller, flowing radially outward or axially into a diffuser or volute chamber, from where it exits into the downstream piping system. A centrifugal pump may be a radial flow pump type, where the fluid exits at right angles to the shaft, an axial flow pump type where the fluid enters and exits along the same direction parallel to the rotating shaft, or may be a mixed flow pump, where the fluid experiences both radial acceleration and lift and exits the impeller somewhere between 0-90 degrees from the axial direction.

Syringe pump. Syringe pumps, or syringe drivers, are motorised devices that accurately control the movement of fluid from a syringe by mechanically inserting or retracting the plunger. Syringe pump typically is a small infusion pump, used to gradually administer small amounts of fluid (with or without medication) to a patient or for use in chemical and biomedical research. Syringe pumps feature stepper motors that accurately move the platform attached to the plunger of a syringe. The body of the syringe is held steady to the body of the unit so that the only movement is from the action of the motor. Basic models can be used for the infusion (and sometimes withdrawal) of liquids at a set rate and are controlled simply by changing the speed of the motor. More sophisticated syringe pumps are equipped with onboard computers, which allow you to program the motion of the stepper motor with multiple steps. Therefore, causing an automatically performed a set sequence.

An example of a syringe pump is model “SY-09 Syringe Pump” available from Nanjing Runze Fluid Control Equipment Co., LTD., of Nanjing City Jiangsu Province, China, described in a data sheet entitled “SY-09 Syringe Pump” downloaded on December 2023 from https://www.runzefluid.com/contact.html, which is incorporated in its entirety for all purposes as if fully set forth herein.

An e-book with recommendations for low liquid flow setups, focusing on low liquid flows, flows <100 g/h, downloaded December 2023 from www.bronkhorst.com entitled: “How to Handle Low Liquid Flows”, is incorporated in its entirety for all purposes as if fully set forth herein. Besides low flow definition and tips for flow meter selection, this e-book also gives advice on system lay-outs, connection material and liquid supply systems. Because flow setups and process conditions are rarely the same for different customers; there is no one-fix-for-all solution available. Providing the best advice requires insight into the customer application.

Pressure vessel. A pressure vessel is a container designed to hold gases or liquids at a pressure substantially different from the ambient pressure. Construction methods and materials may be chosen to suit the pressure application, and will depend on the size of the vessel, the contents, working pressure, mass constraints, and the number of items required. Design involves parameters such as maximum safe operating pressure and temperature, safety factor, corrosion allowance and minimum design temperature (for brittle fracture). Construction is tested using nondestructive testing, such as ultrasonic testing, radiography, and pressure tests. Hydrostatic pressure tests usually use water, but pneumatic tests use air or another gas. Hydrostatic testing is preferred, because it is a safer method, as much less energy is released if a fracture occurs during the test (water does not greatly increase its volume when rapid depressurization occurs, unlike gases, which expand explosively). Mass or batch production products will often have a representative sample tested to destruction in controlled conditions for quality assurance. Pressure relief devices may be fitted if the overall safety of the system is sufficiently enhanced. A thin-walled pressure vessel is described in an article by David Roylance of the Department of Materials Science and Engineering Massachusetts Institute of Technology Cambridge, published Aug. 23, 2001, entitled: “PRESSURE VESSELS”, which is incorporated in its entirety for all purposes as if fully set forth herein. Structures such as pipes or bottles capable of holding internal pressure have been very important in the history of science and technology. Although the ancient Romans had developed municipal engineering to a high order in many ways, the very need for their impressive system of large aqueducts for carrying water was due to their not yet having pipes that could maintain internal pressure. Water can flow uphill when driven by the hydraulic pressure of the reservoir at a higher elevation, but without a pressure-containing pipe an aqueduct must be constructed so the water can run downhill all the way from the reservoir to the destination. Airplane cabins are another familiar example of pressure-containing structures. They illustrate very dramatically the importance of proper design, since the atmosphere in the cabin has enough energy associated with its relative pressurization compared to the thin air outside that catastrophic crack growth is a real possibility.

Linear actuator. Linear actuator is an actuator that creates linear motion (i.e., in a straight line), in contrast to the circular motion of a conventional electric motor. Hydraulic or pneumatic cylinders inherently produce linear motion. Many other mechanisms are used to generate linear motion from a rotating motor. Rotary-based linear actuators may be a screw, a wheel and axle, or a cam type. A screw actuator operates on the screw machine principle, whereby rotating the actuator nut, the screw shaft moves in a line, such as a lead-screw, a screw jack, a ball screw or roller screw. A wheel-and-axle actuator operates on the principle of the wheel and axle, where a rotating wheel moves a cable, rack, chain or belt to produce linear motion. Examples are hoist, winch, rack and pinion, chain drive, belt drive, rigid chain, and rigid belt actuators. Cam actuator includes a wheel-like cam, which upon rotation, provides thrust at the base of a shaft due to its eccentric shape. Mechanical linear actuators may only pull, such as hoists, chain drive and belt drives, while others only push (such as a cam actuator). Some pneumatic and hydraulic cylinder-based actuators may provide force in both directions. Linear actuators, as well as other actuators and sensors, are described in a book authored by Nathan Ida, 2nd Edition published 2020 [ISBN 978-1-78561-836-9] by The Institution of Engineering and Technology, entitled: “Sensors, Actuators, and Their Interfaces A multidisciplinary introduction”, which is incorporated in its entirety for all purposes as if fully set forth herein. The approach adopted in this book is to view all devices as belonging to three categories: sensors, actuators, and processors (interfaces). Sensors are the devices that provide input to systems and actuators are those devices that serve as outputs. In between, linking, interfacing, processing, and driving are the processors.

A linear hydraulic actuator (a.k.a. hydraulic cylinder) commonly involves a hollow cylinder having a piston inserted in it. An unbalanced pressure applied to the piston provides a force that can move an external object, and since liquids are nearly incompressible, a hydraulic cylinder can provide controlled precise linear displacement of the piston. The displacement is only along the axis of the piston. Pneumatic actuators, or pneumatic cylinders, are similar to hydraulic actuators except they use compressed gas to provide pressure instead of a liquid. A linear pneumatic actuator (a.k.a. pneumatic cylinder) is similar to hydraulic actuator, except that it uses compressed gas to provide pressure instead of a liquid. A linear actuator may be a piezoelectric actuator, based on the piezoelectric effect in which application of a voltage to the piezoelectric material causes it to expand. Very high voltages correspond to only tiny expansions. As a result, piezoelectric actuators can achieve extremely fine positioning resolution, but also have a very short range of motion.

A linear actuator may be a linear electrical motor. Such a motor may be based on a conventional rotary electrical motor, connected to rotate a lead screw, that has a continuous helical thread machined on its circumference running along the length (similar to the thread on a bolt). Threaded onto the lead screw is a lead nut or ball nut with corresponding helical threads, used for preventing from rotating with the lead screw (typically the nut interlocks with a non-rotating part of the actuator body). The electrical motor may be a DC brush, a DC brushless, a stepper, or an induction motor type. Telescoping linear actuators are specialized linear actuators used where space restrictions or other requirements require, where their range of motion is many times greater than the unextended length of the actuating member. A common form is made of concentric tubes of approximately equal length that extend and retract like sleeves, one inside the other, such as the telescopic cylinder. Other more specialized telescoping actuators use actuating members that act as rigid linear shafts when extended, but break that line by folding, separating into pieces and/or uncoiling when retracted. Examples of telescoping linear actuators include a helical band actuator, a rigid belt actuator, a rigid chain actuator, and a segmented spindle.

A linear actuator may be a linear electric motor, that has had its stator and rotor “unrolled” so that instead of producing a torque (rotation) it produces a linear force along its length. The most common mode of operation is as a Lorentz-type actuator, in which the applied force is linearly proportional to the current and the magnetic field. A linear electric motor may be a Linear Induction Motor (LIM), which is an AC (commonly 3-phase) asynchronous linear motor that works with the same general principles as other induction motors but which has been designed to directly produce motion in a straight line. In such motor type, the force is produced by a moving linear magnetic field acting on conductors in the field, such that any conductor, be it a loop, a coil or simply a piece of plate metal, that is placed in this field, will have eddy currents induced in it thus creating an opposing magnetic field, in accordance with Lenz's law. The two opposing fields will repel each other, thus creating motion as the magnetic field sweeps through the metal. The primary of a linear electric motor typically consists of a flat magnetic core (generally laminated) with transverse slots which are often straight cut with coils laid into the slots, while the secondary is frequently a sheet of aluminum, often with an iron backing plate. Some LIMs are double sided, with one primary either side of the secondary, and in this case no iron backing is needed. A LIM may be based on a synchronous motor, where the rate of movement of the magnetic field is controlled, usually electronically, to track the motion of the rotor. A linear electric motor may be a Linear Synchronous Motor (LSM), in which the rate of movement of the magnetic field is controlled, usually electronically, to track the motion of the rotor. Synchronous linear motors may use commutators, or preferably the rotor may contain permanent magnets, or soft iron.

A linear actuator may be a comb-drive capacitive actuator utilizing electrostatic forces that act between two electrically conductive combs. The attractive electrostatic forces are created when a voltage is applied between the static and moving combs causing them to be drawn together. The force developed by the actuator is proportional to the change in capacitance between the two combs, increasing with driving voltage, the number of comb teeth, and the gap between the teeth. The combs are arranged so that they never touch (because then there would be no voltage difference). Typically the teeth are arranged so that they can slide past one another until each tooth occupies the slot in the opposite comb. Comb drive actuators typically operate at the micro- or nanometer scale and are generally manufactured by bulk micromachining or surface micromachining a silicon wafer substrate.

Lens. A lens is a transmissive optical device that focuses or disperses a light beam by means of refraction. A simple lens consists of a single piece of transparent material, while a compound lens consists of several simple lenses (elements), usually arranged along a common axis. Lenses are made from materials such as glass or plastic and are ground, polished, or molded to the required shape. A lens can focus light to form an image, unlike a prism, which refracts light without focusing.

Wide-angle lens/fisheye lens. A fisheye lens is an ultra-wide-angle lens that produces strong visual distortion intended to create a wide panoramic or hemispherical image. Fisheye lenses achieve extremely wide angles of view, well beyond any rectilinear lens. Instead of producing images with straight lines of perspective (rectilinear images), fisheye lenses use a special mapping (distortion), which gives images a characteristic convex non-rectilinear appearance. The angle of view of a fisheye lens is usually between 100 and 180 degrees, although lenses covering up to 280 degrees exist. Unlike rectilinear lenses, fisheye lenses are not fully characterized by focal length and aperture alone. Angle of view, image diameter, projection type, and sensor coverage all vary independently of these. In a circular fisheye lens, the image circle is inscribed in the film or sensor area; in a diagonal (“full-frame”) fisheye lens, the image circle is circumscribed around the film or sensor area. This implies that using a fisheye lens for a different format than it was intended for is easy (as opposed to a rectilinear lens), and may change its characteristic.

Further, different fisheye lenses map (“distort”) images differently, and the manner of distortion is referred to as their mapping function. A common type for consumer use is equisolid angle. The focal length is determined by the angular coverage, the specific mapping function used, and the required dimensions of the final image. The first types of fisheye lenses developed were circular fisheyes, referring to lenses which took in a 180°hemisphere and projected it as a circle within the film frame. By design, circular fisheye lenses thus cover a smaller image circle than rectilinear lenses designed for the same sensor size. The corners of a circular fisheye image will be completely black. This blackness is different from the gradual vignetting of rectilinear lenses and sets on abruptly. Some circular fisheyes were available in orthographic projection models for scientific applications. These have a 180° vertical, horizontal and diagonal angle of view.

F-Theta Lenses. F-Theta lenses have been engineered to provide the highest performance in laser scanning or engraving systems. These lenses are ideal for engraving and labeling systems, image transfer, and material processing. For many applications in laser scanning and engraving, a planar imaging field is desired for the best results. A spherical lens can only image along a circular plane. The flat-field scanning lens solves this problem. However, the displacement of the beam depends on the product of the effective focal length (f) and the tangent of the deflection angle θ[f×tan (θ)]. While this nonlinear displacement can be accounted for with the proper software algorithm, the ideal solution is to produce a linear displacement (i.e., constant scan rate). F-theta lenses are designed with a barrel distortion that yields a displacement that is linear with θ (f*θ). This simple response removes the need for complicated electronic correction and allows for a fast, relatively inexpensive, and compact scanning system. A tutorial describing F-Theta lenses is entitled: “F-THETA LENSES TUTORIAL” by Thorlabs, Inc., downloaded Decemeber 2023 from https://www.thorlabs.com/newgrouppage9.cfm?objectgroup_id=10766, which is incorporated in its entirety for all purposes as if fully set forth herein.

F-Theta lenses are a class of Fisheye lenses, and use an image mapping function of type r=fθ, and are associated with non-distortion 180° have an image circle of π*FocalLength mm. For example, a non-distortion F-Theta lens of 1.37 mm focal length has an image circle of 4.30 mm. Therefor a f=3.17mm F-Theta lens with an image diameter for 180°of 4.15 mm has a distortion of (4.15/4.3)−1=0.965−1=−3.5%. F-Theta lenses are commonly used in laser scanning systems that require a flat image plane and high resolution. By introducing a specific amount of barrel distortion in the lens, the image height of the F-Theta lens is proportional to the scanning angle. These diffraction limited lens systems can be engineered to produce the desired spot size and have a distortion of less than 0.25% of the entire field of view. The Scan Field Diameter (SFD) is defined to be the diagonal length of the square area in the image plane where the laser beam is focused by the f-theta lens. The SFD of the lens will define deflection and focal length. The angle between the output beam and the normal of the image plane is called the Output Scan Angle (OSA). This angle is not constant across the image field, although the change in OSA is small enough it will not affect scanning applications. For a telecentric lenses, the output scan angle is always zero. The optical scan angle is the maximum OSA that avoids vignetting.

The spot size in a laser system can be calculated by multiplying a constant (C=1.83 for a Gaussian beam truncated at the 1/e\hat{ }2 diameter) by the wavelength of the laser and the effective focal length of the lens, divided by the entrance beam diameter. The ability to position the appropriately-sized spot at any point in the flat image plane is crucial to laser scanning, and a good f-theta lens makes this easily attainable. A spot diameter diagram, which indicates the spot diameter variation depending on field position, can be provided on request. The back working distance (BWD) of a F-Theta lens is the distance from the paraxial focus point to the lens housing. The back focal length, or BFL, is the distance from the paraxial focus point to the apex of the lens (the apex of the outer glass element).

Random. Randomness is commonly implemented by using random numbers, defined as a sequence of numbers or symbols that lack any pattern and thus appear random, are often generated by a random number generator. Randomness for security is also described in IETF RFC 1750 “Randomness Recommendations for Security” (December 1994), which is incorporated in its entirety for all purposes as if fully set forth herein. A random number generator (having either analog or digital output) can be hardware based, using a physical process such as thermal noise, shot noise, nuclear decaying radiation, photoelectric effect or other quantum phenomena. Alternatively, or in addition, the generation of the random numbers can be software based, using a processor executing an algorithm for generating pseudo-random numbers which approximates the properties of random numbers.

The term ‘random’ herein is intended to cover not only pure random, non-deterministically and non-predicted generated signals, but also pseudo-random, deterministic signals such as the output of a shift-register arrangement provided with a feedback circuit as used to generate pseudo-random binary signals or as scramblers, and chaotic signals, and where a randomness factor may be used.

A digital random signal generator (known as random number generator) wherein numbers in binary form replaces the analog voltage value output may be used for any randomness. One approach to random number generation is based on using linear feedback shift registers. An example of random number generators is disclosed in U.S. Pat. No. 7,124,157 to Ikake entitled: “Random Number Generator”, in U.S. Pat. No. 4,905,176 to Schulz entitled: “Random Number Generator Circuit”, in U.S. Pat. No. 4,853,884 to Brown et al. entitled: “Random Number Generator with Digital Feedback” and in U.S. Pat. No. 7,145,933 to Szajnowski entitled: “Method and Apparatus for generating Random signals”, which are incorporated in its entirety for all purposes as if fully set forth herein.

A digital random signal generator may be based on ‘True Random Number Generation IC RPG100/RPG100B’ available from FDK Corporation and described in the data sheet ‘Physical Random number generator RPG100.RPG100B’ REV. 08 publication number HM-RAE106-0812, which is incorporated in its entirety for all purposes as if fully set forth herein. The digital random signal generator can be hardware based, generating random numbers from a natural physical process or phenomenon, such as the thermal noise of semiconductor which has no periodicity. Typically, such hardware random number generators are based on microscopic phenomena such as thermal noise, shot noise, nuclear decaying radiation, photoelectric effect or other quantum phenomena, and typically contain a transducer to convert some aspect of the physical phenomenon to an electrical signal, an amplifier and other electronic to bring the output into a signal that can be converted into a digital representation by an analog to digital converter. In the case where digitized serial random number signals are generated, the output is converted to parallel, such as 8 bits data, with 256 values of random numbers (values from 0 to 255). Alternatively, a digital random signal generator may be software (or firmware) based, such as pseudo-random number generators. Such generators include a processor for executing software that includes an algorithm for generating numbers, which approximates the properties of random numbers. The random signal generator (either analog or digital) may output a signal having uniform distribution, in which there is a substantially or purely equal probability of a signal falling between two defined limits, having no appearance outside these limits. However, Gaussian and other distribution may be equally used.

CAD. Computer-Aided Design (CAD) is the use of computers (or workstations) to aid in the creation, modification, analysis, or optimization of a design. This software is used to increase the productivity of the designer, improve the quality of design, improve communications through documentation, and to create a database for manufacturing. Designs made through CAD software help protect products when used in patent applications, and CAD output is often in the form of electronic files for print, machining, or other manufacturing operations. CAD software for mechanical design uses either vector-based graphics to depict the objects of traditional drafting, or may also produce raster graphics showing the overall appearance of designed objects. Typically, the output of CAD conveys information, such as materials, processes, dimensions, and tolerances, according to application-specific conventions. CAD may be used to design curves and figures in two-dimensional (2D) space; or curves, surfaces, and solids in three-dimensional (3D) space.

An example of a CAD software is Simplify3D version 5.1 available from Simplify3D described by an unofficial documentation in a web page downloaded December 2023 from https://jinschoi.github.io/simplify3d-docs, which is incorporated in its entirety for all purposes as if fully set forth herein. The Simplify3D is a commercial slicer and 3D printer host, and provides complete control over the 3D printing process. Simplify3D features a realistic print simulation system that may assist in getting some insight into the print. Using the simulation allows users to also discover potential issues and print failures before actually printing, saving time and material cost. Version 5 offers precise visualizations, more accurate build predictions, and metrics that provide valuable insights into the printing process. According to Simplify3D, updated algorithms will even simulate the behavior of the printer firmware, thus allowing for a better prediction of how long a print will take to complete. Simplify3D supports specifying separate settings for each part on the build surface in a single print. Simplify3D further supports handling of tapering and sharp edges by dynamically adjusting material flow. The program will adjust extrusion settings to provide better quality in places where sticking to one standard extrusion width would cause over-extrusion issues.

An example of a popular CAD software is SOLIDWORKS®, available from Dassault Systèmes of Vélizy-villacoublay Cedex, France, described, for example, in a datasheet published 2016 and entitled: “SOLIDWORKS PREMIUM—THE POWER YOU NEED TO DRIVE INNOVATION”, which is incorporated in its entirety for all purposes as if fully set forth herein. SolidWorks provides solid modeling computer-aided design, computer-aided engineering, 3D CAD design and collaboration, analysis, and product data management software. SolidWorks is a solid modeler that utilizes a parametric feature-based approach developed to create 3D CAD models and assemblies. The software uses the Parasolid modelling kernel. Parameters refer to constraints whose values determine the shape or geometry of the model or assembly. Parameters can be either numeric parameters, such as line lengths or circle diameters, or geometric parameters, such as tangent, parallel, concentric, horizontal or vertical, etc. Numeric parameters can be associated with each other through the use of relations, which allows them to capture design intent. Design intent is how the creator of the part wants it to respond to changes and updates. For example, the user would want the hole at the top of a beverage can to stay at the top surface, regardless of the height or size of the can. SolidWorks allows the user to specify that the hole is a feature on the top surface, and will then honor their design intent no matter what height they later assign to the can. Features refer to the building blocks of the part, and are the shapes and operations that construct the part. Shape-based features typically begin with a 2D or 3D sketch of shapes such as bosses, holes, slots, etc. This shape is then extruded to add or cut to remove material from the part. Operation-based features are not sketch-based, and include features such as fillets, chamfers, shells, applying draft to the faces of a part, etc.

Building a model in SolidWorks usually starts with a 2D sketch (although 3D sketches are available for power users). The sketch consists of geometry such as points, lines, arcs, conics (except the hyperbola), and splines. Dimensions are added to the sketch to define the size and location of the geometry. Relations are used to define attributes such as tangency, parallelism, perpendicularity, and concentricity. The parametric nature of SolidWorks means that the dimensions and relations drive the geometry, not the other way around. The dimensions in the sketch can be controlled independently, or by relationships to other parameters inside or outside the sketch. In an assembly, the analog to sketch relations are mates. Just as sketch relations define conditions such as tangency, parallelism, and concentricity with respect to sketch geometry, assembly mates define equivalent relations with respect to the individual parts or components, allowing the easy construction of assemblies. SolidWorks also includes additional advanced mating features such as gear and cam follower mates, which allow modelled gear assemblies to accurately reproduce the rotational movement of an actual gear train.

STL. STereoLithography (STL), also known as Standard Triangulation Language or Standard Tesselation Language, is a file format, native to the stereolithography CAD software created by 3D Systems, for model data describing the surface geometry of an object as a tessellation of triangles used to communicate 3D geometries to machines in order to build physical parts. An STL file describes a raw, unstructured triangulated surface by the unit normal and vertices (ordered by the right-hand rule) of the triangles using a three-dimensional Cartesian coordinate system. STL files contain no scale information, and the units are arbitrary. STL files describe only the surface geometry of a three-dimensional object without any representation of color, texture or other common CAD model attributes. The STL format specifies both ASCII and binary representations. Binary files are more common, since they are more compact. STL is widely used for rapid prototyping, 3D printing and computer-aided manufacturing, and supported by many other software packages.

AMF. Additive Manufacturing File Format (AMF) is an open standard for describing objects for additive manufacturing processes such as 3D printing, used for communicating additive manufacturing model data including a description of the 3D surface geometry with native support for color, materials, lattices, textures, constellations and metadata. AMF can represent one of multiple objects arranged in a constellation. Similar to STL, the surface geometry is represented by a triangular mesh, but the triangles may also be curved. The official ISO/ASTM 52915:2016 standard is an XML-based format designed to allow any computer-aided design software to describe the shape and composition of any 3D object to be fabricated on any 3D printer via a computer-aided manufacturing software. Unlike its predecessor STL format, AMF has native support for color, materials, lattices, and constellations.

An AMF can represent one object, or multiple objects arranged in a constellation. Each object is described as a set of non-overlapping volumes. Each volume is described by a triangular mesh that references a set of points (vertices). These vertices can be shared among volumes belonging to the same object. An AMF file can also specify the material and the color of each volume, as well as the color of each triangle in the mesh. The AMF file is compressed using the zip compression format, but the “.amf” file extension is retained. A minimal AMF reader implementation must be able to decompress an AMF file and import at least geometry information (ignoring curvature).

IGES. The Initial Graphics Exchange Specification (IGES) is a platform neutral CAD data exchange format intended for exchange of product geometry and geometry annotation information. IGES version 5.3 was superseded by ISO 10303, STEP in 2006 IGES. The Initial Graphics Exchange Specification (IGES) is a vendor-neutral file format that allows the digital exchange of information among computer-aided design (CAD) systems. It's an ASCII-based textual format. Using IGES, a CAD user can exchange product data models in the form of circuit diagrams, wireframe, freeform surface or solid modeling representations. Applications supported by IGES include traditional engineering drawings, models for analysis, and other manufacturing functions.

G-code. G-code (also RS-274) is the most widely used computer numerical control (CNC) and 3D printing programming language. It is used mainly in computer-aided manufacturing to control automated machine tools, as well as for 3D-printer slicer applications. The G stands for geometry, and the G-code has many variants. G-code instructions are provided to a machine controller (industrial computer) that tells the motors where to move, how fast to move, and what path to follow. The two most common situations are that, within a machine tool such as a lathe or mill, a cutting tool is moved according to these instructions through a toolpath cutting away material to leave only the finished workpiece and/or an unfinished workpiece is precisely positioned in any of up to nine axes around the three dimensions relative to a toolpath and, either or both can move relative to each other. The same concept also extends to noncutting tools such as forming or burnishing tools, photoplotting, additive methods such as 3D printing, and measuring instruments.

STEP. A Standard for the Exchange of Product model data (STEP) is a standard for the exchange of product model data. The STEP is standardized as ISO 10303 entitled: “Automation systems and integration-Product data representation and exchange” and provides a representation of product information, along with the necessary mechanisms and definitions to enable product data to be exchanged. STEP applies to the representation of product information, including components and assemblies; the exchange of product data, including storing, transferring, accessing and archiving. ISO 10303 can represent 3D objects in Computer-aided design (CAD) and related information. STEP can be typically used to exchange data between CAD, computer-aided manufacturing, computer-aided engineering, product data management/enterprise data modeling and other CAx systems. STEP addresses product data from mechanical and electrical design, geometric dimensioning and tolerancing, analysis and manufacturing, as well as additional information specific to various industries such as automotive, aerospace, building construction, ship, oil and gas, process plants, and others.

Slicer. A slicer is a toolpath generation software used in 3D printing that facilitates the conversion of a 3D object model to specific instructions for the printer. The slicer typically converts a model in STL (Stereolithography) format into printer commands in G-code format, that may be used in 3D printing processes. A slicer initially segments the object as a stack of flat layers, and then describes these layers through linear movements of the 3D printer's extruder, the fixation laser, or an equivalent component. All these movements, together with some specific printer commands like the ones to control the extruder temperature or bed temperature, are ultimately compiled in the G-code file, that then may be transferred to the printer for execution. Slicers may support infill. To mitigate requires a significant amount of material (such as filament) and time when printing solid objects, slicers can automatically convert solid volumes to hollow ones, thereby saving costs and reducing print time. These hollow objects can be reinforced with internal structures, like internal walls, to enhance robustness. The proportion of these structures, known as ‘infill density’, is a key parameter that can be adjusted in the slicer.

Further, since most 3D printing processes build objects layer by layer, from the bottom up, each new layer is deposited directly on top of the previous one. Consequently, every part of the object must, to some extent, rest on another part. For layers that are ‘floating’—for example, the flat roof of a house or a horizontally extended arm in a figure-the slicer may automatically add supports. These supports are designed to touch the object in a manner that allows for easy detachment upon the completion of the object's production. Rafts, skirts and brims: To mitigate problems of adherence issues, surface rugosity, and the smooth deposition of the initial filament, when printing of the first object layer, which contacts the printer bed, the slicer may automatically add detachable structures. Common types of these base structures include a skirt, referring to a single band encircling the object's base, without touching it, a brim, referring to multiple lines of filament around the base of the object, touching but not underneath it, and extending outward, and a raft, where several layers of material forming a detachable base on which the object is printed.

An example of a free, open-source software that is available on multiple operating systems: Linux, macOS and Windows, where Slicer-5.0 release is described in “3D Slicer Documentation” by Slicer Community dated Mar. 10, 2022, downloaded December 2023 from https://slicer.readthedocs.io/_/downloads/en/v4.11/pdf/, which is incorporated in its entirety for all purposes as if fully set forth herein. The 3D Slicer is a software application for visualization and analysis of medical image computing datasets. All commonly used datasets are supported, such as images, segmentations, surfaces, annotations, and transformations, in 2D, 3D, and 4D. Visualization is available on desktop and in virtual reality, and an analysis includes segmentation, registration, and various quantifications.

Laser scanning. Laser scanning is the controlled deflection of laser beams, visible or invisible. Scanned laser beams are used in some 3-D printers, in rapid prototyping, in machines for material processing, in laser engraving machines, in ophthalmological laser systems for the treatment of presbyopia, in confocal microscopy, in laser printers, in laser shows, in Laser TV, and in barcode scanners. Applications specific to mapping and 3D object reconstruction are known as 3D laser scanner.

An introduction to the fundamentals of photonics is provided in a book by BAHAA E. A. SALEH and MALVIN CARL TEICH, Third Edition published 2019 by John Wiley & Sons, Inc. [ISBN: 9781119506874] entitled: “FUNDAMENTALS OF PHOTONICS”, which is incorporated in its entirety for all purposes as if fully set forth herein. The book includes the generation of coherent light by lasers, and incoherent light by luminescence sources such as light-emitting diodes; the transmission of light in free space, through conventional optical components such as lenses, apertures, and imaging systems, and through waveguides such as optical fibers; the modulation, switching, and scanning of light by the use of electrically, acoustically, or optically controlled devices; the amplification and frequency conversion of light by the use of wave interactions in nonlinear materials; and the detection of light. These areas have found ever-increasing applications in optical communications, signal processing, computing, sensing, display, printing, and energy transport.

A scan system requires not only optics but disciplines such as mechanics, electronics, magnetics, fluid dynamics, material science, acoustics, image analysis, firmware, software, and a host of others. Scan systems are described in a book by Gerald F. Marshal and Glenn E Stutz, published 2012 by CRC Press [ISBN: 978-1-4398-0879-5], entitled: “Handbook of Optical and Laser Scanning—Second Edition”, which is incorporated in its entirety for all purposes as if fully set forth herein. A scanning system can be an input or output system or a combination of both. Input systems acquire images in either two or three dimensions. These systems can operate at a fixed wavelength or over a broad spectrum, and can reacquire the original light source by gathering either the specular or diffuse reflection or by fluorescing the image and acquiring the fluoresced light. Output systems direct light to produce images for applications such as marking, visual projection, and hard copy output. Ladar and many inspection systems use the same optical path to both illuminate the scene and acquire the image.

Scanning mirrors. Most laser scanners use moveable mirrors to steer the laser beam. The steering of the beam can be one-dimensional, as inside a laser printer, or two-dimensional, as in a laser show system. Additionally, the mirrors can lead to a periodic motion-like the rotating polygon mirror in a barcode scanner or so-called resonant galvanometer scanners—or to a freely addressable motion, as in servo-controlled galvanometer scanners (the terms raster scanning and vector scanning are used to distinguish the two situations). To control the scanning motion, scanners need a rotary encoder and control electronics that provide, for a desired angle or phase, the suitable electric current to the motor (for a polygon mirror) or galvanometer (also called galvos). A software system usually controls the scanning motion and, if 3D scanning is implemented, also the collection of the measured data.

In order to position a laser beam in two dimensions, it is possible either to rotate one mirror along two axes-used mainly for slow scanning systems—or to reflect the laser beam onto two closely spaced mirrors that are mounted on orthogonal axes. Each of the two flat or polygon (polygonal) mirrors is then driven by a galvanometer or by an electric motor respectively. Two-dimensional systems are essential for most applications in material processing, confocal microscopy, and medical science. Some applications require positioning the focus of a laser beam in three dimensions. This is achieved by a servo-controlled lens system, usually called a ‘focus shifter’ or ‘z-shifter’. Many laser scanners further allow changing the laser intensity.

Scanning refractive optics: When two Risley prisms are rotated against each other, a beam of light can be scanned at will inside a cone. When two optical lenses are moved or rotated against each other, a laser beam can be scanned in a way similar to mirror scanners. Material effects: Some special laser scanners use, instead of moving mirrors, acousto-optic deflectors or electro-optic deflectors. These mechanisms allow the highest scanning frequencies possible so far. Phased array scanning: Scanning of laser beams may be achieved through phased arrays. This method is used to scan radar beams without moving parts. With the use of vertical-cavity surface-emitting laser (VCSELs), it may be possible to realize fast laser scanners.

The ability of lasers to harden liquid polymers, together with laser scanners, is used in rapid prototyping, the ability to melt polymers and metals is, with laser scanners, to produce parts by laser sintering or laser melting. The principle that is used for all these applications includes a software that runs on a PC or an embedded system and that controls the complete process is connected with a scanner card. That card converts the received vector data to movement information which is sent to the scan-head. This scan-head consists of two mirrors that are able to deflect the laser beam in one level (X- and Y-coordinate). The third dimension is—if necessary—realized by a specific optic that is able to move the laser's focal point in the depth-direction (Z-axis). Scanning the laser focus in the third spatial dimension is needed for some special applications like the laser scribing of curved surfaces or for in-glass-marking where the laser has to influence the material at specific positions within it.

For enhanced laser scanning applications and/or high material throughput during production, scanning systems with more than one scan-head are used. Here the software has to control what is done exactly within such a multi-head application: it is possible that all available heads have to mark the same to finish processing faster or that the heads mark one single job in parallel where every scan-head performs a part of the job in case of large working areas.

Camera. Any devices that may generate visual or non-visual image data encoding a captured visual image may be collected referred to herein as “camera”. In various embodiments, the pixel values of a visual image encode information about the detected wave's/photon's intensity, amplitude, frequency, wavelength, polarization, and/or phase. That is, the pixel values of visual images encode various detected aspects waves/photons received from (i.e., reflected from or emitted by) tangible objects in the environment. The pixel values of visual images may be encoded in a Red-Green-Blue (RGB) format, a greyscale format, or any other such format. The term “visual map” may refer to a visual image that is a map. That is, a visual map is a visual image that is associated with a coordinate system. The term “visual-domain” may refer to encoding or representing visual features. Thus, visual images and visual maps may be referred to as being represented in a visual-domain. Digital photography is described in an article by Robert Berdan (downloaded from ‘canadianphotographer.com’ preceded by ‘www.’) entitled: “Digital Photography Basics for Beginners”, and in a guide published on April 2004 by Que Publishing (ISBN: 0-7897-3120-7) entitled: “Absolute Beginner's Guide to Digital Photography” authored by Joseph Ciaglia et al., which are both incorporated in their entirety for all purposes as if fully set forth herein.

A digital camera may be a digital still camera that converts captured image into an electric signal upon a specific control or can be a video camera, wherein the conversion between captured images to the electronic signal is continuous (e.g., 24 frames per second). Further, any camera may be a digital camera, wherein the video or still images are converted using an electronic image sensor. A digital camera typically includes a lens (or a few lenses) for focusing the received light centered around an optical axis (referred to herein as a line-of-sight) onto the small semiconductor image sensor. The optical axis is an imaginary line along which there is some degree of rotational symmetry in the optical system, and typically passes through the center of curvature of the lens and commonly coincides with the axis of the rotational symmetry of the sensor. The image sensor commonly includes a panel with a matrix of tiny light-sensitive diodes (photocells), converting the image light to electric charges and then to electric signals, thus creating a video picture or a still image by recording the light intensity. Charge-Coupled Devices (CCD) and CMOS (Complementary Metal-Oxide-Semiconductor) are commonly used as light-sensitive diodes. Linear or area arrays of light-sensitive elements may be used, and the light-sensitive sensors may support monochrome (black & white), color, or both. For example, the CCD sensor KAI-2093 Image Sensor 1920 (H) X 1080 (V) Interline CCD Image Sensor or KAF-50100 Image Sensor 8176 (H) X 6132 (V) Full-Frame CCD Image Sensor can be used, available from the Image Sensor Solutions, Eastman Kodak Company, Rochester, New York. Further, any video or image processing may use, or may be based on, the algorithms and techniques disclosed in the book entitled: “Handbook of Image & Video Processing”, edited by Al Bovik, by Academic Press, ISBN: 0-12-119790-5, which is incorporated in its entirety for all purposes as if fully set forth herein.

The single lens or a lens array is positioned to collect optical energy representative of a subject or scenery, and to focus the optical energy onto the photosensor array. Commonly, the photosensor array is a matrix of photosensitive pixels, which generates an electric signal that is representative of the optical energy directed at the pixel by the imaging optics. The captured image (still images or part of video data) may be stored in a memory, which may be volatile or non-volatile memory, and may be a built-in or removable media. Many stand-alone cameras use SD format, while a few use CompactFlash or other types.

Stereo camera. A stereo camera is a type of camera with two or more lenses with a separate image sensor or film frame for each lens, which allows the stereo camera to simulate human binocular vision, and therefore gives it the ability to capture three-dimensional images, a process known as stereo photography. Stereo cameras may be used for making stereoviews and 3D pictures for movies, or for range imaging. Given a series of two-dimensional images it is possible to extract a significant amount of auxiliary information about the scene being captured, such as knowledge about the relative depth of objects in the scene. Given two images of a single scene it is possible to extract the depth of various objects in the scene from the disparity between the two images.

A stereo depth camera consists of two sensors, similar to human eyes, that capture two slightly different images. By comparing these images, the camera calculates the depth of objects in its field of view. This is achieved through a process called stereopsis, where the slight differences in the images from each sensor (known as parallax) are analyzed to determine the distance to various points in the scene. This technology enables the camera to perceive and map the three-dimensional structure of the environment, making it valuable in applications such as robotics, autonomous vehicles, and augmented reality. Being able to retrieve this depth information is useful for any number of applications. Most prominent of these are 3D scene reconstruction, where the depth information is used to aid in the creation of a three-dimensional model of the scene being captured. Similarly, robotics applications often use a rough 3D scene model garnered from a stereo rig to model the world around a robot in order to provide sane movement and navigation data to the machine.

Thermal camera. Thermal imaging is a method of improving visibility of objects in a dark environment by detecting the objects infrared radiation and creating an image based on that information. Thermal imaging, near-infrared illumination, and low-light imaging are the three most commonly used night vision technologies. Unlike the other two methods, thermal imaging works in environments without any ambient light. Like near-infrared illumination, thermal imaging can penetrate obscurants such as smoke, fog and haze. All objects emit infrared energy (heat) as a function of their temperature, and the infrared energy emitted by an object is known as its heat signature. In general, the hotter an object is, the more radiation it emits. A thermal imager (also known as a thermal camera) is essentially a heat sensor that is capable of detecting tiny differences in temperature. The device collects the infrared radiation from objects in the scene and creates an electronic image based on information about the temperature differences. Because objects are rarely precisely the same temperature as other objects around them, a thermal camera can detect them and they will appear as distinct in a thermal image.

A thermal camera, also known as thermographic camera, is a device that forms a heat zone image using infrared radiation, similar to a common camera that forms an image using visible light. Instead of the 400-700 nanometer range of the visible light camera, infrared cameras operate in wavelengths as long as 14,000 nm (14 μm). A major difference from optical cameras is that the focusing lenses cannot be made of glass, as glass blocks long-wave infrared light. Typically, the spectral range of thermal radiation is from 7 to 14 mkm. Special materials such as Germanium, calcium fluoride, crystalline silicon or newly developed special type of Chalcogenide glass must be used. Except for calcium fluoride all these materials are quite hard but have high refractive index (n=4 for germanium) which leads to very high Fresnel reflection from uncoated surfaces (up to more than 30%). For this reason, most of the lenses for thermal cameras have antireflective coatings.

LIDAR. Light Detection And Ranging-LIDAR-also known as Lidar, LiDAR or LADAR (sometimes Light Imaging, Detection, And Ranging), is a surveying technology that measures distance by illuminating a target with a laser light. Lidar is popularly used as a technology to make high-resolution maps, with applications in geodesy, geomatics, archaeology, geography, geology, geomorphology, seismology, forestry, atmospheric physics, Airborne Laser Swath Mapping (ALSM) and laser altimetry, as well as laser scanning or 3D scanning, with terrestrial, airborne and mobile applications. Lidar typically uses ultraviolet, visible, or near infrared light to image objects. It can target a wide range of materials, including non-metallic objects, rocks, rain, chemical compounds, aerosols, clouds and even single molecules. A narrow laser-beam can map physical features with very high resolutions; for example, an aircraft can map terrain at 30 cm resolution or better. Wavelengths vary to suit the target: from about 10 micrometers to the UV (approximately 250 nm). Typically light is reflected via backscattering. Different types of scattering are used for different LIDAR applications: most commonly Rayleigh scattering, Mie scattering, Raman scattering, and fluorescence. Based on different kinds of backscattering, the LIDAR can be accordingly referred to as Rayleigh Lidar, Mie Lidar, Raman Lidar, Na/Fe/K Fluorescence Lidar, and so on. Suitable combinations of wavelengths can allow for remote mapping of atmospheric contents by identifying wavelength-dependent changes in the intensity of the returned signal. Lidar has a wide range of applications, which can be divided into airborne and terrestrial types. These different types of applications require scanners with varying specifications based on the data's purpose, the size of the area to be captured, the range of measurement desired, the cost of equipment, and more.

LIDAR technology is being used in robotics for the perception of the environment as well as object classification. The ability of LIDAR technology to provide three-dimensional elevation maps of the terrain, high precision distance to the ground, and approach velocity can enable safe landing of robotic and manned vehicles with a high degree of precision. LiDAR has been used in the railroad industry to generate asset health reports for asset management and by departments of transportation to assess their road conditions. LIDAR is used in Adaptive Cruise Control (ACC) systems for automobiles. Systems use a LIDAR device mounted on the front of the vehicle, such as the bumper, to monitor the distance between the vehicle and any vehicle in front of it. In the event the vehicle in front slows down or is too close, the ACC applies the brakes to slow the vehicle. When the road ahead is clear, the ACC allows the vehicle to accelerate to a speed preset by the driver. Any apparatus herein, which may be any of the systems, devices, modules, or functionalities described herein, may be integrated with, or used for, Light Detection And Ranging (LIDAR), such as airborne, terrestrial, automotive, or mobile LIDAR.

Image. As used herein, the term “image” may refer to any 2D or 3D structured data (i.e., a data structure). The image data encoded in an image is structured as an array of pixels, each pixel storing pixel values. The array of pixels may be a 1D, 2D, or 3D array, depending upon the structure and dimensionality of the image. As used herein, the term “map,” may refer to an image that is associated with a spatial coordinate system. That is, each pixel of a map is associated with one or more coordinates of the coordinate system, wherein the associated coordinates uniquely indicate a spatial location or position. In some embodiments, the pixel values for a particular pixel of a map may encode the coordinates associated with or corresponding to the particular map pixel.

The term “visual image,” may refer to a 2D or 3D image, where the pixel values encode visual features (i.e., visual representations of tangible objects). Such encoded visual features within visual images include but are not limited to edges, surface textures, geometric shapes, colors, hues, lighting effects, and the likes. The visual features and/or visual representations may correspond to the tangible objects in the environment. The visual image data encoding visual images may be generated via various imagers or sensors that detect ElectroMagnetic (EM) waves or photons of various frequencies (or wavelengths). Imaging devices that may generate visual images include, but are not limited to cameras that detect visual wavelengths, InfraRed (IR) cameras, Ultra Violet (UV) cameras, Radio-Frequency (RF) detectors, microwave detectors, and the like. Such imaging devices may include LIght Detection And Ranging (LIDAR) cameras, Time-Of-Flight (TOF) cameras, or other laser-scanning-based cameras. Other imaging devices that generate visual images may include stereoscopic cameras, 3D cameras, and the like. A digital image is a numeric representation (normally binary) of a two-dimensional image. A pixel (abbreviated px), pel, or picture element is the smallest addressable element in a raster image, or the smallest addressable element in an all-points addressable display device; so it is the smallest controllable element of a picture represented on the screen. Depending on whether the image resolution is fixed, it may be of a vector or raster type. Raster images have a finite set of digital values, called picture elements or pixels. The digital image contains a fixed number of rows and columns of pixels, which are the smallest individual element in an image, holding quantized values that represent the brightness of a given color at any specific point. Typically, the pixels are stored in computer memory as a raster image or raster map, a two-dimensional array of small integers, where these values are commonly transmitted or stored in a compressed form. The raster images can be created by a variety of input devices and techniques, such as digital cameras, scanners, coordinate-measuring machines, seismographic profiling, airborne radar, and more. Common image formats include Graphics Interchange Format (GIF), the Joint Photographic Experts Group (JPEG) that uses ‘.jpg’ or ‘.jpeg’ filename extension, and Portable Network Graphics (PNG).

Video. The term ‘video’ typically pertains to numerical or electrical representation or moving visual images, commonly referring to recording, reproducing, displaying, or broadcasting the moving visual images. Video, or a moving image in general, is created from a sequence of still images called frames, and by recording and then playing back frames in quick succession, an illusion of movement is created. Video can be edited by removing some frames and combining sequences of frames, called clips, together in a timeline. A Codec, short for ‘coder-decoder’, describes the method in which video data is encoded into a file and decoded when the file is played back. Most video is compressed during encoding, and so the terms codec and compressor are often used interchangeably. Codecs can be lossless or lossy, where lossless codecs are higher quality than lossy codecs, but produce larger file sizes. Transcoding is the process of converting from one codec to another. Common codecs include DV-PAL, HDV, H.264, MPEG-2, and MPEG-4. Digital video is further described in Adobe Digital Video Group publication updated and enhanced March 2004, entitled: “A Digital Video Primer—An introduction to DV production, post-production, and delivery”, which is incorporated in its entirety for all purposes as if fully set forth herein.

Digital video data typically comprises a series of frames, including orthogonal bitmap digital images displayed in rapid succession at a constant rate, measured in Frames-Per-Second (FPS). In interlaced video each frame is composed of two halves of an image (referred to individually as fields, two consecutive fields compose a full frame), where the first half contains only the odd-numbered lines of a full frame, and the second half contains only the even-numbered lines.

Many types of video compression exist for serving digital video over the internet, and on optical disks. The file sizes of digital video used for professional editing are generally not practical for these purposes, and the video requires further compression with codecs such as Sorenson, H.264, and more recently, Apple ProRes especially for HD. Currently widely used formats for delivering video over the internet are MPEG-4, Quicktime, Flash, and Windows Media. Other PCM based formats include CCIR 601 commonly used for broadcast stations, MPEG-4 popular for online distribution of large videos and video recorded to flash memory, MPEG-2 used for DVDs, Super-VCDs, and many broadcast television formats, MPEG-1 typically used for video CDs, and H.264 (also known as MPEG-4 Part 10 or AVC) commonly used for Blu-ray Discs and some broadcast television formats.

TSP. The traveling salesman problem consists of a salesman and a set of cities. The salesman has to visit each one of the cities starting from a certain one (e.g., the hometown) and returning to the same city. The challenge of the problem is that the traveling salesman wants to minimize the total length of the trip. The Traveling Salesman Problem (TSP) can simply be stated as: if a traveling salesman wishes to visit exactly once each of a list of m cities (where the cost of traveling from city i to city j is cij) and then return to the home city, what is the least costly route the traveling salesman can take?. The TSP problem is a NP problem that is actually NP-Hard, and belongs in the class of such problems known as NP-complete. TSP is usually modeled using graphs. A graph is an ordered pair G=(V, E), where V is a set of vertices and E is a set of edges. Graphs can be drawn using points for vertices and lines for edges. In the case of TSP every city is a vertex and edges has weight which represents the length between two cities. For this problem all vertex are connected with each other, this is call a complete graph. Having this property guarantees that the circle exists (with Hamiltonian Cycle you have to find if the circle exists).

TSP can be modelled as an undirected weighted graph, such that cities are the graph's vertices, paths are the graph's edges, and a path's distance is the edge's weight. It is a minimization problem starting and finishing at a specified vertex after having visited each other vertex exactly once. Often, the model is a complete graph (i.e., each pair of vertices is connected by an edge). If no path exists between two cities, adding an arbitrarily long edge will complete the graph without affecting the optimal tour.

A TSP may be asymmetric or symmetric. In the symmetric TSP, the distance between two cities is the same in each opposite direction, forming an undirected graph. This symmetry halves the number of possible solutions. In the asymmetric TSP, paths may not exist in both directions or the distances might be different, forming a directed graph. Traffic collisions, one-way streets, and airfares for cities with different departure and arrival fees are examples of how this symmetry could break down.

One way to sole a TSP is by devising exact algorithms, which work reasonably fast only for small problem sizes. The most direct solution would be to try all permutations (ordered combinations) and see which one is cheapest (using brute force search). Other approach for solving TSP is using “suboptimal” or heuristic algorithms, i.e., algorithms that deliver either seemingly or probably good solutions, but which could not be proved to be optimal. Heuristics are algorithms which try to do the best possible to find the solution, but there is no guarantee that the solution found is the best. Another approach involves finding special cases for the problem (“subproblems”) for which either better or exact heuristics are possible. Various heuristics and approximation algorithms, which quickly yield good solutions have been devised. Modern methods can find solutions for extremely large problems (millions of cities) within a reasonable time which are with a high probability just 2-3% away from the optimal solution. Heuristics solutions may involve constructive heuristics, the nearest neighbour (NN) algorithm (a greedy algorithm) which lets the salesman choose the nearest unvisited city as his next move, and the Christofides'algorithm for the TSP that follows a similar outline but combines the minimum spanning tree with a solution of another problem, minimum-weight perfect matching, and the pairwise exchange or 2-opt technique that involves iteratively removing two edges and replacing these with two different edges that reconnect the fragments created by edge removal into a new and shorter tour.

An introduction to the Traveling Salesman Problem that includes current research is described in a paper entitled: “THE TRAVELING SALESMAN PROBLEM” by Corinne Brucato published 2013 by the University of Pittsburgh, which is incorporated in its entirety for all purposes as if fully set forth herein. Although a global solution for the Traveling Salesman Problem does not yet exist, there are algorithms for an existing local solution. There are also necessary and sufficient conditions to determine if a possible solution does exist when one is not given a complete graph. Additionally, the algorithms are used to and a route traveling through twenty US colleges. As well, we use the Geometric Algorithm to assign scouts for the Pittsburgh Pirates.

The Traveling Salesman Problem (TSP) has been an early proving ground for many approaches to combinatorial optimization, including classical local optimization techniques as well as many of the more recent variants on local optimization, such as simulated annealing, tabu search, neural networks, and genetic algorithms. A chapter entitled: “The Traveling Salesman Problem: A Case Study in Local Optimization” by David S. Johnson and Lyle A. McGeoch published Nov. 20, 1995, which is incorporated in its entirety for all purposes as if fully set forth herein, discusses how these various approaches have been adapted to the TSP and evaluates their relative success in this perhaps atypical domain from both a theoretical and an experimental point of view.

Solving a Traveling Salesman Problem (TSP) is described in U.S. Patent Application Publication No. 2003/0084011 to Shetty entitled: “Methods for solving the traveling salesman problem”, which is incorporated in its entirety for all purposes as if fully set forth herein. The TSP solving is by selecting a set of locations to visit, selecting a starting point and an ending point from the set of locations, applying a search method to the set of locations, and providing a route as a solution to the TSP, where the search method is a combinatoric approach to a genetic search and the search method simultaneously minimizes distance and time. The route starts and ends in different locations and completes in polynomial time, such as O(n+k), where k is a constant. The solution to the TSP has many applications, including finding distribution chains to satisfy customer demand for an Internet enterprise.

A system for generating three-dimensional objects by using stereolithography (SLA) is disclosed in U. S U.S. Pat. No. 4,575,330 to Hull entitled: “Apparatus for production of three-dimensional objects by stereolithography”, which is incorporated in its entirety for all purposes as if fully set forth herein. The 3D objects are generated by creating a cross-sectional pattern of the object to be formed at a selected surface of a fluid medium capable of altering its physical state in response to appropriate synergistic stimulation by impinging radiation, particle bombardment or chemical reaction, successive adjacent laminae, representing corresponding successive adjacent cross-sections of the object, being automatically formed and integrated together to provide a step-wise laminar buildup of the desired object, whereby a three-dimensional object is formed and drawn from a substantially planar surface of the fluid medium during the forming process.

A three-dimensional shape forming apparatus that forms a three-dimensional shape is disclosed in European Patent Office Patent No. EP 0376571 B1 to Takano et al. entitled: “Apparatus and method for producing three-dimensional objects”, which is incorporated in its entirety for all purposes as if fully set forth herein. The three-dimensional shape is formed by continuously laminating a cured resin layer made by irradiating a liquid light curable resin material with a beam and selectively curing the material. The three-dimensional shape forming apparatus, comprising: a housing container formed of a conductor for housing a liquid photocurable resin material; a high-frequency heating coil disposed in proximity to the housing container; and a liquid light housed in the housing container. A liquid temperature sensor that measures the liquid temperature of the curable resin material, and a supply of a high-frequency current to the high-frequency heating coil is controlled based on the measurement result of the liquid temperature sensor so that the liquid photocurable resin material is set to an appropriate temperature. By providing the temperature control means, the viscosity of the liquid photocurable resin material can be reduced by controlling the liquid temperature of the liquid photocurable resin material in an inexpensive and safe manner. Liquid photocurable tree of specified thickness It is possible to position the timber, yet the viscosity becomes low because a uniform thickness, thereby rises up and its formation accuracy the rate of three-dimensional shape formation.

An apparatus incorporating a movable dispensing head provided with a supply of material which solidifies at a predetermined temperature, and a base member, is disclosed in U. S U.S. Pat. No. 5,340,433 to Crump entitled: “Apparatus and method for creating three-dimensional objects”, which is incorporated in its entirety for all purposes as if fully set forth herein. The movable dispensing head and the base member are moved relative to each other along “X,” “Y,” and “Z” axes in a predetermined pattern to create three-dimensional objects by building up material discharged from the dispensing head onto the base member at a controlled rate. The apparatus is preferably computer driven in a process utilizing computer aided design (CAD) and computer-aided manufacturing (CAM) software to generate drive signals for controlled movement of the dispensing head and base member as material is being dispensed. The three-dimensional objects may be produced by depositing repeated layers of solidifying material until the shape is formed. Any material, such as self-hardening waxes, thermoplastic resins, molten metals, two-part epoxies, foaming plastics, and glass, which adheres to the previous layer with an adequate bond upon solidification, may be utilized. Each layer base is defined by the previous layer, and each layer thickness is defined and closely controlled by the height at which the tip of the dispensing head is positioned above the preceding layer.

An apparatus and a method for calibrating and normalizing a stereolithographic apparatus are disclosed in U.S. Pat. No. 5,495,328 to Spence et al. entitled: “Apparatus and method for calibrating and normalizing a stereolithographic apparatus”, which is incorporated in its entirety for all purposes as if fully set forth herein. A reaction means directed by a positioning means supplied with positioning means information may be positioned accurately on a designated surface of a working medium. One or more sensors fixed in location with respect to the designated surface of the working medium are utilized to correlate positioning means information with specific locations on the designated surface of the working medium. Other locations intermediate the specific locations may then be determined by the technique of linear interpolation.

Methods and an apparatus for the fabrication of solid three-dimensional objects from liquid polymerizable materials are described in U.S. Pat. No. 9,498,920 to DeSimone et al. entitled: “Method and apparatus for three-dimensional fabrication”, which is incorporated in its entirety for all purposes as if fully set forth herein. In general, the method comprises the steps of: (a) providing a carrier and a rigid stationary build plate, the build plate comprising a fixed semipermeable member, said semipermeable member comprising a build surface and a feed surface separate from said build surface (e.g., on the opposite side, or edge of the semipermeable member, and/or on the top thereof but at location separate from the build region), with the build surface and the carrier defining a build region therebetween, and with the feed surface in fluid contact with a (liquid or gas) polymerization inhibitor; (b) filling the build region with a polymerizable liquid, said polymerizable liquid contacting said build segment, and then, and/or while concurrently; (c) irradiating (e.g., with actinic radiation) the build region through the build plate to produce a solid polymerized region in the build region, with a liquid film release layer comprised of the polymerizable liquid formed between the solid polymerized region and the build surface, the polymerization of which liquid film is inhibited by said polymerization inhibitor; and then, and/or while concurrently; and (d) advancing the carrier with the polymerized region adhered thereto away from the build surface on the stationary build plate to create a subsequent build region between the polymerized region and the top zone of the build plate.

In one example, it would be an advancement in the art to provide methods and systems for additive 3D manufacturing using light-cured resin, such as where layers are added by providing resin via a cavity in the in-process formed 3D object, that are simple, scalable, fast, cost-effective, reliable, has a minimum part count, minimum hardware, and/or uses existing and available components and applications for providing better quality of formed 3D objects, better or optimal resources allocation, allows for rapid prototyping, and provides a better user experience.

### SUMMARY

High speed, accurate, scalable, and size-independent additive manufacturing or printing of a Three-Dimensional (3D) object may use incrementally solidifying light-sensitive resin layers. A new layer is formed by supplying the resin liquid via a cavity, that may serve as a pathway for a light-cured resin fluid, in the formed 3D object, and curing the supplied resin passed via the cavity by a focused light beam, such as a laser beam. The added layers are formed by supplying, using a pump, the light-cured resin fluid to the bottom opening to be output from the top opening via a vertical cavity of the 3D object. The curing is by focusing a light beam that cures the area of the resin output from the top opening, while keeping the top opening non-cured, so that resin can be passed via the cavity. Such 3D printing may be directly applied to any surface or device, such as a floor, wall, wing structure, or machined part, rendering it compatible with other manufacturing methods. A light-sensitive resin may be used in an additive manufacturing in which printed objects may be incrementally grown, and the printed object may be designed to be constructed from tubes. The resin fluid source may propel the building material, which may allow for a flow through the printed object, ultimately reaching its boundary, where a light beam may cure the resin, directing the growth of the object. Multiple light beams or multiple resin fluid sources may be used.

In one example, a 3D printer applies an additive manufacturing technology where a physical 3D geometry of a 3D object is built by successive addition of material. Units of material feedstock, such as a light-cured resin liquid, are brought together and joined, layer by layer, to build the 3D object, by curing the brought resin liquid at specific locations. In one example, the resin liquid is brought to the area to be cured via an unfilled space, that serves as a pathway for the light-cured resin fluid, within the 3D object being formed by the 3D printer.

Any resin fluid herein may be of a first type and may be stored in a first container, and any additional resin fluid herein may be of a second type and may be stored in second container. Any method herein may be used with an additional vertical cavity that may define an additional top opening and an additional bottom opening. Any dispensing herein may comprise dispensing, the resin fluid of the first type from the first container to the bottom opening, and dispensing, the additional resin fluid of the second type from the second container to the additional bottom opening. Any dispensing herein may comprise dispensing, the resin fluid of the first type from the first container to the additional bottom opening, and dispensing, the additional resin fluid of the second type from the second container to the bottom opening. Alternatively or in addition, any dispensing herein may comprise dispensing, the resin fluid of the first type from the first container to the bottom opening, and dispensing, the additional resin fluid of the second type from the second container to the bottom opening.

Any first type herein may be identical to, or different from, any second type herein. Any resin fluid herein may comprise a first color liquid, and any additional resin fluid herein may comprise a second color liquid. Alternatively or in addition, any resin fluid herein may comprise a conductive liquid, and any additional resin fluid may comprise a non-conductive liquid. Any method herein may be used with a selector that may be connected to pass liquid from any first or second container to the bottom opening. Any dispensing herein of any resin fluid may comprise selecting, by the selector, the resin liquid from the first container, and any dispensing hereon of any additional resin fluid may comprise selecting, by the selector, the additional resin liquid from the second container.

Any method herein may be used with a first valve that may be connected to pass liquid from the first container to the bottom opening, and with a second valve that may be connected to pass liquid from the second container to the bottom opening. Any dispensing herein of the resin fluid may comprise activating the first valve to pass the resin liquid from the first container, and any dispensing herein of the additional resin fluid may comprise activating the second valve to pass the additional resin liquid from the second container. Alternatively or in addition, any dispensing herein of the resin fluid may comprise dispensing, using the pump, the resin liquid from the first container, and any dispensing herein of the additional resin fluid may comprise dispensing, using the pump, the additional resin liquid from the second container. Alternatively or in addition, any dispensing herein of the resin fluid may comprise dispensing, using the pump, the resin liquid from the first container, and any dispensing herein of the additional resin fluid may comprise dispensing, using an additional pump, the additional resin liquid from the second container.

Any method herein may be used with multiple types of light-cured resin fluids, wherein the dispensing comprises dispensing at least two types of the light-cured resin fluids. Alternatively or in addition, any method herein may be used with multiple types of light-cured resin fluids, and any method herein may further comprise selecting a first type from the multiple types, and any dispensing herein may comprise dispensing the selected first type of the light-cured resin fluid. Any multiple types herein may comprise at least 2, 3, 4, 5, 7, 10, 12, 15, 20, 30, or 50 types. Alternatively or in addition, any multiple types herein may comprise less than 3, 4, 5, 7, 10, 12, 15, 20, 30, 50, or 100 containers.

At least one type of any multiple types herein may comprise a first color liquid, and at least one type of any multiple types herein may comprise a second color liquid that is different from the first color. Alternatively or in addition, at least one type of any multiple types herein may comprise a conductive liquid, and at least one type of any multiple types herein may comprise a non-conductive liquid. Alternatively or in addition, each of any multiple types herein may be stored in a respective container, and any dispensing herein may comprise obtaining the first type from the respective container. Any selecting herein may comprise using a controlled resin liquid selector between the containers and the 3D object, or may comprise manually controlling the resin liquid selector.

Any selector herein may comprise a valve that may be connected between a first container that may comprise the first type. Any selecting herein may comprise controlling the valve to pass or stop the resin fluid from the first container to the 3D object. Alternatively or in addition, any selector herein may comprise multiple valves, each may be connected to pass or stop one of the multiple types of light-cured resin fluids from a respective container to the 3D object.

Any valve herein may be used to control, regulate, or direct flow of liquids, such as the resin fluid, and may be used for starting or stopping any flow based on the valve state, regulating flow and pressure within any piping system herein, controlling the direction of any flow herein, throttling flow rates within a piping system, may be used for improving safety through relieving pressure or vacuum in any piping system herein, or any combination thereof. Any valve herein may comprise, or may be based on, a manual valve, an actuated valve, an automatic vale, or any combination thereof. Alternatively or in addition, any valve herein may comprise, or may be based on, a ball valve, butterfly valve, check valve, gate valve, knife gate valve, globe valve, needle valve, pinch valve, plug valve, pressure relief valve, or any combination thereof. Alternatively or in addition, any valve herein may comprise, or may be based on, an electrically controlled valve that may comprise a solenoid valve or a motorized valve. Alternatively or in addition, any valve herein may comprise, or may be based on, a stopper type closure, a vertical slide, a rotary type, a flexible body, or any combination thereof.

Any method herein may be used with a 3D model data by a Computer-Aided Design (CAD) system, that may be in a format that is based on, is compatible with, or is according to, STereoLithography (STL), Additive Manufacturing File Format (AMF), G-code, Standard for the Exchange of Product model data (STEP), or Initial Graphics Exchange Specification (IGES) standard. Any method herein may further comprise slicing, by a slicer, the 3D model data into layer slices that include the layer to be added.

Any method herein may further comprise partitioning of a layer, such as the obtained layer data, into multiple overlapping or non-overlapping area parts, and multiple of, most of, or all of, the area parts may be identical. Area parts may be shaped as non-overlapping identical squares. An area of one, each one of part of, each one of most of, or each one of all of, the area parts may be at least 0.001, 0.002, 0.005, 0.007, 0.01, 0.02, 0.05, 0.07, 0.1, 0.2, 0.5, 0.7, 1.0, 1.2, 1.5, 2.0, or 5.0 millimeter-square (mm²). Alternatively or in addition, an area of one, each one of part of, each one of most of, or each one of all of, the area parts may be less than 0.002, 0.005, 0.007, 0.01, 0.02, 0.05, 0.07, 0.1, 0.2, 0.5, 0.7, 1.0, 1.2, 1.5, 2.0, 5.0, or 10.0 millimeter-square (mm²).

Any curing herein may comprise curing by any light beam at least one of the area parts, or may comprise curing by any light beam all of the area parts. Any method herein may further comprise sequentially selecting one part out of, multiple parts of, or whole of, the area parts, or selecting of one area part at a time. Any dispensing herein of any light-cured resin fluid may comprise dispensing the light-cured resin fluid responsive to a lack of light-cured resin fluid in any selected area part. Any sequentially selecting herein may comprise selecting based on, or responsive to, an availability of the light-cured resin fluid in the area parts.

Any sequentially selecting herein may comprise solving a Travelling Salesman Problem (TSP), where locations of the area parts may replace the cities in the TSP, and where the associated costs for each route segment may comprise estimated distance, the time for moving to cure, between a pair of area parts, or any combination thereof. Any TSP herein may be a symmetric or asymmetric TSP, and may be solved using an exact or a heuristic algorithm.

Alternatively or in addition, any sequentially selecting herein may comprise, may use, or may be based on, a random, quazi-random, or deterministic selecting. Any selecting herein may use, may comprise, or may be based on, random selecting that may use one or more random numbers generated by a random number generator, that may be is hardware-based that may use, or may be based on, thermal noise, shot noise, nuclear decaying radiation, photoelectric effect, or quantum phenomena, or may be software-based that may use, or may be based on, executing an algorithm for generating pseudo-random numbers. Alternatively or in addition, any selecting herein may be based on, may comprise, or may use, sequential selection, cyclic selection, Last-In-First-Out (LIFO), First-In-First-Out (FIFO) scheme, or any combination thereof. Alternatively or in addition, any selecting herein may be based on, may comprise, or may use, a location of the area parts within the layer area, where the selecting may be based on first selecting area parts that are adjacent to an edge of the layer area. Alternatively or in addition, any selecting herein may be based on, may comprise, or may use, a current light source or light beam location, speed, and steering, or availability of a resin liquid thereon.

Any curing herein may comprise generating any light beam for the curing, such as by forming a light spot on the area of the resin fluid output for curing the resin liquid at the light spot. Any generating herein may comprise controlling a size, a shape, of any combination thereof, of the light spot, such as focusing, by an optical lens, the light beam to form the light spot. Any controlling herein may comprise controlling using an open-loop or a closed-loop control of a first distance between the optical lens and the area of the resin fluid output for optimal light spot. Any lens herein may be associated with a focal distance, and any controlling herein may comprise minimizing of the difference between a first distance and the focal distance, or may comprise adjusting a vertical height of the 3D object or adjusting the vertical height of the plate (on which upper surface the 3D object is placed) by a linear actuator. Alternatively or in addition, any controlling herein may comprise controlling lens position by a motorized actuator in a 3-axis scan-head.

Any method herein may further comprise estimating or measuring of the first distance, such as by estimating, measuring, or calculating using a sensor, or by estimating, measuring, or calculating the height of the 3D object. Any sensor herein may comprise a camera mounted to capture an image of the area of the resin fluid output, and any estimating or measuring herein of the first distance may comprise capturing, by the camera, the image of the area of the resin fluid output or the image of the light spot, processing the captured image for providing the first distance, or for providing a size, a shape, or any combination thereof, of the light spot.

Alternatively or in addition, any controlling herein may be performed in response to a powering up, may be in response to receiving of a user input, may be continuously performed, or may be in response to the obtaining of the layer data. Alternatively or in addition, any time interval between two the controlling comprises periodically controlling every time interval, and any time interval herein of at least two consecutive controlling actions may be more than 0.1, 0.2, 0.5, 1.0, 1.2, 1.5, 2.0, 3.0, 5.0, 10, 15, 20, 50, 100, 120, 150, 200, 500, or 1,000 seconds, or may be less than 0.2, 0.5, 1.0, 1.2, 1.5, 2.0, 3.0, 5.0, 10, 15, 20, 50, 100, 120, 150, 200, 500, 1,000 or 2,000 seconds.

Any curing herein may comprise generating the light beam for the curing and forming a light spot, that may be circular shaped, on the area of the resin fluid output. Any diameter herein, such as of any light spot, may be, or may be controlled to be, more than 1, 2, 5, 10, 15, 20, 50, 100, 120, 150, 200, 300, 500, or 1,000 microns, or may be, or may be controlled to be, less than 2, 5, 10, 15, 20, 50, 100, 120, 150, 200, 300, 500, 1,000, or 2,000 microns. Alternatively or in addition, any area herein, such as any light spot area, may be, or ma be controlled to be, more than 0.001, 0.002, 0.005, 0.01, 0.02, 0.05, 0.1, 0.2, 0.5, 1.0, 1.2, 1,5, 2.0, or 5.0 millimeter-square (mm²), or less than 0.002, 0.005, 0.01, 0.02, 0.05, 0.1, 0.2, 0.5, 1.0, 1.2, 1,5, 2.0, 5.0, or 10.0 millimeter-square (mm²).

Any 3D object herein may be placed on an upper flat horizontal surface of a plate, and any dispensing herein of any resin fluid to any bottom opening may be via a cavity in the plate. Any cavity herein, such as in the plate, may be at least in part aligned to the bottom opening of the vertical cavity of the 3D object. Any surface herein, such as any upper flat horizontal surface herein, may be plated, galvanized, painted, or coated. Any plate herein may be at least partly made of metal, plastics, glass, ceramics, an iron, a stainless steel, cast iron, tool steel, alloy steel, Aluminum, Titanium, Copper, Magnesium, or any combination thereof, and any plate herein may have a thickness of at least 1, 2, 5, 10, 15, 20, 50, 100, 120, 150, or 200 millimeters (mm), or less than 2, 5, 10, 15, 20, 50, 100, 120, 150, 200, or 300 millimeters (mm). Any area of any upper flat horizontal surface may be at least 10, 15, 20, 30, 50, 100, 120, 150, 200, 500, 1,000, 2,000, 5,000, 10,000, 20,000, 30,000, or 50,000 square-millimeters (mm²), or may be less than 15, 20, 30, 50, 100, 120, 150, 200, 500, 1,000, 2,000, 5,000, 10,000, 20,000, 30,000, 50,000, or 100,000 square-millimeters (mm²). Any upper flat horizontal surface herein may be polygon, circular, or ellipsoid shaped, and any polygon herein may comprise a square, a rectangle, a triangle, a pentagon, a hexagon, a heptagon, or an octagon, or wherein the polygon is simple, convex, concave, star-shaped, self-intersecting, or any combination thereof.

Any plate herein may be attachable or detachable. Any method herein may comprise detaching any plate, such as by separating the plate by a person without using any tool and without using an excessive force. Alternatively or in addition, any method herein may comprise attaching the plate using a fastener, such as non-permanently joining or affixing by a person without any tool and without using an excessive force. Any fastener herein may comprise a vertical support, such as one or more elongated bars. Any attaching herein, such as attaching of any plate herein, may comprise crimping, welding, soldering, brazing, taping, gluing, cement, using of an adhesive, using a magnet, using vacuum, using a suction cup, using friction, or any combination thereof.

Any plate herein may comprise a vertical hole in the plate that may be having an opening in the upper flat horizontal surface, that may be at least in part aligned with the vertical cavity, or that may be substantially located at a geometric center of the upper surface. Any dispensing herein of the resin fluid to the bottom opening may be via the opening. Any opening herein may be polygon, circular, or ellipsoid shaped, and any polygon herein may comprise a square, a rectangle, a triangle, a pentagon, a hexagon, a heptagon, or an octagon, or wherein the polygon is simple, convex, concave, star-shaped, self-intersecting, or any combination thereof. An area of any opening herein may be at least 0.1, 0.2, 0.5, 1, 2, 5, 10, 15, 20, 30, 50, 100, 120, 150, 200, 300, or 500 millimeters (mm), or may be less than 0.2, 0.5, 1, 2, 5, 10, 15, 20, 30, 50, 100, 120, 150, 200, 300, 500, or 1,000 millimeters (mm).

Any method herein may be used for adding a layer to any 3D object that may include an additional vertical cavity that may define additional top and additional bottom openings. Any method herein may comprise obtaining an additional layer data that defines an additional area to be added onto the 3D object; dispensing, using the pump, an additional light-cured resin fluid to the additional bottom opening for outputting and spreading from the additional top opening; and curing, by the light beam, at least part of the output and spread additional light-cured resin fluid according to the additional area, while keeping the additional top opening non-cured, so that the additional resin can be passed via the additional cavity, so that the additional layer is added after the curing.

Any method herein may be used for adding a layer to any 3D object having multiple cavities, each of the multiple cavities may include a respective vertical cavity that may define a respective top opening and a respective bottom opening. Any method herein may comprise obtaining a respective layer data that defines a respective area to be added onto each of the 3D object; dispensing, using the pump, light-cured resin fluid to the multiple bottom openings for outputting and spreading from the multiple top openings; and curing, by the light beam, at least part of the output and spread light-cured resin fluid according to the respective areas, while keeping the multiple top openings non-cured, so that the resin can be passed via the multiple cavities, so that the respective layer is added after the curing.

Any method herein may be further for adding a layer to an additional object that may include an additional vertical cavity that may define additional top and additional bottom openings. Any method herein may further comprise obtaining an additional layer data that may define an additional area to be added onto the additional 3D object; dispensing, using any pump, an additional light-cured resin fluid to the additional bottom opening for outputting and spreading from the additional top opening; and curing, by any light beam, at least part of the output and spread additional light-cured resin fluid according to the additional area, while keeping the additional top opening non-cured, so that the additional resin may be passed via the additional cavity, so that the additional layer may be added after the curing.

Alternatively or in addition, any method herein may be further for adding a layer to each of multiple objects that each may include a respective vertical cavity that may define a respective top opening and a respective bottom opening. Any method herein may comprise obtaining a respective layer data that may define a respective area to be added onto each of the multiple 3D object; dispensing, using any pump, light-cured resin fluid to the multiple bottom openings for outputting and spreading from the multiple top openings; and curing, by any light beam, at least part of the output and spread light-cured resin fluid according to the respective areas, while keeping the multiple top openings non-cured, so that the resin may be passed via the multiple cavities, so that the respective layer is added after the curing. Any multiple objects herein may comprise at least 2, 3, 4, 5, 7, 10, 12, 15, 20, 30, or 50 objects, or may comprise less than 3, 4, 5, 7, 10, 12, 15, 20, 30, 50, or 100 objects. At least two of, or all of, any multiple objects herein may be identical, may have the same shape, may have the same dimension, or may have the same structure.

Any multiple 3D objects herein may be placed on an upper flat horizontal surface of any plate having a single bottom opening and multiple top openings aligned with the cavities of the multiple objects, each of the top openings may be connected via a respective cavity to the bottom opening, and any dispensing herein may comprise dispensing of the resin fluid to any bottom opening. Alternatively or in addition, any multiple 3D objects herein may be are placed on an upper flat horizontal surface of any plate having multiple vertical cavities, each of the cavities may comprises bottom and top opening, and any dispensing herein may comprise dispensing of the resin fluid to any multiple bottom openings. Alternatively or in addition, any dispensing herein to any multiple bottom openings may comprise dispensing of the of the light-cured resin fluid to each of the bottom openings of the multiple vertical cavities.

Any resin herein may comprise blends of monomers, oligomers, and photoinitiators, Any curing herein may comprise toughening or hardening of a polymer material by cross-linking of polymer chains, or may comprise undergoing a photopolymerization process to cure the liquid resin into hardened plastic, so the resin may be photochemically solidified to form the layer area. Any resin herein may be cured by a visible light, or by a non-visible light, such as by a light in the Ultraviolet (UV) spectrum of the 365 to 405 nano-meter (nm) spectrum band. Alternatively or in addition, any resin herein may comprise, may use, or may be based on, a Standard Resin, a Clear Resin, an Engineering SLA Resins, a Tough Resin, a Durable Resin, a Heat Resistant Resin, a Flexible Resin, a Rigid Ceramic-Filled Resin, a Dental or Medical SLA Resin, a Class I Biocompatible Custom Medical Appliances Resin, a Class IIa Biocompatible Dental Long-Term Biocompatible Resin, a soluble resin (such as a water-soluble resin), a conductive resin, or a Castable SLA Resin.

Any curing herein by any light beam may comprise generating the light beam by a light projector, that may comprise, may use, or may be based on, an Eidophor, a Liquid Crystal on Silicon (LCOS or LCOS), or a Liquid Crystal Display (LCD) projector. Any light projector herein may comprise, or may be based on, Digital Light Processing (DLP™) technology that may comprise, or may be based on, a Digital Micromirror Device (DMD) chip that comprises a digitally controlled Micro-Electro-Mechanical System (MEMS) Spatial Light Modulator (SLM). Alternatively or in addition, any DLP projector herein may comprise, may use, or may be based on, an ultra-high-pressure lamp that may comprise, may use, or may be based on, a xenon arc lamp. Alternatively or in addition, any curing herein by any light beam may comprise generating the light beam by a light source that is powered from an electrical power source, and any generating herein may comprise controlling an intensity of the light beam using a Pulse Wide Modulation (PWM) controlled switching between the power source and the light source, such as by using a duty cycle of providing power from the power source to the light source may be more than 5%, 10%, 15%, 20%, 30%, 40%, 50%, 60%, 70%, 80%, or 90%, or that may be less than 10%, 15%, 20%, 30%, 40%, 50%, 60%, 70%, 80%, 90%, or 95%. A light intensity emitted from any light source herein may be more than 0.01, 0.02, 0.05, 0.1, 0.2, 0.5, 1.0, 1.2, 1.5, or 2.0 Watts (W), or may be less than 0.02, 0.05, 0.1, 0.2, 0.5, 1.0, 1.2, 1.5, 2.0, or 5.0 Watts (W).

Any curing herein, such as by any light beam, may comprise generating the light beam by a light source, and any light beam herein may be configured to emit visible light or non-visible light, such as InfraRed (IR), Ultra Violet (UV), X-rays, or gamma rays. Any light source herein may comprise a lamp, an incandescent lamp, a gas discharge lamp, a fluorescent lamp, a Solid-State Lighting (SSL), a Light Emitting Diode (LED), an Organic LED (OLED), a polymer LED (PLED), or a laser diode. Alternatively or in addition, any light source herein may be solid-state based, such as a light source that may consist of, that may comprise, or that may use, a Light-Emitting Diode (LED), an Organic LED (OLED), or a polymer LED (PLED). Any light source herein may comprise a coherent light emitter or a laser beam emitter, and any light beam herein may comprise a coherent light beam or a laser beam.

Alternatively or in addition, any light source or emitter herein may consist of, may comprise, may use, or may be based on, an electric light source that may convert electrical energy into light, and the electric light source may be configured to emit visible or non-visible light, and may be solid-state based. Alternatively or in addition, any light emitter herein may consist of, may comprise, or may use a Light-Emitting Diode (LED), which may be an Organic LED (OLED) or a polymer LED (PLED). Alternatively or in addition, any light emitter herein may consist of, may comprise, or may use a coherent or a laser beam emitter, which may comprise, or may use, a semiconductor or solid-state laser emitter, such as a laser diode. Alternatively or in addition, any light emitter herein may consist of, may comprise, or may be based on, silicon laser, Vertical Cavity Surface-Emitting Laser (VCSEL), a Raman laser, or a Quantum cascade laser, or a Vertical External-Cavity Surface-Emitting Laser (VECSEL), and may further consist of, comprise, or may use, a gas, chemical, or excimer laser.

Any method herein may further comprise focusing any light beam by a circular or non-circular lens, that may comprise, or may use, a wide-angle circular-shaped lens, a F-Theta lens, or a fisheye lens.

Any pump herein may be used to force or compress any resin liquid to any opening, such as any bottom opening. Any pump herein may use, may be based on, or may comprise, a direct lift, an impulse, a displacement, a valveless, a velocity, a centrifugal, a vacuum, a gravity pump, a positive displacement pump that comprises, or is based on, a rotary lobe, a progressive cavity, a rotary gear, a piston, a diaphragm, a screw, a gear, a hydraulic, a vane pump, a rotary-type positive displacement pump, an impulse pump, a rotodynamic pump, a syringe pump, a pressure vessel, or any combination thereof.

Any pump herein may comprises, may use, or may be based on, an internal gear, a screw, a shuttle block, a flexible vane, a sliding vane, a rotary vane, a circumferential piston, a helical twisted roots, a liquid ring vacuum pump, a reciprocating-type positive displacement type such as a piston, a diaphragm, a plunger, a diaphragm valve, or a radial piston pump, a rope-and-chain pump, a hydraulic ram, a pulser, an airlift pump, a velocity pump or a centrifugal pump, that may be a radial flow, an axial flow, a mixed flow pump, or any combination thereof.

Any supplying herein of any light-cured resin fluid may comprise feeding the resin fluid from a container that stores the resin fluid, and any feeding herein may comprise carrying a flow of the resin fluid from a container using a flexible hose or a pipe, or may comprise controlling (such as by using a nozzle) a direction, a rate of flow, a speed, a mass, a shape, a pressure of the resin fluid flow, or any combination thereof.

Any 3D object herein may be formed, manufactured, or placed on, any horizontal surface, and any method herein may further comprise adjusting a height of the horizontal surface by a linear actuator mechanically attached thereto. Any adjusting herein may comprise adjusting the height for adjusting a focus of the light beam. Any linear actuator herein may comprise, may be based on, or may use, a piezoelectric motor, a wax motor, a fluid power actuator, a linear hydraulic actuator, a pneumatic actuator, or any combination thereof. Any motion actuator herein may cause a rotary motion and a conversion mechanism for converting linear motion that may use, or may be based on, a screw, a wheel and axle, or a cam. Alternatively or in addition, any linear actuator herein may comprise, may use, or may be based on, a linear electrical motor that may comprise a DC brush, a DC brushless, a stepper, or an induction motor type. Alternatively or in addition, any linear actuator herein may comprise, may use, or may be based on, a linear electric motor that may comprise a Linear Induction Motor (LIM) or a Linear Synchronous Motor (LSM).

Any curing herein of any area may comprise deflecting, such as a raster scanning or vector scanning, of a visible or non-visible laser beam onto the area by a scan head that may be attached to receive the laser beam from a laser beam source. Any deflecting herein may be a two-dimensional deflecting that may comprise deflecting in two perpendicular directions. Any deflecting herein may comprise, or may be based on, moving mirrors in the scan head, scanning via refractive optics, or a material effect. Any moving mirrors herein may comprise rotating polygon mirror by a rotary encoder, electric motor, or stepper motor in the scan head. Alternatively or in addition, any moving mirrors herein may comprise servo-controlling a galvanometer by a rotary encoder, electric motor, or stepper motor in the scan head.

Alternatively or in addition, any deflecting herein may comprise, or may be based on, rotating two Risley prisms against each other in the scan head, for forming a beam of light that may be scanned inside a cone, may comprise, or may be based on, rotating an acousto-optic deflector or an electro-optic deflector in the scan head, may comprise, or may be based on, a phased array scanning, so that there are no moving parts in the scan head.

Any method herein may be used with an additional object that may have an additional cavity that may define additional top and additional bottom openings. Any dispensing herein may comprise dispensing the light-cured resin fluid to the additional bottom opening for outputting from the top additional opening. Alternatively or in addition, any method herein may comprise obtaining the additional object, and forming the additional cavity in the obtained additional object, such as by drilling or punching the additional cavity.

Alternatively or in addition, any method herein may comprise aligning the additional object so that the additional top opening is aligned with the bottom opening, for forming a continuous cavity of the vertical cavity and the additional cavity, so that the dispensing to the additional bottom opening is outputting from the top opening of the vertical cavity. Alternatively or in addition, any method herein may comprise mechanically securing the additional object to a surface, such as mechanically detachably attaching using suction, adhesive, stickers, glue, magnetic force, ‘hook-and loop’ fastening, crimping, welding, soldering, brazing, taping, gluing, cement, snap locking, tab inserting, magnets, vacuum (like suction cups), friction, using securing strap or band, or any combination thereof.

Any additional object material herein may be same as, similar to, or different from, any 3D object material herein. Any additional object herein may be at least partly made of metal, plastics, glass, ceramics, a cement-based material, a concrete, a Medium-density fibre (MDF), a plaster, a wood-based material, a composite material, a carbon-fiber, a fiberglass, or any combination thereof. Any additional object shape herein may be same as, similar to, or different from, any 3D object shape herein. Any additional object herein may be shaped as a cone, a cylinder, an ellipsoid, a sphere, a hyperboloid, a paraboloid, a box, a plate, a torus, a polytope, or any combination thereof.

Any method herein may further comprise capturing, such as by a camera that has an optical axis, an image that may be of a part of, or may be whole of, any object herein, such as the 3D object. Any optical axis herein may define a line-of-sight, and any camera herein may be mounted so that the line-of-sight may be directed or pointed to the top or bottom opening of any vertical cavity herein. Any capturing herein may be in a visible light or in a non-visible light, such as InfraRed (IR), Ultra Violet (UV), X-rays, or gamma rays. Any camera herein may consist of, may comprise, or may be based on, a MultiSpectral Scanner (MSS) that may collect data over a plurality of different wavelength ranges. Any capturing herein may comprise scanning, such as by the scanner, using across-track scanning, whisk-broom scanning, along-track scanning, push-broom scanning, or any combination thereof.

Alternatively or in addition, any camera herein may consist of, may comprise, or may be based on, a Light-Detection-and-Ranging (LIDAR) or Synthetic Aperture Radar (SAR), camera or scanner. Alternatively or in addition, any camera herein may consist of, may comprise, or may be based on, a digital still or video camera, that may be based on, or may include, a stereo camera, and that may be configured for focusing, by an optical lens mechanically oriented to guide the captured image, a received light; producing, by a photosensitive image sensor array in the camera disposed approximately at an image focal point plane of the optical lens, an analog signal representing the image; and converting, by an analog-to-digital (A/D) converter coupled to the image sensor array, the analog signal to a digital data representation of the captured image. Any image sensor array herein may use, or may be based on, semiconductor elements that use the photoelectric or photovoltaic effect, such as Charge-Coupled Devices (CCD) or Complementary Metal-Oxide-Semiconductor Devices (CMOS) elements. Any image herein may be based on a format that may be based on, may use, or may be compatible with, Portable Network Graphics (PNG), Graphics Interchange Format (GIF), Joint Photographic Experts Group (JPEG), Windows bitmap (BMP), Exchangeable image file format (Exif), Tagged Image File Format (TIFF), or Raw Image Formats (RIF).

Alternatively or in addition, any camera herein may consist of, may comprise, or may be based on, a digital video camera that may produce a video data stream, and any capturing herein may comprise capturing the video data stream, or an image therefrom. Any digital video format herein may use, may be compatible with, or may be based on TIFF (Tagged Image File Format), RAW format, AVI, DV, MOV, WMV, MP4, DCF (Design Rule for Camera Format), ITU-T H.261, ITU-T H.263, ITU-T H.264, ITU-T CCIR 601, ASF, Exif (Exchangeable Image File Format), DPOF (Digital Print Order Format), High-Definition (HD), Standard-Definition (SD) format, ISO/IEC 14496 standard, MPEG-4 standard, or ITU-T H.264 standard.

Any selection herein, such as selection of a next sub-area to cure, may be based on, or may use, load balancing or random selection. Any random selection herein may use, or may be based on, one or more random numbers generated by a random number generator. Any random number generator herein may be hardware based, and may be using thermal noise, shot noise, nuclear decaying radiation, photoelectric effect, or quantum phenomena. Alternatively or in addition, any random number generator herein may be software based, and may be based on executing an algorithm for generating pseudo-random numbers.

The above summary is not an exhaustive list of all aspects of the present invention. Indeed, it is contemplated that the invention includes all systems and methods that can be practiced from all suitable combinations and derivatives of the various aspects summarized above, as well as those disclosed in the detailed description below and particularly pointed out in the claims filed with the application. Such combinations have particular advantages not specifically recited in the above summary.

### BRIEF DESCRIPTION OF THE DRAWINGS

The invention is herein described, by way of non-limiting examples only, with reference to the accompanying drawings, wherein like designations denote like elements. Understanding that these drawings only provide information concerning typical embodiments and are not therefore to be considered limiting in scope:

FIG. 1 pictorially depicts a simplified isometric view of a prior-art device for fabricating a three-dimensional object from a light curable liquid resin;

FIG. 2 pictorially depicts a simplified isometric view of an improved device for fabricating a three-dimensional object from a light curable liquid resin;

FIG. 3 pictorially depicts a simplified vertical cut in an opening in a 3D object carrying plate;

FIG. 4 schematically illustrates a block-diagram of a control system of a 3D printer;

FIGS. 5 and 5a schematically illustrate simplified flow-charts of printing a 3D object using a 3D printer that use a light-curable liquid resin;

FIGS. 6 and 6a pictorially depict simplified views a cone-shaped three-dimensional object being formed from a light curable liquid resin;

FIGS. 6b, 6c, and 6d pictorially depict simplified views of forming a cone-shaped three-dimensional object from a light curable liquid resin in a 3D printer;

FIG. 6e schematically illustrates three formulas relating to focus, including spot size, beam diameter, and depth of field calculations;

FIG. 7 schematically illustrates simplified flow-charts of a control loop for optimizing the focus or spot size of a curing light-beam;

FIG. 8 pictorially depicts simplified views of a cylinder-shaped object;

FIG. 8a pictorially depicts simplified external and cross-section cut views of an in-process cylinder-shaped 3D object;

FIGS. 8b and 8c pictorially depict simplified grid of tiles used to add a layer to an in-process cylinder-shaped 3D object;

FIG. 9 pictorially depicts simplified views of a triangular-shaped object;

FIGS. 9a-9c pictorially depict a simplified isometric view of an improved device for fabricating a three-dimensional object on another 3D object;

FIG. 9d schematically illustrates simplified flow-charts of a forming a 3D object over a substrate and using a detachable platform;

FIGS. 10-10d pictorially depict a simplified isometric view of an improved device for fabricating a three-dimensional object using a detachable platform;

FIG. 11 pictorially depicts a simplified 3D object carrying plate having internal splitting into multiple openings;

FIGS. 11a-11d pictorially depict simplified isometric views of an improved device for fabricating a three-dimensional object using a platform having a splitter into multiple openings;

FIGS. 12-12c pictorially depict simplified isometric views of an improved device for fabricating a three-dimensional object using a splitter external to the platform into multiple cavities in the platform;

FIGS. 13-13b pictorially depict simplified isometric views of an improved device for fabricating a three-dimensional object using three types of resin liquid;

FIGS. 14-14a schematically illustrate block-diagram of a control system of a 3D printer that uses three types of resin liquid;

FIG. 15 schematically illustrates simplified flow-charts of printing of a 3D object using multiple types of resin liquid;

FIGS. 16-16c pictorially depict simplified isometric views of an improved device for fabricating multiple three-dimensional objects using a platform having multiple openings respectively fed by respective multiple resin liquid containers;

FIG. 17 schematically illustrates a block-diagram of a control system of a 3D printer that uses using a platform having multiple openings respectively fed by respective multiple resin liquid containers;

FIG. 18 schematically illustrates simplified flow-charts of printing of a 3D object using a platform having multiple openings respectively fed by respective multiple resin liquid containers; and

FIGS. 19-19c pictorially depict simplified isometric views of an improved device for fabricating multiple three-dimensional objects using a platform having multiple openings fed by a single pipe from respective multiple resin liquid containers via respective pumps.

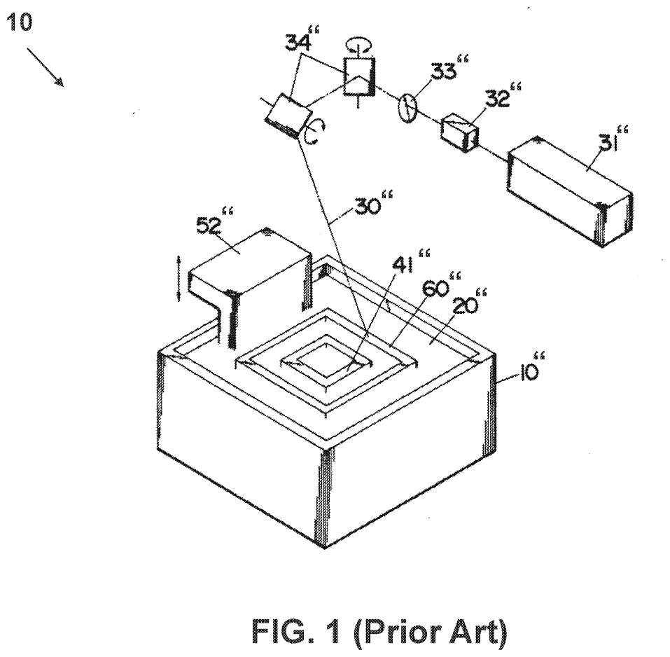

### DETAILED DESCRIPTION

The principles and operation of an apparatus or a method according to the present invention may be understood with reference to the figures and the accompanying description wherein identical or similar components (either hardware or software) appearing in different figures are denoted by identical reference numerals. The drawings and descriptions are conceptual only. In actual practice, a single component can implement one or more functions; alternatively or in addition, each function can be implemented by a plurality of components and devices. In the figures and descriptions, identical reference numerals indicate those components that are common to different embodiments or configurations. Identical numerical references (in some cases, even in the case of using different suffix, such as 5, 5a, 5b and 5c) refer to functions or actual devices that are either identical, substantially similar, similar, or having similar functionality. It is readily understood that the components of the present invention, as generally described and illustrated in the figures herein, could be arranged and designed in a wide variety of different configurations. Thus, the following more detailed description of the embodiments of the apparatus, system, and method of the present invention, as represented in the figures herein, is not intended to limit the scope of the invention, as claimed, but is merely representative of embodiments of the invention. It is to be understood that the singular forms “a”, “an”, and “the” herein include plural referents unless the context clearly dictates otherwise. Thus, for example, a reference to “a component surface” includes a reference to one or more of such surfaces. By the term “substantially” it is meant that the recited characteristic, parameter, feature, or value need not be achieved exactly, but that deviations or variations, including, for example, tolerances, measurement error, measurement accuracy limitations and other factors known to those of skill in the art, may occur in amounts that do not preclude the effect the characteristic was intended to provide.

All directional references used herein (e.g., upper, lower, upwards, downwards, left, right, leftward, rightward, top, bottom, above, below, vertical, horizontal, clockwise, and counterclockwise, etc.) are only used for identification purposes to aid the reader's understanding of the present invention, and do not create limitations, particularly as to the position, orientation, or use of the invention. Spatially relative terms, such as “inner,” “outer,” “beneath”, “below”, “right”, “left”, “upper”, “lower”, “above”, “front”, “rear”, “left”, “right” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In one example, a 3D object of formed from bottom to top by adding thin 2D layers, defined by resin liquid that is spread or laid out, creating a surface. Each layer is formed by supplying a resin via a cavity (such as a cylindrically-shaped cavity) in the formerly formed layers, and then cured by a light source according to the printing instructions, that are based on the shape of the layer to be added. The added layer includes an opening, so the cavity remains passable for a resin fluid, enabling resin to be pushed therethrough to form the next layer.

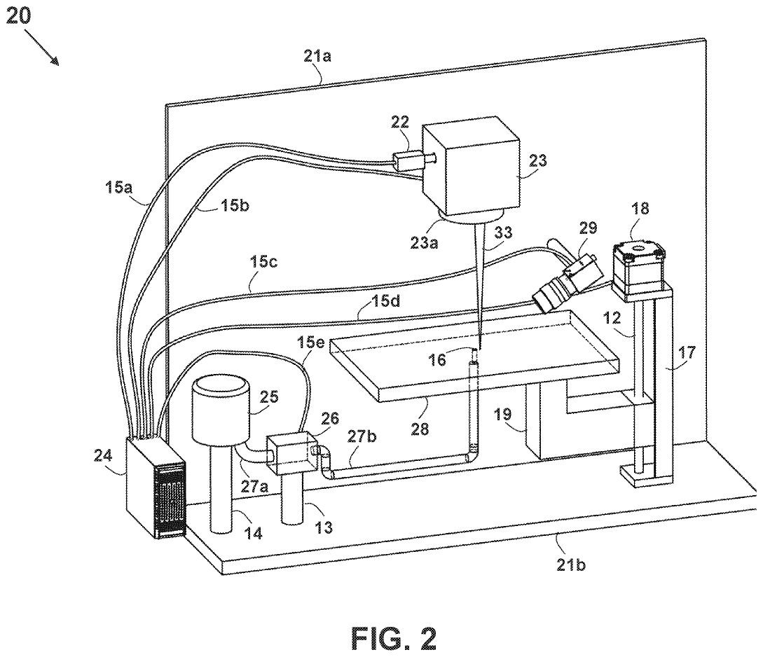

An example of an 3D printer 20 that uses an additive manufacturing is shown in FIG. 2. The 3D printer 20 framework may comprise a vertical plate 21a and a horizontal plate 21b that may serve as a chassis and may provide a structural support for the various components of the 3D printer 20, such as by mounting the components thereon. The 3D printer 20 uses photopolymerization of a resin liquid in which the liquid photopolymer is selectively cured by light-activated polymerization. A controller 24, that may be based on, includes, or be integrated with, a computer, and may serve to provide electrical power to the 3D printer 20, as well as to control and monitor the operation of the 3D printer 20. The controller 24 may be separated from, or may be mounted on, the 3D printer 20, such as being mounted on the horizontal plate 21b.

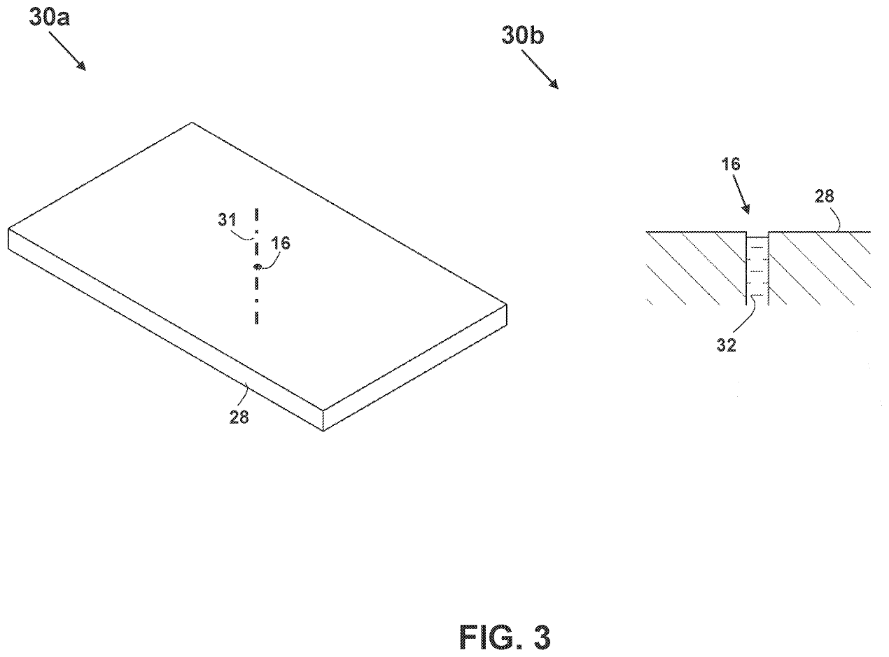

The 3D object may be formed on a horizontal rectangular build platform 28 using photopolymerization. The build platform 28 may be made of metal or plastic, and may include an opening 16, through which the resin liquid flows from the bottom side of the build platform 28, and spreads on the build platform 28 upper surface. The 3D printer 20 may include a resin container 25 for storing a light-curable resin liquid therein. The resin container 25 may serve as a feedstock storage, where the resin liquid, that is the bulk raw material for the additive manufacturing building process, is stored. The resin container 25 may be mounted onto the plate 21b using a vertical pole 14. The resin is supplied from the resin container 25 by a flexible tube or hose 27a, that carries the resin fluid to a fluid pump 26, that may be mounted onto the plate 21b using a vertical pole 13. The pump 26 is powered and controlled by the controller 24 via a cable 15e, and is controlled by the controller 24 to press the resin liquid from the resin container 25 (via the hose 27a) to the top opening 16 in the build platform 28, such as via a nozzle or orifice, using a flexible hose 27b. A view 30a in FIG. 3 of a vertical cut 31 in the build platform 28 is detailed in a view 30b in FIG. 3, showing the top opening 16 of the vertical cavity 32, which is shown filled with the resin liquid. The resin liquid level is shown not to reach the upper surface of the build platform 28. The hose 27a that carries the resin fluid from the container 25 to the pump 26, the hose 27b that carries the resin fluid from the pump 26 to the top opening 16, may be any cylindrical or non-cylindrical vessel suitable for moving or carrying fluids, and may be flexible or rigid, such as a tube or pipe.

The build platform 28 serves as the build platform, which is a base which provides a surface upon which the building of the part, such as the fabricated 3D object, is started and supported throughout the build process. The upper surface of the build platform 28 serves as the build surface, a flat surface area where the resin liquid is added (via the opening 16) on the last deposited layer which becomes the foundation upon which the next layer is formed. The 3D object parts are built attached onto the build platform 28 either directly, or through a support structure that is located between the formed 3D object and the upper surface of the build platform 28. The build platform 28 may be shaped as flat plate, and the upper build surface may be plated, galvanized, painted, or coated. The build platform 28 may be made of metal, such as an iron; an alloy such as stainless steel; or a molecular compound such as polymeric sulfur nitride. Further, the build platform 28 may be made of a metallic iron alloy such steel, stainless steel, cast iron, tool steel, alloy steel, as well as of Aluminum, Titanium, Copper, and Magnesium. Alternatively or in addition, the build platform 28 may be made of synthetic or semi-synthetic materials that use polymers as a main ingredient, such as plastics, may be made of a non-crystalline solid that is often transparent, brittle and chemically inert, such as glass, or may be made of hard, brittle, heat-resistant, and corrosion-resistant materials made, such as ceramics, for example earthenware, porcelain, or brick. Alternatively or in addition, the build platform 28 may be made of cement-based materials, such as concrete or plaster, wood-based materials (such as oak or pine), wood products (such as MDF or plaster), or composite materials (such as carbon fiber or fiberglass).

The thickness of the build platform 28 may be at least 1, 2, 5, 10, 15, 20, 50, 100, 120, 150, or 200 millimeters (mm). Alternatively or in addition, the thickness of the build platform 28 may be less than 2, 5, 10, 15, 20, 50, 100, 120, 150, 200, or 300 millimeters (mm). In one example, the opening 16 is located at the geometric center of the upper surface of the build platform 28. The area the upper surface of the build platform 28 that serves as the build surface may be at least 10, 15, 20, 30, 50, 100, 120, 150, 200, 500, 1,000, 2,000, 5,000, 10,000, 20,000, 30,000, or 50,000 square-millimeters (mm²). Alternatively or in addition, the area the upper surface of the build platform 28 that serves as the build surface may be less than 15, 20, 30, 50, 100, 120, 150, 200, 500, 1,000, 2,000, 5,000, 10,000, 20,000, 30,000, 50,000, or 100,000 square-millimeters (mm²).

While the upper surface of the build platform 28 that serves as the build surface is shown as rectangular, any shape may be equally used. For example, the plane of the upper surface of the build platform 28 may be made up of a polygon shape, where line segments are connected to form a closed polygonal chain. Any number of line segments may be used, such as forming a triangle, a square, a pentagon, a hexagon, a heptagon, or an octagon. Further, the polygon may be simple, convex, concave, star-shaped, or self-intersecting. Similarly, the polygon may be equiangular where all corner angles are equal, an equilateral where all edges are of the same length, a regular which is both equilateral and equiangular, a cyclic where all corners lie on a single circle (circumcircle), a tangential where all sides are tangent to an inscribed circle, an isogonal or vertex-transitive, where all corners lie within the same symmetry orbit, or any combination thereof. Alternatively or in addition, the surface, the plane of the upper surface of the build platform 28 may be circular or ellipsoid shaped.

The opening 16 may be polygon, circular, or ellipsoid shaped, such as a square, a rectangle, a triangle, a pentagon, a hexagon, a heptagon, or an octagon, or wherein the polygon is simple, convex, concave, star-shaped, self-intersecting, or any combination thereof. An area of the opening 16 may be at least 0.1, 0.2, 0.5, 1, 2, 5, 10, 15, 20, 30, 50, 100, 120, 150, 200, 300, or 500 millimeters (mm). Further, the area of the opening may be less than 0.2, 0.5, 1, 2, 5, 10, 15, 20, 30, 50, 100, 120, 150, 200, 300, 500, or 1,000 millimeters (mm).

Any liquid or fluid resin that may be used in SLA 3D printing may be equally used in the 3D printer 20, and may be stored in the resin container 25. Such fluid typically includes various blends of monomers, oligomers, photoinitiators, and other additives, where under light (such as the light emitted from the light emitter 22 shown as the beam 33) undergo a photopolymerization process to cure the liquid resin into hardened plastic. In one example, the light is in the Ultraviolet (UV) spectrum, such as UV light wave of 405 nm (nano-meter). Such photopolymers are sensitive to ultraviolet light, so the resin is photochemically solidified and forms a single layer of the desired 3D object. A photo-polymer or light-activated resin is a polymer that changes its properties when exposed to light, often in the ultraviolet or visible region of the electromagnetic spectrum. These changes are often manifested structurally, for example hardening of the material occurs as a result of cross-linking when exposed to light.

The resin in the container 25 may be a Standard Resin, a Clear Resin, an Engineering SLA Resins, a Tough Resin, a Durable Resin, a Heat Resistant Resin, a Flexible Resin, a Rigid Ceramic-Filled Resin, a Dental or Medical SLA Resin, a Class I Biocompatible Custom Medical Appliances Resin, a Class IIa Biocompatible Dental Long-Term Biocompatible Resin, a water-soluble resin (such as ‘3Dresyn Perfect Case WS1 Water Soluble resin’ available from 3Dresyn Resyner Technologies S.L., of Barcelona, Spain), a conductive resin (such as ‘3D-ADD GrapEK1 Bio’, available from 3Dresyn Resyner Technologies S.L., of Barcelona, Spain), or a Castable SLA Resins.

In one example, the resin liquid may be Standard Resin+ available from ANYCUBIC-US, described in a guide entitled: “User Guide for Standard Resin+” downloaded December 2023 from https://www.anycubic.com/collections/standard-resin. Standard Resin+ is a general-purpose 3D printing resin material. It enhances toughness, detail and precision on the basis of standard resin. It can be adapted to light curing equipment in the 365˜405 band, with good rigidity, better toughness, and shrinkage. The Standard Resin+ is defined to be cured using a wavelength of 365-405 nm, has a density of 1.15 g/cm3, a viscosity (at 25° C.) of 200 mPa·s, and a tensile strength of 35 MPa.

The light emitter 22 may consist of, may comprise, may use, or may be based on, an electric light source that may convert electrical energy into light, and the electric light source may be configured to emit visible or non-visible light, and may be solid-state based. Alternatively or in addition, any light emitter herein may consist of, may comprise, or may use a Light-Emitting Diode (LED), which may be an Organic LED (OLED) or a polymer LED (PLED). Alternatively or in addition, the light emitter 22 may consist of, may comprise, or may use a coherent or a laser beam emitter, which may comprise, or may use, a semiconductor or solid-state laser emitter, such as a laser diode. Alternatively or in addition, the light emitter 22 may consist of, may comprise, or may be based on, silicon laser, Vertical Cavity Surface-Emitting Laser (VCSEL), a Raman laser, or a Quantum cascade laser, or a Vertical External-Cavity Surface-Emitting Laser (VECSEL), and may further consist of, comprise, or may use, a gas, chemical, or excimer laser. In one example, the light source 22 may be based on, or may include, the LWPRO-405-1000-MM professional high-power semiconductor ultraviolet laser module, that provides stable continuous light output of 1000 mW at an emission wavelength of 405 nm, available from LAMBDAWAVE laser technology of Wegorzewo, Poland. The LWPRO-405-1000-MM laser module is described in a data-sheet “LWPRO-405-1000-MM-250423-1.0.0-EN (250423)” published 2023. In another example, the light source 22 may be based on, or may include, the RLTMDL-405 1-500 mW Violet Laser Diode Modul available from Roithner Lasertechnik GmbH, Vienna, Austria. This violet diode laser module at 405 nm is made features of ultra compact, long lifetime, low cost and easy operating, which is used in measurement, communication, and spectrum analysis, and is described in a data-sheet “RLTMDL-405 1-300 mW”published Sep. 8 2017.

In one example, the light emitter 22 may consist of, may comprise, may use, or may be based on, a projector, that may use, or may be based on, an Eidophor, Liquid Crystal on Silicon (LCOS or LCOS), or LCD, or may use Digital Light Processing (DLP™) technology. In one example, the light emitter 22 may consist of, may comprise, may use, or may be based on, a DLP projector, that may be based on a DMD chip, such as a ‘DLP651LE 0.65 WXGA Digital Micromirror Device’ available from Texas Instruments, Dallas, Texas, U.S. A., described in a data sheet DLPS153 published October 2023 entitled: “DLP651LE 0.65 WXGA Digital Micromirror Device”, which are both incorporated in their entirety for all purposes as if fully set forth herein. The DLP651LE Digital Micromirror Device (DMD) is a digitally controlled micro-electro-mechanical system (MEMS) Spatial Light Modulator (SLM) that enables affordable WXGA display solutions. The DLP651LE DMD, the DLPC4430 display controller, the DLPA100 power and motor driver, and the DLPA200 micromirror driver comprise the chipset. This chipset is a cost-optimized version of DLP650LE, offered in performance-enhancing hermetic packaging, designed to enable applications requiring a 16:10 aspect ratio with excellent brightness.

In one example, the light emitter 22 may consist of, may comprise, may use, or may be based on, the DLP projector that may use an ultra-high-pressure lamp. Such lamp may be a xenon arc lamp, where a constant-current supply is used, which starts with a sufficiently high open-circuit voltage (between 5 and 20 kV, depending on lamp) to cause an arc to strike between the electrodes, and once the arc is established, the voltage across the lamp drops to a given value (typically 20 to 50 volts) while the current increases to a level required to maintain the arc at optimal brightness. All xenon short-arc lamps generate substantial ultraviolet radiation, as Xenon has strong spectral lines in the UV bands, and these readily pass through the fused quartz lamp envelope. An example of such an ultra-high-pressure lamp that uses a high-pressure mercury arc lamp, is ‘Philips UHP 100 W/120 W 1.0 P22’, available from Koninklijke Philips Electronics N.V. of Eindhoven, Netherlands, described in Document#: ‘PHI/387-May.28-2008’ entitled: “Specification sheet UHP Replacement Lamps”, which is incorporated in its entirety for all purposes as if fully set forth herein. While the mercury arc lamp is not monochromatic, it has a band in the UV spectrum, and may be coupled with an optical filter, such as FBH405-3 band pass filter by Thorlabs, to provide a specific wavelength.

In one example, the light intensity emitted from the light source 22 may be more than 0.01, 0.02, 0.05, 0.1, 0.2, 0.5, 1.0, 1.2, 1.5, or 2.0 Watts (W). Alternatively or in addition, the light intensity emitted from the light source 22 may be less than 0.02, 0.05, 0.1, 0.2, 0.5, 1.0, 1.2, 1.5, 2.0, or 5.0 Watts (W).

The pump 26 may be include, or may be based on, any liquid push mechanism capable of moving (or compressing) fluids or liquids, commonly by pressure (such as by air or gas pressure) or suction actions, the resin fluid from the resin fluid container 25 to the opening 16 of the build platform 28 via the pipe or hose 27b. The pump 26 may use activating mechanism that may be reciprocating or rotary. The pump 26 may be a direct lift, impulse, displacement, valveless, velocity, centrifugal, vacuum pump, or gravity pump. Alternatively or in addition, the pump 26 may be a positive displacement pump, such as a rotary-type positive displacement type such as internal gear, screw, shuttle block, flexible vane or sliding vane, circumferential piston, helical twisted roots or liquid ring vacuum pumps, a reciprocating-type positive displacement type, such as piston or diaphragm pumps, and a linear-type positive displacement type, such as rope pumps and chain pumps, a rotary lobe pump, a progressive cavity pump, a rotary gear pump, a piston pump, a diaphragm pump, a screw pump, a gear pump, a hydraulic pump, and a vane pump. Alternatively or in addition, the pump 26 may be a rotary positive displacement pump that may be a gear pump, a screw pump, or a rotary vane pumps. Alternatively or in addition, the pump 26 may be a reciprocating positive displacement pump that may be plunger pumps type, diaphragm pumps type, diaphragm valves type, or radial piston pumps type.

Alternatively or in addition, the pump 26 may be an impulse pump such as hydraulic ram pumps type, pulser pumps type, or airlift pumps type. Alternatively or in addition, the pump 26 may be a rotodynamic pump such as a velocity pump or a centrifugal pump. Alternatively or in addition, the pump 26 may be a centrifugal pump that may be a radial flow pump type, an axial flow pump type, or a mixed flow pump. Alternatively or in addition, the pump 26 may be a syringe pump or a pressure vessel.

In one example, an end of the hose 27b that is attached to, or in, the opening 16 of the build platform 28, may include a device designed to control the direction or characteristics of the resin fluid flow (specially to increase velocity) as it exits (or enters) an enclosed chamber or pipe, such as a nozzle. The nozzle may be shaped or structured as a pipe or tube of varying cross-sectional area, and may be used to direct or modify the flow of the fluid. Further, the nozzle may be used to control the rate of flow, speed, direction, mass, shape, and/or the pressure of the fluid stream that emerges or outputs from them. When nozzle is used, the velocity of output resin fluid may be increased at the expense of its pressure energy.

The build platform 28 may be vertically elevated or lowered using the vertical rod 12 that is mechanically attached (directly or indirectly) to the build platform 28 via a right-angled bar 19. The linear actuator is mounted onto the horizontal plate 21b, and is mechanically powered by a motor 18 (that may be a stepper motor), that may be powered and controlled by the controller 24 by via a cable 15d. The vertical position of the build platform 28 may be controlled to be adjusted for optimal focus or location. The height of the build platform 28 may be adjusted, such as for focusing the light beam 33 onto the resin liquid spread to form a new layer, may use a linear actuator. In one example, a rotary-based linear actuators may be used, such as linear actuator that uses a screw, a wheel and axle, or a cam type. The screw actuator shown as part of the 3D printer 20 operates on the screw machine principle, whereby the motor 18 rotates an actuator nut, the screw shaft 12, that may be based on, or includes, a lead-screw, a screw jack, a ball screw, or roller screw, moves vertically in a line, thereby adjusting the build platform 28 height by the right-angled bar 19 attached thereto. In one example, as the screw 12 (or a leadscrew) rotates, its threads engage with corresponding threads in a nut. This interaction causes the nut to move along the length of the screw. The nut may be attached to the right-angled bar 19 that in turn is mechanically attached to the build platform 28 to be moved, thus translating the screw's rotational motion into the linear motion of the nut and the attached load.

In another example, the linear actuator 17 that comprises the motor 18 and the screw rod 12 uses, or is based on, a linear actuator from a family of “FSK—Open Screw Module” actuators available from FUYU Technology Co., LTD., of Chengdu city, Sichuan province, China, which data-sheet downloaded December 2023 from https://www.fuyumotion.com, which is incorporated in its entirety for all purposes as if fully set forth herein.

Any other a linear actuator that creates motion in a straight line may be equally used for adjusting the height of the build platform 28, such as in relation to the light director 23 (or the lens 23a) for focusing the light beam therefrom. Such linear actuator may use hydraulic or pneumatic cylinders which inherently produce linear motion, or may provide a linear motion by converting from a rotary motion created by a rotary actuator, such as electric motors.

Any wheel-and-axle linear actuator that operates on the principle of the wheel and axle, where a rotating wheel moves a cable, rack, chain or belt to produce linear motion, may be used. Examples are hoist, winch, rack and pinion, chain drive, belt drive, rigid chain, and rigid belt actuators. Cam actuator includes a wheel-like cam, which upon rotation, provides thrust at the base of a shaft due to its eccentric shape. Mechanical linear actuators may only pull, such as hoists, chain drive and belt drives, while others only push (such as a cam actuator). Some pneumatic and hydraulic cylinder-based actuators may provide force in both directions.

An example of a linear rail guide is available from Luna Technologies Pvt. Ltd. Headquartered in Navi Mumbai, India, described in a datasheet ‘CCM W45-15 LINEAR MODULE’ downloaded December 2023 from https://luna.co.in/wp-content/uploads/2019/12/W45-15.pdf, which is which is incorporated in its entirety for all purposes as if fully set forth herein. The W45-15 linear rail guide provides a guide width of 45 mm, supports a maximum load of 15 Kgs, and supports a pitch of 80 mm.

Alternatively or in addition, the linear actuator used may be based on, or may include, a linear hydraulic actuator (a.k.a. hydraulic cylinder), a pneumatic actuators, or pneumatic cylinders, or a linear pneumatic actuator (a.k.a. pneumatic cylinder). Alternatively or in addition, the linear actuator may be a piezoelectric actuator or may be a linear electrical motor, that uses an electrical motor that may be a DC brush, a DC brushless, a stepper, or an induction motor type. Alternatively or in addition, the linear actuator used may be based on, or may include, a telescoping linear actuator such as a helical band actuator, a rigid belt actuator, a rigid chain actuator, or a segmented spindle. Alternatively or in addition, the linear actuator used may be based on, or may include, a linear electric motor, that may be a Linear Induction Motor (LIM), a Linear Synchronous Motor (LSM), or a synchronous linear motor. Alternatively or in addition, the linear actuator used may be based on, or may include, a comb-drive capacitive actuator.

An image sensor 29 may consist of, or may comprise, a digital still or video camera for capturing images along of, or centered at, an optical axis, and the digital camera may comprise an optical lens for focusing received light, the lens being mechanically oriented to guide the captured images; a photosensitive image sensor array disposed approximately at an image focal point plane of the optical lens for capturing the image and producing an analog signal representing the image; and an Analog-to-Digital (A/D) converter coupled to the image sensor array for converting the analog signal to a digital data representation of the captured image. The image sensor array may respond to visible or non-visible light, such as infrared, ultraviolet, X-rays, or gamma rays. The image sensor array may use, or may be based on, semiconductor elements that use the photoelectric or photovoltaic effect, such as Charge-Coupled Devices (CCD) or Complementary Metal Oxide Semiconductor Devices (CMOS) elements.

Alternatively or in addition, the image sensor 29 may comprise, or may be based on, a MultiSpectral Scanner (MSS) that may collect data over a plurality of different wavelength ranges, and any capturing of the image herein may comprise along-track scanning, push-broom scanning, across-track scanning, whisk-broom scanning, or any combination thereof, by the scanner. Alternatively or in addition, any camera herein may consist of, may comprise, or may be based on, a Light Detection And Ranging (LIDAR) camera or scanner, Synthetic Aperture Radar (SAR), or a thermal camera that may be operative to capture in a visible light or in an invisible light that may be infrared, ultraviolet, X-rays, gamma rays, or any combination thereof. In one example, the image sensor 29 may consist of, may comprise, or may be based on, an IR camera such as the IR camera ImageIR 9100, available from InfraTec GmbH Headquartered in Dresden/GERMANY, described in a data sheet published October 2023 entitled: “ImageIR® 8100/9100—The New Generation SWIR Infrared Cameras”, which is incorporated in its entirety for all purposes as if fully set forth herein. The SWIR infrared cameras ImageIR®8100 and ImageIR® 9100 are radiometrically calibrated with (640×512) and (1,280×1,024) IR pixels in VGA and SXGA image format respectively. Both have a pixel pitch of only 5 μm which results in small detector chip diagonals. This allows a comparatively affordable, compact optical design with high imaging quality. In combination with radiometric calibration, brilliant thermographic images with high geometric and thermal resolution can thus be achieved in both formats. Combining the system with interchangeable lenses of different focal lengths allows convenient adaptation to real measurement scenarios. Here, even the smallest geometric and thermal details on large-area objects can be optimally resolved in the SXGA format.

In another example, the image sensor 29 may consist of, may comprise, or may be based on, a webcam camera, such as the C930E BUSINESS WEBCAM available from Logitech Americas of Newark, CA, U.S.A., described in a datasheet entitled: “DATASHEET-C930E BUSINESS WEBCAM” published October and downloaded December 2023 from https://www.logitech.com/c930e, which is incorporated in its entirety for all purposes as if fully set forth herein. The C930E webcam supports 1080 p (Full HD) @ 30 fps that enables expressions, non-verbal cues and movements to be seen clearly, provides a 90° diagonal field of view along with Full HD 1080p/30 fps resolution, autofocus and 4× zoom provide clear details for video meetings, and supports H.264 with Scalable Video Coding and UVC 1.5 encoding to free up PC bandwidth and provide a consistently reliable video-conferencing experience.

In another example, the image sensor 29 may consist of, may comprise, or may be based on, a High-Speed Machine Vision Camera, such as Cyclone 16-300 of the CamPerform-Cyclone series available from Optronis GmbH of Kehl, Germany, and described in a data sheet published 3.21 downloaded December 2023 from www.optronis.com, entitled “CamPerform-Cyclone series—Cyclone-16-300”, which is incorporated in its entirety for all purposes as if fully set forth herein. The Cyclone-16-300 is a high-resolution camera with low noise pixels for demanding machine vision applications, where reducing vertical resolution allows increased frame rate. The camera offers 4,672×3,416 pixel-resolution, a low noise pixel, a frame rate that increases with vertical window size reduction, an analogue gain adjustment, an analogue offset adjustment, and a hot pixel correction (customer activatable).

In another example, the image sensor 29 may consist of, may comprise, or may be based on, an UV camera such as the UV camera Alvium G5-812 UVm, available from Allied Vision Technologies GmbH of Stadtroda, Germany, described in a data sheet version 1.1.1 published Nov. 24, 2023 entitled: “Alvium G5—Speed up your vision application—5GigE Vision camera for demanding applications”, which is incorporated in its entirety for all purposes as if fully set forth herein. The Alvium G5-812 UV with Sony IMX487 runs 58.0 frames per second at 8.1 MP resolution. The Alvium G5 camera series combines the advantages of the 5GigE interface for higher bandwidth and the flexibility of the Alvium platform offering various mount and sensor options. It enables an easy upgrade of existing systems (USB3 Vision or GigE Vision) and offers backwards compatibility with 1000BASE-T solutions. Powered by ALVIUM® Technology, the sugar cube Alvium G5 camera delivers highest image quality at a low power consumption.

In another example, the image sensor 29 may consist of, may comprise, or may be based on, an LiDAR camera, such as the Intel® RealSense™ LiDAR Camera L515, available from Intel Corporation, described in a data sheet Revision 003 published January 2021 entitled: “Intel® RealSense™ LiDAR Camera L515”, which is incorporated in its entirety for all purposes as if fully set forth herein. The Intel® RealSense™ LiDAR Camera L515 is Intel's first release of a LiDAR camera enabling highly accurate depth sensing in a small form factor, that is small enough to fit in the palm of your hand, the L515 is 61 mm in diameter and 26 mm in height. At approximately 100 g, it's designed to be easily situated on any system, or attached to a tablet or phone. It also runs at less than 3.5 W, considerably lower than competing time-of-flight (TOF) solutions. All depth calculations run on the device resulting in true platform independence. With a short exposure time of <100 ns per depth point, even rapidly moving objects can be captured with minimal motion blur. Optimized for indoor lighting, the L515 processes over 23 million depth points per second via a custom-made ASIC. The product has been designed for use case flexibility with the inclusion of an RGB camera and an inertial measurement unit.

In another example, the image sensor 29 may consist of, may comprise, or may be based on, a stereo camera. In another example, the image sensor 29 may consist of, may comprise, or may be based on, a stereo camera such as Intel® RealSense™ Depth Camera D457, available from Intel Corporation, described in a data sheet Revision 003 published September 2023 [Document Number: 337029-011] entitled: “Intel® RealSense™—Product Family D457 Intel® RealSense™ Vision Processor D4 Board V5, Intel® RealSense™ Depth Camera D457”, which is incorporated in its entirety for all purposes as if fully set forth herein. Intel® RealSense™ Depth Camera D457 is an IP65-rated, GMSL 2/FAKRA camera comprised of the D450 optical module with a newly developed GMSL 2/FAKRA Vision Processor D4 board (V5). It supports the same specification including resolutions, FOV, FPS and configurations as the D455, but over GMSL 2/FAKRA instead of USB. The small size and ease of integration of the camera sub system provides system integrators flexibility to design into a wide range of products. The Intel® RealSense™ D400 series also offers complete depth cameras integrating vision processor, stereo depth module, RGB sensor with color image signal processing and Inertial Measurement Unit (IMU). The depth cameras are designed for easy setup and portability making them ideal for makers, educators, hardware prototypes and software development. The Intel® RealSense™ Camera D457 is supported with the cross-platform and open-source Intel® RealSense™ SDK 2.0. In addition, it requires kernel drivers supporting the GMSL MAXIM serializer. The Intel® RealSense™ Camera D457 is supported with the cross-platform and open-source Intel® RealSense™ SDK 2.0. In addition, there is a separate kernel driver package supporting the GMSL MAXIM serializer.

The resin stored in the resin container 25 may be cured by a light, that may be emitted by the light source 22, that may emit a laser beam. The light source 22 may be powered and controlled by the controller 24 (such as controlling the light intensity by a PWM intensity control.) by via a cable 15a. A light beam 33 that was generated by the light source 22 may be directed to various locations on the upper surface of the build platform 28 for curing and solidifying a resin thereon, by a light director 23. The light director 23 may be powered and controlled by the controller 24 by via a cable 15b. For example, the light source 22 may emit a UV laser beam. The light beam 33 may be emitted via a lens 23a for focusing the beam onto the resin liquid to be cured on the build platform 28, such as for creating a focal point as small as possible.

The image sensor 29, such as a camera, may be used to capture an image of the formed 3D object on the build platform 28, and may be used as a sensor for a closed-loop control of the printing process, such as to provide feedback to the controller 24 of the quality and progress of the forming of the 3D object, such as feedback regarding a focus of the light beam 33 or the height of the 3D object during the printing process. The camera 29 may be mechanically attached (directly or indirectly) to the vertical plate 21a using a horizontal rod, and may be powered and controlled by the controller 24 by via a cable 15c. In one example, the camera 29 may be mechanically mounted to capture the 3D object formed on the build platform 28, for example the optical axis of the camera 29 may be pointed at the opening 16.

The light director 23 may be based on, may include, or may consist of, a scan head for performing laser scanning of the build platform 28, and in particular on a 3D object that is formed on the build platform 28. The laser scanning may comprise controlled deflection of laser beams, visible or invisible, from the light source 22. The scan head may use moveable scanning mirrors to steer the laser beam, that may be in a form a rotating polygon mirror or may be freely addressable motion mirrors. The mirrors may be controlled to be in a desired angle or phase using an electric motor (for a polygon mirror) or a galvanometer. In order to position a laser beam in two dimensions, it is possible either to rotate one mirror along two axes or to rotate two mirrors along non parallel axes. Alternatively or in addition, a positioning the focus of the laser beam may be controlled (such as in a three dimensions controlled system), such as by using a servo-controlled lens system, usually called a ‘focus shifter’or ‘z-shifter’.

Alternatively or in addition, the scan-head may be based on scanning refractive optics and may comprise two Risley prisms that are rotated against each other, forming a beam of light that can be scanned at will inside a cone. Alternatively or in addition, the scan-head may be based on material effects and may include acousto-optic deflectors or electro-optic deflectors. Alternatively or in addition, the scan-head may be based on phased array scanning, and may include phased arrays for scanning of the laser beams. Such scan-head may be used with Vertical-Cavity Surface-Emitting Laser (VCSELs) for realizing fast laser scanners without moving parts.

The scan head in the light director 23 may be of any shape, such as a regular sphere, a truncated sphere, a cube, a rectangular prism, a cylinder, a triangular prism, a cone, a pyramid, a barrel, a truncated cone, a domed cylinder, a truncated cylinder, an ellipsoid, a regular polygon prism, a truncated three-dimensional polygon of e.g., 4-16 sides (such as a truncated pyramid (trapezoid) or any combination thereof). or it may be an irregular shape. Further, the scan head may comprise an upper face that contains and is configured to show one or more jewels and/or ornamental designs.

In one example, the scan head may be based on, may include, or may consist of, a ‘High Performance Laser Scanning Module (HPM10A/R) available from GMAX SYSTEMS (now General Scanning Optical Scanners) headquartered in Bedford, MA, United States, described in a data sheet entitled: “HPM10A/R—Hardware Manual—MULTI-AXIS BEAM HANDLING” [P/N 176-25014, Rev. C, GSI Lumonics1996], published 1996. The High-Performance Laser Scanning Module (HPM10A/R) is a multi-purpose-designed module. The module consists of 2 galvanometer scanners (X and Y), optics (flat field lens) and integrated driver electronics all enclosed in a black anodized aluminum case. The 2-mirror, 2-axis galvanometer Scan Heads provide the capability of deflecting optical beams in an XY manner for all possible laser applications. The synchronized actions of two galvanometer servo-controlled turning mirrors direct the laser beam to specific locations on a target material surface in both the X and Y directions.

The lens 23a comprises a transmissive optical device that focuses or disperses the light beam from the light director 23 by means of refraction, to form the focused light beam 33. In one example, the lens 23a comprises a wide-angle circular-shaped lens (fisheye lens) that produces strong visual distortion intended to create a wide panoramic or hemispherical image. The laser beam 33 may be steered, directed, or deflected in one or two dimensions by usually using a galvanometer or scan mirrors in the light director 23. The focused laser beam 33 may then be used to cure the resin fluid of the 3D object on the build platform 28. In one example, the lens 23a comprises, uses, or consists of, F-Theta lens. Such lens may provide an image height that is linearly proportional to the focal length and the scanning angle theta. Examples of F-Theta lenses are “F-THETA SCAN LENSES” available from Thorlabs, Inc. of Newton, NJ, U.S. A., described in https://www.thorlabs.com/newgrouppage9.cfm?objectgroup_id=6430 downloaded December 2023, which is incorporated in its entirety for all purposes as if fully set forth herein. The ‘F-THETA SCAN LENSES’ features include 1064 nm Design Wavelength for Nd:YAG Laser Systems; Large Scan Fields Ranging from 70 mm×70 mm to 156.7 mm×156.7 mm; and F-Theta Distortion of <0.1% or <1.3%. The Thorlabs'F-Theta Lenses consist of an air-spaced 2- or 3-element design and are available with one of three focal lengths: 100 mm, 160 mm, or 254 mm. The elements are coated with a high efficiency AR coating for a 1064 nm Nd:YAG laser and for a visible alignment laser. Each housing has a standard M85×1.0 or M39×1.0 thread for compatibility with most commercial laser marking systems.

In one example, the lens 23a may comprise a bandpass filter. An example of a bandpass filter may be FBH405-3 of “Hard-Coated UV/VIS Bandpass Filters” available from Thorlabs, Inc. of Newton, NJ, U.S.A., described in https://www.thorlabs.com/newgrouppage9.cfm?objectgroup_id=1860 downloaded December 2023, which is incorporated in its entirety for all purposes as if fully set forth herein. These hard-coated bandpass filters are designed to provide enhanced isolation of key Yb:YAG, Nd:YAG, HeNe, Ar, and diode laser lines, and offer excellent (ODavg≥4) suppression in the blocking region while providing ≥85% transmission at the design wavelength (except the 300 nm filter which offers ≥50% transmission). They are available with 12.5 mm or 25 mm outer diameters and are 3.5 mm thick, which allows the Ø25 mm filters to be used as drop-in replacements for our fluorescence emission filters. The passbands of these filters range from 1 to 40 nm FWHM, depending on the center wavelength chosen, with steep cut-on and cut-off slopes. The center wavelength and passbands for these filters are specified for light normally incident on the surface. For angles of incidence (AOIs) greater than 0°, the band will shift toward a lower center wavelength and the shape of the passband will change. Filters with passbands that have full width half maxima (FWHM) in the 1 to 5 nm range are particularly susceptible to these shifts.

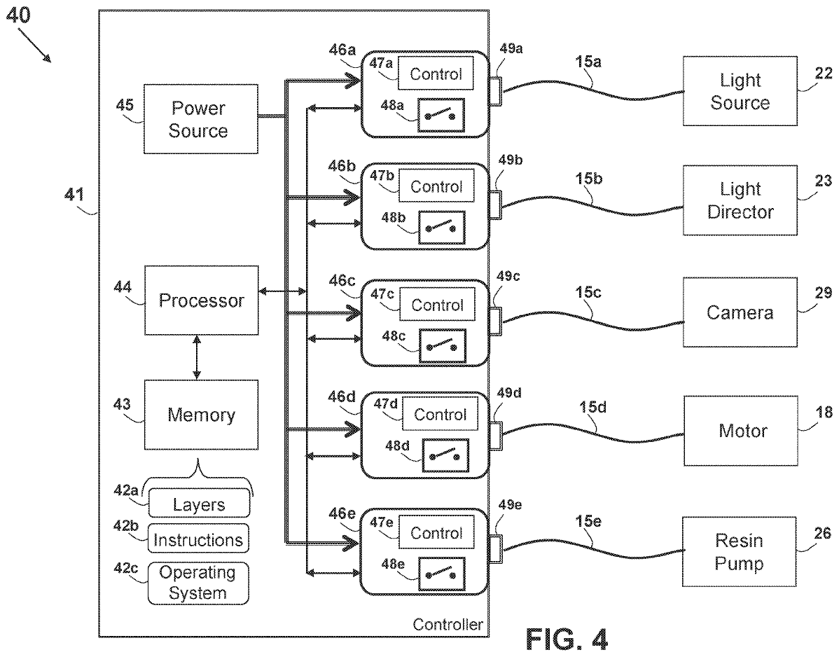

In one example, the lens 23a may comprise a UV (405 nm) F-Theta lens, that is designed such that the image height is proportional to the scan angle (Theta), not the tangent of that angle, such as a scan lens STY-F-840-405 available from Sintec Optronics Technology Pte. Ltd. of The Spire, Singapore, and described in a data sheet downloaded December 2023 from http://www.sintecoptronics.com/catalog/scanlens.pdf and entitled: “Scan Lenses (f-9 Lenses) for Nd:YAG Lasers”, which is incorporated in its entirety for all purposes as if fully set forth herein. A schematic block diagram 40 of the power and control of the 3D printer 20 is shown in FIG. 4. A schematic block diagram 41 may refer to the controller 24 of the 3D printer 20 shown in FIG. 2. The controller 41 connects to the light source 22 by the cable 15a via a connector 49a, to the light director 23 by the cable 15b via a connector 49b, to the camera 29 by the cable 15c via a connector 49c, to the motor 18 by the cable 15d via a connector 49d, and to the resin pump 26 by the cable 15e via a connector 49e. The electrical power to the 3D printer 20 is supplied by the power source 45, that may be separated from, part of, or integrated with, the controller 41. The controller 41 may include specific interfaces 46a-46e for providing power and for controlling the 3D printer 20 components.

In one example, a processor 44 executes instructions 42b and an operating system 42c that are stored in a memory 43. The memory 43 may further store the information regarding the layers 42a to be printed to form the required 3D object. Under the processor 44 control, the electric power may be switched from the power source 45 to the light source 22 using a controlled switch 48a that may be part of a light source interface 46a, the electric power may be switched from the power source 45 to the light director 23 using a controlled switch 48b that may be part of a light director interface 46b, the electric power may be switched from the power source 45 to the camera 29 using a controlled switch 48c that may be part of a camera interface 46c, the electric power may be switched from the power source 45 to the motor 18 using a controlled switch 48d that may be part of a motor interface 46d, and the electric power may be switched from the power source 45 to the resin pump 26 using a controlled switch 48e that may be part of a pump interface 46e.

Each of the interfaces may comprise a control functionality, such as the applicable hardware or software to control the 3D printer 20 components. The control functionality 47a may be part of the interface 46a for controlling the light source 22, the control functionality 47b may be part of the interface 46b for controlling the light director 23, the control functionality 47c may be part of the interface 46c for controlling the camera 29, the control functionality 47d may be part of the interface 46d for controlling the motor 18, and the control functionality 47e may be part of the interface 46e for controlling the resin pump 26.

The control circuitry or functionality 47c that is part of the camera interface 46c, as well as any interface to any sensor herein, may include a signal conditioner coupled to the sensor output for conditioning or manipulating of the sensor output signal, and the signal conditioner may comprise a linear or non-linear conditioning or manipulating. The signal conditioner may comprise an operation or an instrument amplifier, a multiplexer, a frequency converter, a frequency-to-voltage converter, a voltage-to-frequency converter, a current-to-voltage converter, a current loop converter, a charge converter, an attenuator, a sample-and-hold circuit, a peak-detector, a voltage or current limiter, a delay line or circuit, a level translator, a galvanic isolator, an impedance transformer, a linearization circuit, a calibrator, a passive or active (or adaptive) filter, an integrator, a deviator, an equalizer, a spectrum analyzer, a compressor or a de-compressor, a coder (or decoder), a modulator (or demodulator), a pattern recognizer, a smoother, a noise remover, an average or RMS circuit, an analog to digital (A/D) converter, or any combination thereof.

Any one of, or all of, the control circuitry or functionality 47a of the light source 22 that is part of the light source interface 46a, the control circuitry or functionality 47b of the light director 23 that is part of the light director interface 46b, the control circuitry or functionality 47d of the motor 18 that is part of the light director interface 46d, the control circuitry or functionality 47e of the pump 26 that is part of the pump interface 46e, as well any other actuator interface, may use, or may be based on, a signal conditioning in order to adapt the actuator operation, or in order to improve the handling of the actuator input or adapting it to the former stage or manipulating, such as attenuation, delay, current or voltage limiting, level translation, galvanic isolation, impedance transformation, linearization, calibration, filtering, amplifying, digitizing, integration, derivation, and any other signal manipulation. Further, in the case of conditioning, the conditioning circuit may involve time related manipulation, such as filter or equalizer for frequency related manipulation such as filtering, spectrum analysis or noise removal, smoothing or de-blurring, a compressor (or de-compressor) or coder (or decoder) in the case of a compression or a coding/decoding schemes, modulator or demodulator in case of modulation, and extractor for extracting or detecting a feature or parameter such as pattern recognition or correlation analysis. In case of filtering, passive, active or adaptive (such as Wiener or Kalman) filters may be used. The conditioning circuits may apply linear or non-linear manipulations. Further, the manipulation may be time-related such as using analog or digital delay-lines or integrators, or any rate-based manipulation.

The switch 48a that is part of the interface 46a, the switch 48b that is part of the interface 46b, the switch 48c that is part of the interface 46c, the switch 48d that is part of the interface 46d, the switch 48e that is part of the interface 46e, or any other switch herein, may be based on, may be part of, or may consist of, an analog switch, a digital switch, or a relay, and the relay may be a solenoid-based electromagnetic relay, a reed relay, a Solid-State Relay (SSR), or a semiconductor-based relay. Alternatively or in addition, the switch may be based on, may comprise, or may consist of, an electrical circuit that comprises an open collector transistor, an open drain transistor, a thyristor, a TRIAC, or an opto-isolator. Any switch herein may be based on, may comprise, or may consist of, an electrical circuit or a transistor, the transistor may be a field-effect transistor, the respective switch may be formed between a ‘drain’ and a ‘source’ pins, and the control port may be a ‘gate’ pin. The field-effect power transistor may be an N-channel or a P-channel field-effect transistor.

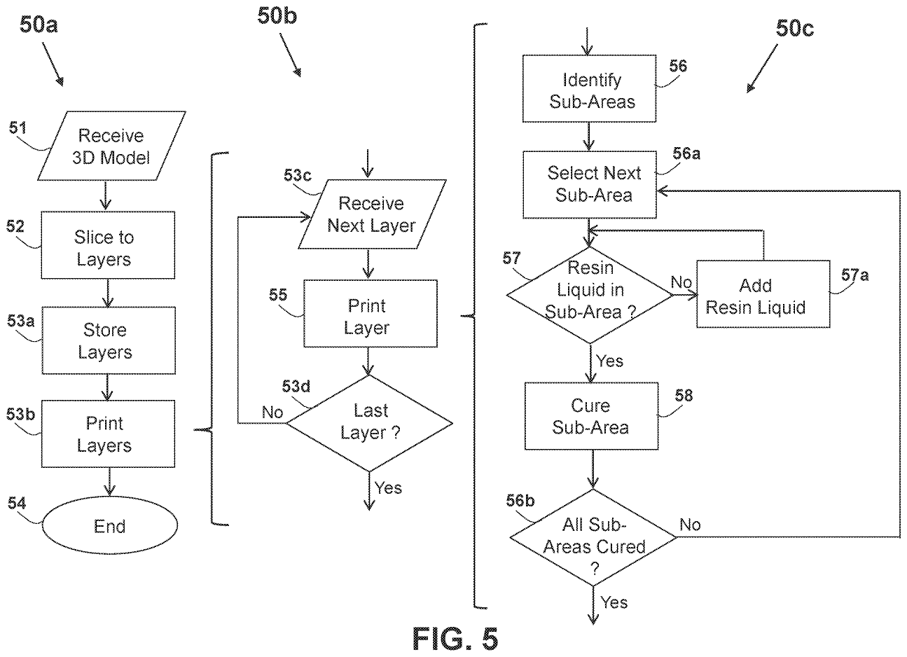

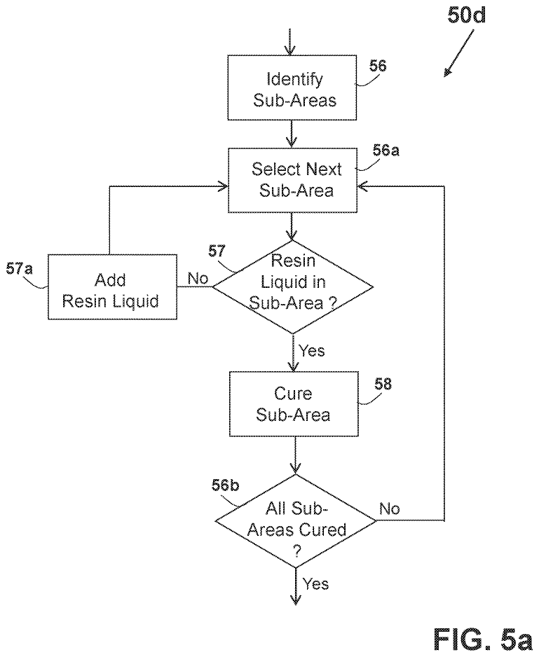

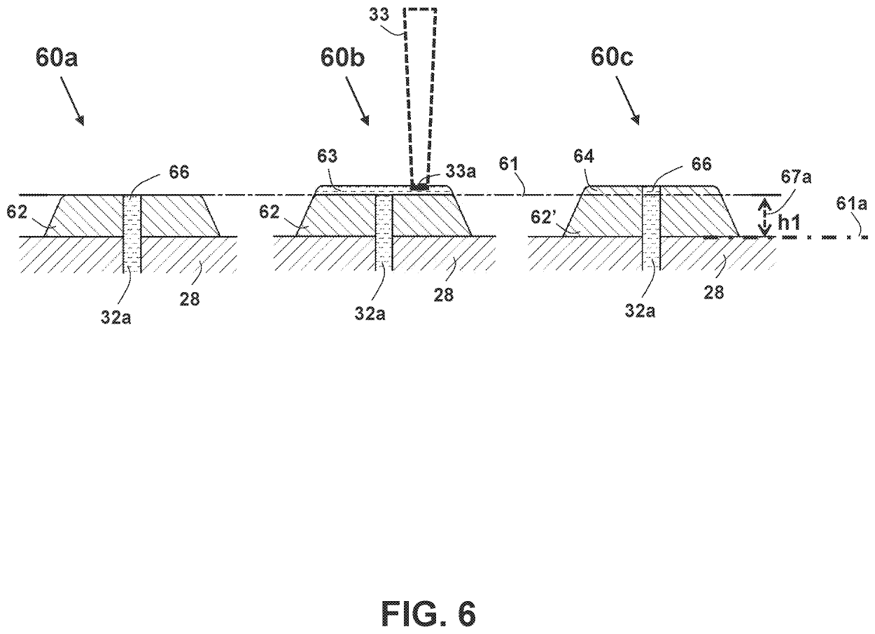

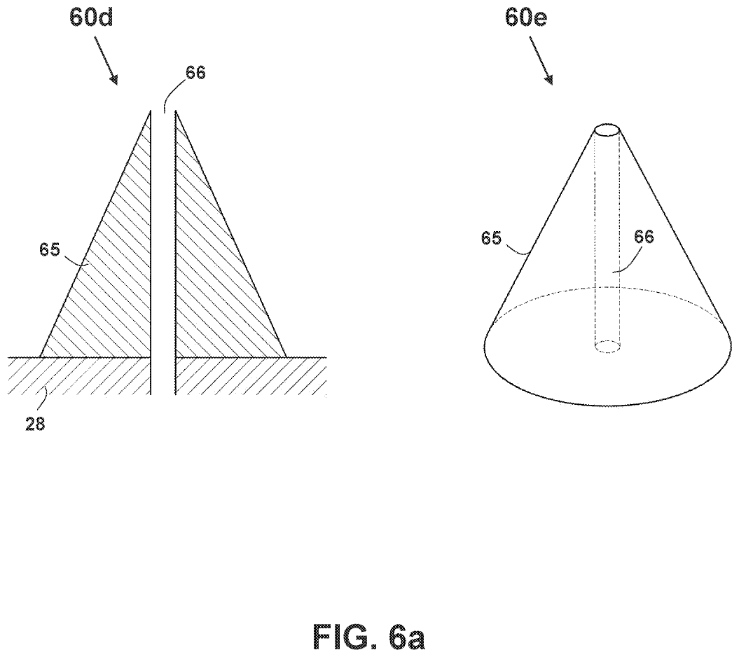

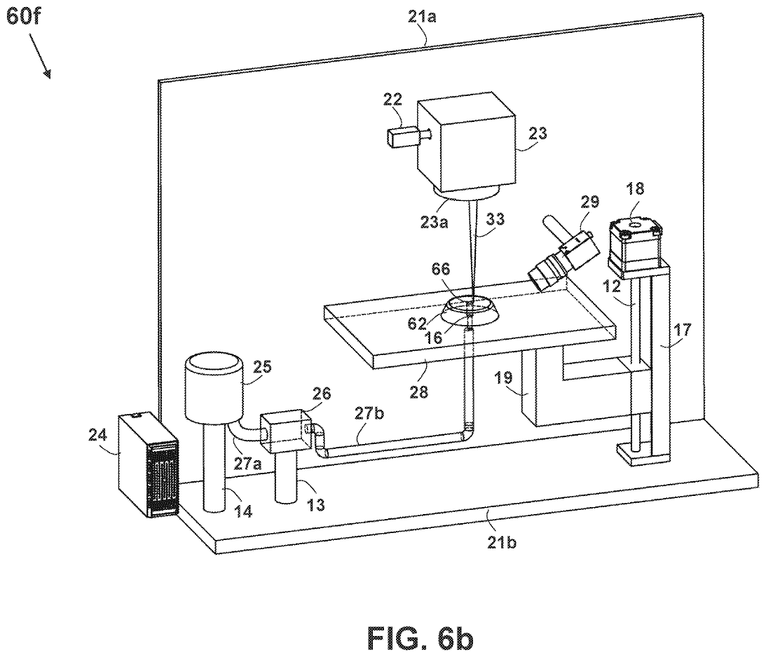

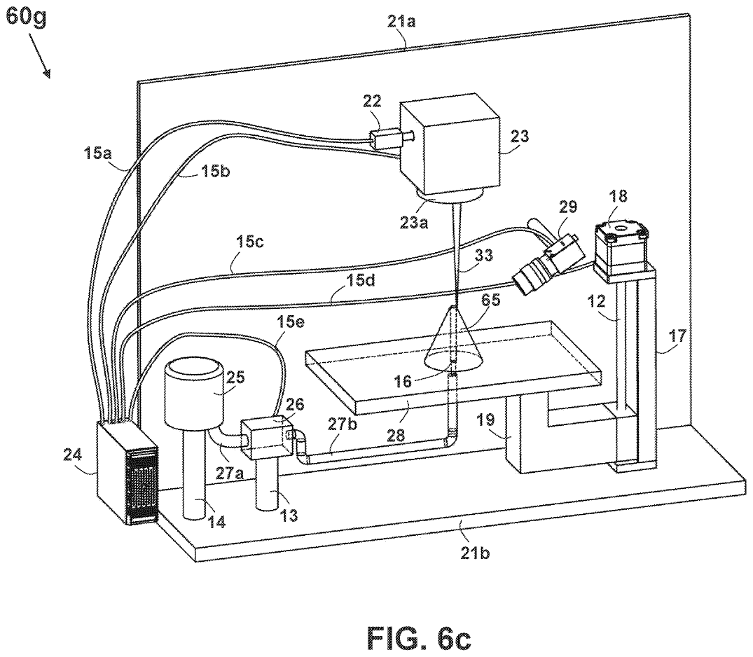

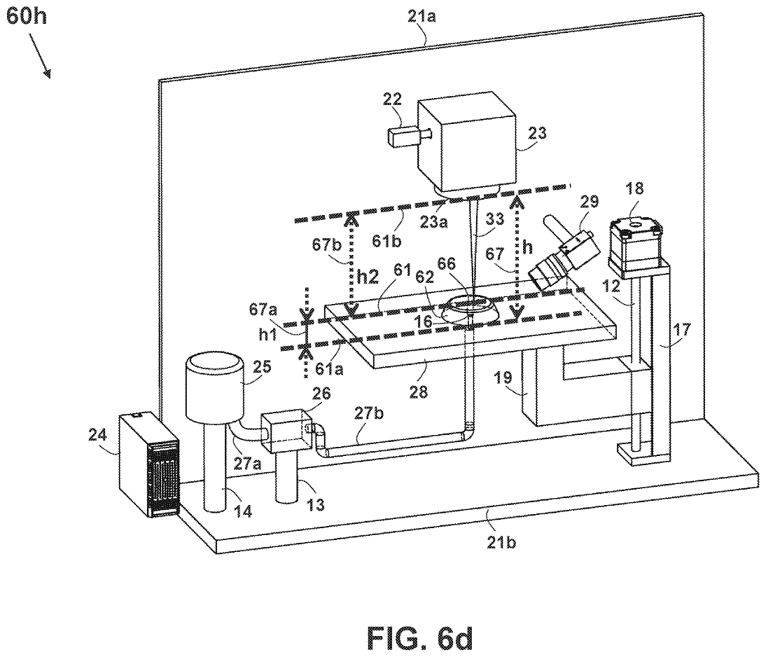

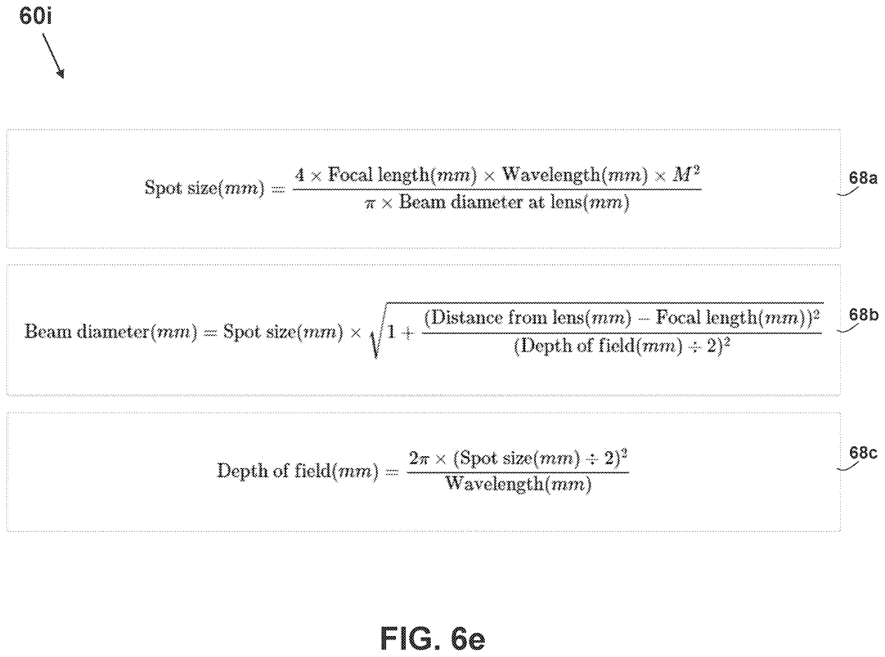

Examples of flow charts 50a, 50b, 50c, and 50d illustrating the process for fabricating of a 3D object using the 3D printer 20 are shown in FIGS. 5 and 5a. An example of a process for 3D printing of a cone 65 is demonstrated is shown in pictorial views 60a-60e shown in FIGS. 6 and 6a. An example of a high-level flow-chart 50a for 3D printing using the 3D printer 20 is shown in FIG. 5. As part of a “Receive 3D Model” step 51, a 3D model or image is identified or obtained. The 3D model may be in a surface model format, which includes a mathematical or digital representation of the 3D object as a set of planar or curved surfaces, or both, that can, but does not necessarily have to, represent a closed volume. In one example, the 3D image file may be obtained from, or prepared by, a Computer-Aided Design (CAD) system. Such 3D image may be in an STL, AMF, G-code, STEP, or IGES format, which is a file format native to the stereolithography CAD software created by 3D Systems. As part of a “Slice to Layers” step 52, a slicer is applied for converting of a 3D object model to specific instructions for the printer, such as forming Two-Dimensional (2D) layers. For example, it may convert a model in STL, AMF, STEP, G-code, or IGES format to printer commands in G-code format. Each layer comprises a matter material laid out, or spread, to create a surface, where the multiple layers form the 3D object to be fabricated. Alternatively or in addition, the layer information file may be in G-code (also RS-274), which is widely used Computer Numerical Control (CNC) and 3D printing programming language, and is mainly used in computer-aided manufacturing to control automated machine tools, as well as for 3D-printer slicer applications.

As part of a “Store Layers” step 53a, the layers 42a that form the required 3D object, such as the cone 65, are stored in the memory 43 of the controller 41. In the case of the cone 65, the layers are basically discs, which are filled circles of changing diameters. As part of a “Print Layers” step 53b, the layers are sequentially printed by the 3D printer 20, to form the 3D object, until the 3D object is completed by all layers printed, ending the process at a “End” step 54.

The 3D printing is performed sequentially each layer at a time, typically from bottom to top, as shown in a flow chart 50b in FIG. 5, which may be executed as part of the “Print Layers” step 53b. Each layer is identified or obtained at a time, as part of a “Receive Next Layer” step 53c. The obtained or identified layer is printed according to the layer image, shape, plan, or instruction, as part of a “Print layer” step 55. After finalizing the current layer printing as part of the Print layer” step 55, the availability of a next layer is checked as part of a “Last Layer?” step 53d. In the case where the printing is completed and no other layers are required to be printed, the process ends as part of the “End” step 54. In the case where the printing is not completed and more layers are to be printed, the next layer is received, obtained, or identified, as part of the “Receive Next Layer” step 53c.

The actions as part of each layer printing may be part of the “Print layer” step 55 are shown as a flow chart 50c shown in FIG. 5, and may be part of the instructions 42b that are stored in a memory 43, and that are executed by the processor 44. The map or arrangement of a layer to be added to the in-process 3D object is segmented to multiple smaller segments, referred to herein as ‘sub-areas’, as part of an “Identify Sub-Areas” step 56. Typically, the identified sub-areas as part of the “Identify Sub-Areas” step 56 may be part of a 2D map, identified as horizontal coordinates (such as (X, Y)) in a bitmap that represents the layer to be printed as part of the “Print Layer” step 55. For example, the sub-areas may be polygons. Alternatively or in addition, the identified sub-areas as part of the “Identify Sub-Areas” step 56 may be part of a 3D map, such as voxels, where each voxel represents a value on a regular grid in three-dimensional space to be printed. For example, the identified sub-areas as part of the “Identify Sub-Areas” step 56 may be arranged as a queue that defines the order or curing the sub-areas.

The partitioning to sub-areas as part of the “Identify Sub-Areas” step 56 may be overlapping (where a point is part of two or more sub-areas), or non-overlapping, where each of the points is part of a single sub-area. In one example, at least part of, or all of, the sub-areas are identical. In one example, the sub-areas are shaped as non-overlapping identical squares (referred herein as ‘tiles’). The area of one, each one of part of, each one of most of, or each one of all of, the sub-areas may be at least 0.001, 0.002, 0.005, 0.007, 0.01, 0.02, 0.05, 0.07, 0.1, 0.2, 0.5, 0.7, 1.0, 1.2, 1.5, 2.0, or 5.0 millimeter-square (mm²). Alternatively or in addition, the area of one, each one of part of, each one of most of, or each one of all of, the sub-areas may be less than 0.002, 0.005, 0.007, 0.01, 0.02, 0.05, 0.07, 0.1, 0.2, 0.5, 0.7, 1.0, 1.2, 1.5, 2.0, 5.0, or 10.0 millimeter-square (mm²).

In one example, adding a layer as part of the “Print Layer” step 55 involves printing one sub-area at a time, until the whole layer to be printed is added. As part of a “Select Next Sub-Area” step 56a, one of the non-cured sub-areas that was identified as part of the “Identify Sub-Areas” step 56 is selected for curing. In one example, the sub-areas at the edges of a contour of the layer map are first selected (or are highly prioritized for selecting), in order to form a solid frame that may hold or control the resin liquid, and may further provide better control and accuracy. Such prioritized sub-areas may be cured (or the light beam 33 may be directed to these sub areas) even if resin does not yet exist in sub area, in anticipation that the resin liquid will shortly reach these areas, in order to maintain the edges and provide faster edges curing time.

In another example, sub-areas that represent a local minimum height of the layer are first selected. Alternatively or in addition, the sub-area is randomly selected. Such selection of a next sub-area to cure, may be based on, or may use, random selection, that may use, or may be based on, one or more random numbers generated by a random number generator. The random number generator herein may be hardware based, and may be using thermal noise, shot noise, nuclear decaying radiation, photoelectric effect, or quantum phenomena. Alternatively or in addition, the random number generator herein may be software based, and may be based on executing an algorithm for generating pseudo-random numbers.

As part of a “Resin Liquid in Sub-Area?” step 57, the controller 24 may determine whether the sub-area that was selected as part of the “Select Next Sub-Area” step 56a is covered by resin liquid that may be cured as part of the forming of the added layer. In one example, a checking of the existence of resin liquid in the selected sub-area may be by analyzing, using an image processing, an image captured by the camera 29.

In a case where there is no resin liquid in the selected sub-area, the resin pump 26 may be controlled, such as by the processor 44 using the control mechanism 47e or the switch 48e, that are part of the pump interface 46e of the controller 41 shown in FIG. 4, to apply more resin liquid, as part of an “Add Resin Liquid” step 57a. The adding of resin liquid part of the “Add Resin Liquid” step 57a is repeated until it is determined, at the “Resin Liquid in Sub-Area?” step 57, that enough resin liquid is available at the selected sub-area.

In a case where it is determined as part of the “Resin Liquid in Sub-Area?” step 57 that there is enough resin liquid in the selected sub-area, the selected sub-area is cured, such as by directing the light beam 33 thereto, as part of a “Cure Sub-Area” step 58. For example, the light beam (such as a laser beam) may be formed by activating the switch 48a that is part of the light source 22 interface 46a. The formed light beam 33 may then be directed to the selected sub-area by using the light director 23 using the control circuitry 47b that is part of the interface 46b in the controller 41 shown in FIG. 4.

As part of a “Add Resin Liquid” step 57a, a quantified amount of resin fluid is selectively dispensed or pressed by the pump 26, under control of the controller 41 via the pump interface 46e and the cable 15e, from the resin container 25 to the opening 16 via the flexible tube or pipe 27b, or via a nozzle or orifice therein. The pressed resin fluid passes via the opening 16 and the in-process 3D object, and spread outside the 3D object (and/or on the upper surface of the build platform 28). As part of a “Cure Sub-Area” step 58, the light beam 33, generated by the light source 22 (under control of the controller 41 via the light source interface 46a and the cable 15a) and directed by the light director 23 (under control of the controller 41 via the light director interface 46b and the cable 15b), reaches the resin spread area according to the shape, instruction, image, or plan, of the layer to be printed, and cure or solidify the resin therein, forming the required additional layer.

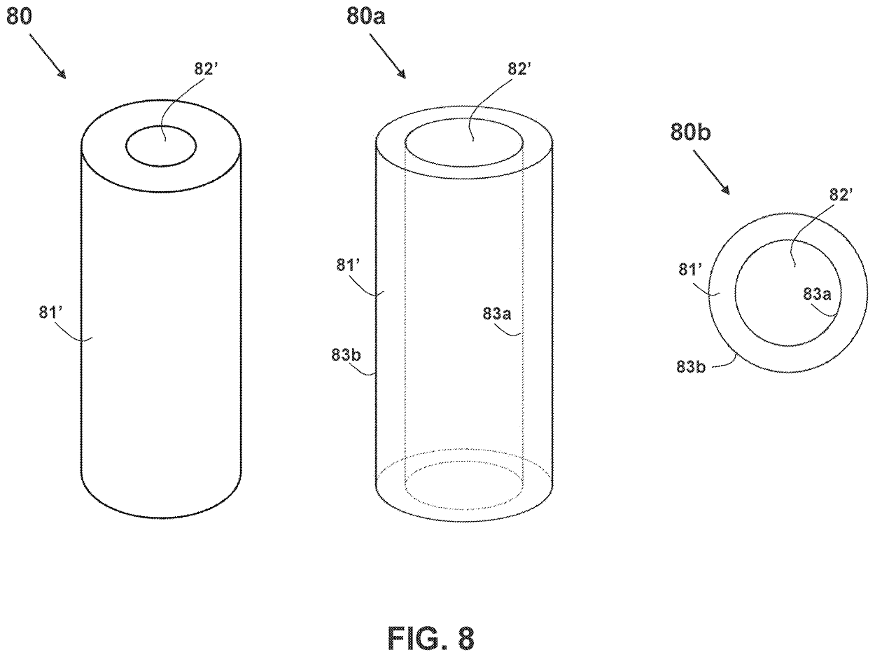

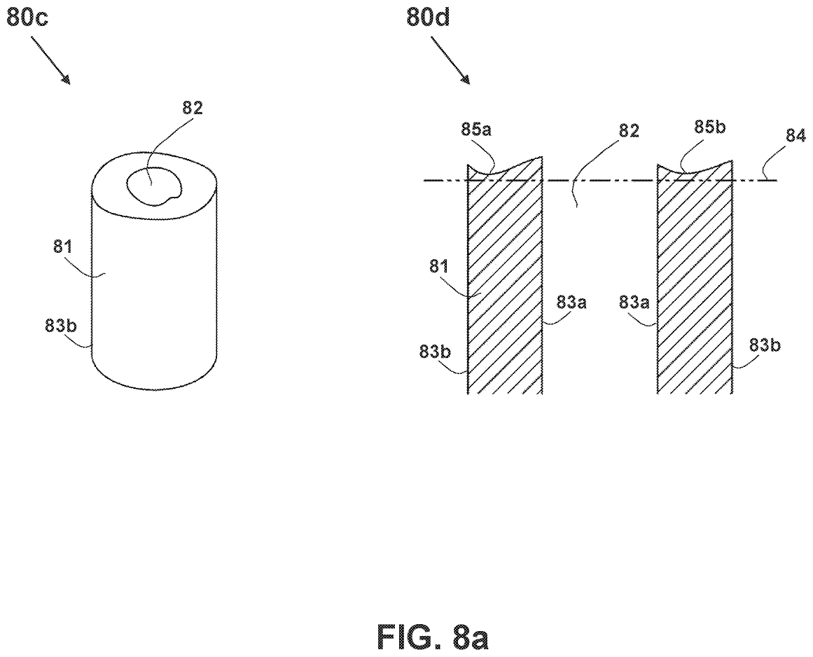

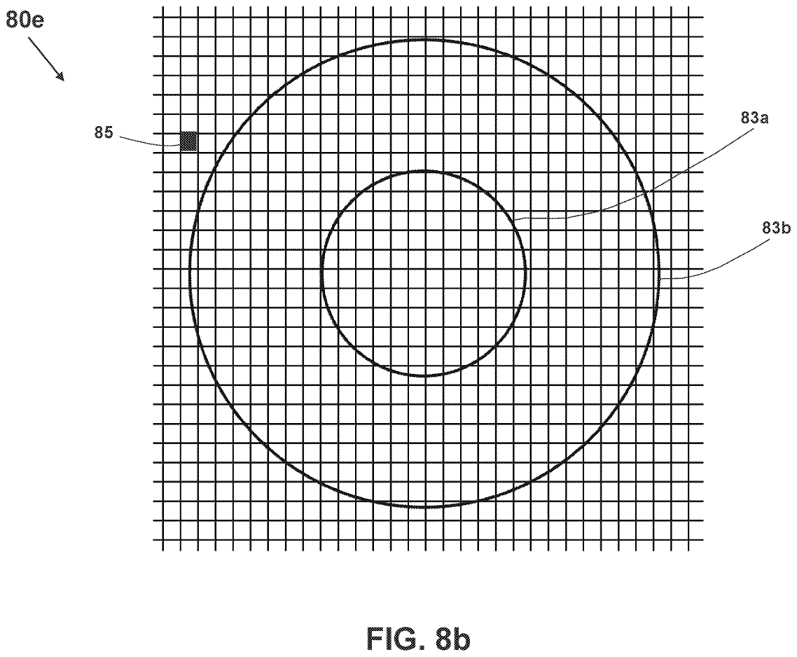

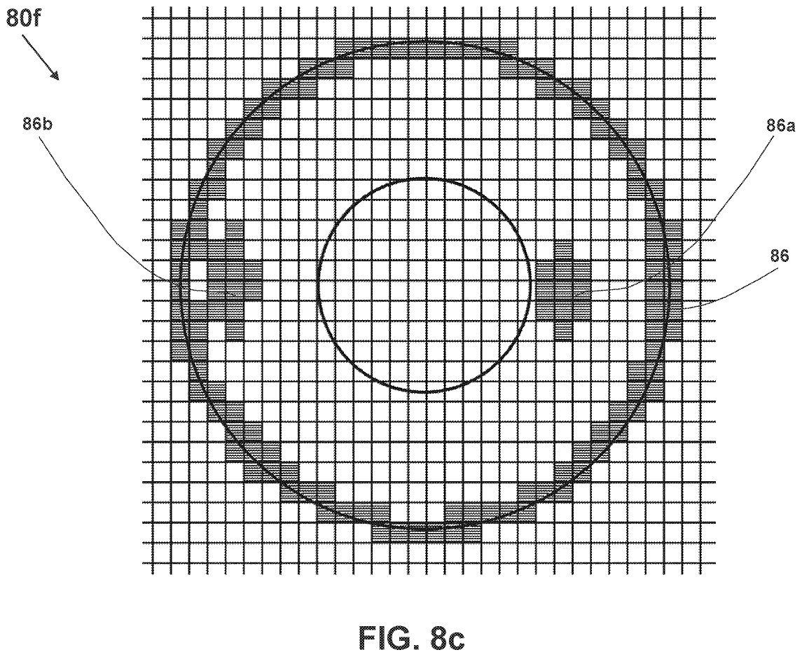

In one example, a complete cylinder 81′ is to be printed by the 3D printer 20, as shown in a view 80 in FIG. 8. The external view 80 depicts the cylinder 81′ that defines an interval cavity 82′. As shown in an isometric view 80a, the cylinder 81′ defines an external surface 83b, and an internal surface 83a, which encircle the cavity 82′. A vertical cross-section cut view 80b is further shown in FIG. 8. In one example, as the cylinder 81′ is built vertically from bottom to top, and a view 80c depicts an in-process cylinder 81 having a cavity 82 in FIG. 8a. A vertical cross-section 80d is shown in FIG. 8a, defining a projection plane 84, and further depicts non-flat horizontal surface that depicts the local minimum 85a and 85b.

In one example, as part of the “Identify Sub-Areas” step 56, the layer to be added is partitioned to a grid that comprises multiple identical non-overlapping square-shaped area parts ('tiles') of a horizontal layer, as shown in a view 80e depicted in FIG. 8b, indicating a blackened tile 85 as an example. In one example, various tiles are selected first, or given higher priority, as part of the “Select Next Sub-Area” step 56a, as shown in a view 80f in FIG. 8c. In one example, tiles 86 that defines the exterior contour 83b of the cylinder 81 may first be selected as part of the “Select Next Sub-Area” step 56a and cured, one at a time, as part of the “Cure Sub-Area” step 58. In another example, tiles 86a or 86b that defines local minimum 85a or 85b shown in the view 80d in FIG. 8a, may first be selected as part of the “Select Next Sub-Area” step 56a and cured, one at a time, as part of the “Cure Sub-Area” step 58.

In one example, the selecting of a sub-area to cure may be based on an availability of resin liquid thereon. The actions as part of each layer printing may be part of the “Print layer” step 55 are shown as a flow chart 50d shown in FIG. 5a, and may be part of the instructions 42b that are stored in a memory 43, and that are executed by the processor 44. The map or arrangement of a layer to be added to the in-process 3D object is segmented to multiple smaller segments, referred to herein as ‘sub-areas’, as part of the “Identify Sub-Areas” step 56. Typically, the identified sub-areas as part of the “Identify Sub-Areas” step 56 may be part of a 2D map, identified as horizontal coordinates (such as (X, Y)) in a bitmap that represents the layer to be printed as part of the “Print Layer” step 55. A next sub-area to be cured is identified as part of the “Select Next Sub-Area” step 56a, followed by the “Resin Liquid in Sub-Area?” step 57, checking that there is enough resin liquid in the selected sub-area. In a case where the resin fluid has not yet arrived to the selected sub-area, resin liquid is added as part of the “Add Resin Liquid” step 57a, followed by selecting another sub-area as part of the “Select Next Sub-Area” step 56a, in order not to wait for the resin liquid to spread and arrive to the former selected sub-area. Assuming continuous streaming and spreading of the resin liquid, the former selected sub-area will be covered later, and then may be selected for curing. In case where the selected sub-area is covered with the resin liquid, then the curing as part of the “Cure Sub-Area” step 58 follows.

In one example, the order or sequence of the selecting of the sub-areas that are identified as part of the “Identify Sub-Areas” step 56, as part of the “Select Next Sub-Area” step 56a, is based on an optimizing of a pre-determined criterion. For example, the sub-areas may be selected in order to reduce the latency of moving from one selected sub-area to the next selected one, for minimizing the duration of the printing. For example, the “Select Next Sub-Area” step 56a may use, or may be based on, a Travelling Salesman Problem (TSP). The TSP problem is applied herein by replacing the traditional cities with the relevant locations of the sub-areas, and the cost is a distance between, or a time duration for moving from, one sub-area to another. The TSP used may be asymmetric or non-asymmetric, and may be solved using an exact algorithm or a heuristic one.

The curing as part of the “Cure Sub-Area” step 58 is a chemical process employed in polymer chemistry and process engineering that produces the toughening or hardening of a polymer material by cross-linking of polymer chains. During the curing process, single monomers and oligomers, mixed with or without a curing agent, react to form a tridimensional polymeric network. In the very first part of the reaction branches of molecules with various architectures are formed, and their molecular weight increases in time with the extent of the reaction until the network size is equal to the size of the system. The system has lost its solubility and its viscosity tends to infinite. The remaining molecules start to coexist with the macroscopic network until they react with the network creating other crosslinks. The crosslink density increases until the system reaches the end of the chemical reaction.

In one example, the intensity of the light emitted by the light source 22 (that may be a laser beam source), is controlled by using Pulse Wide Modulation (PWM). Is such scenario, controlling of the average power or amplitude of the light source intensity uses a switching of the electric power supply, such as by the switch 48a that is part of the light source 22 interface 46a, between 0 and 100% at a rate faster than it takes the load to change significantly. The proportion of ‘on’ time to the regular interval or ‘period’ of time, known as a ‘duty cycle’, corresponds to average power obtained. A full intensity (100%) refers to continuous supplying the full (100%) electric power. A duty cycle of 50% resembles a “square” wave where the power is provided half of the time and is ‘off’ on the other half of the time. In one example, the duty cycle of providing power to the light source 22 using PWM may be more than 5%, 10%, 15%, 20%, 30%, 40%, 50%, 60%, 70%, 80%, or 90%. Alternatively or in addition, the duty cycle of providing power to the light source 22 using PWM may be less than 10%, 15%, 20%, 30%, 40%, 50%, 60%, 70%, 80%, 90%, or 95%.

In a case where the sub-area that was selected as part of the “Select Next Sub-Area” step 56a is the last sub-area to be cured out of the sub-areas identified as part of the “Identify Sub-Areas” step 56, indicating that all sub-layers have been cured as part of the “Cure Sub-Area” step 58, the whole layer to be printed as part of the “Print Layer” step 55 has been printed, as may be determined by a “All Sub-Areas Cured?” step 56b. In such a case, the next layer (if any) may be received, obtained, selected, or identified, for additional printing as part of the “Receive Next Layer” step 53c. Otherwise, printing of the currently involved layer continues by selecting another sub-area to cure, as part of the “Select Next Sub-Area” step 56a.

A view 60a in FIG. 6 shows a vertical cut of an intermediate producing of a cone-shaped 3D object. The cone 62 is shown to be formed by applying an additional layer 63 to the in-process cone 62, added over the last cured layer having a vertical position level 61, so that to the in-process cone 62 forms a height value ‘h1’ 67a from the top flat layer 61a of the build platform 28. The in-process cone 62 includes a cylindrical cavity 66, located over the build platform 28 top opening 16, so that the vertical cavity 32a, shown filled with the resin liquid, may flow from the bottom of the build platform 28 through the partial cone shape 62. As part of the “Add Resin Liquid” step 57a, the pump 26, under control of the controller 41 via the pump interface 46e and the cable 15e, pushes an amount of resin 63 (via the cavity 66) that is spread or laid out due to gravity over the partial formed cone 62, forming a 2D layer resin fluid layer 63 as shown in a view 60b in FIG. 6. As part of the “Cure Sub-Area” step 58, the spread resin fluid 63 is cured and solidified by the light beam 33 (shown as a vertical cut in the beam), that forms a light spot 33a, that by curing adds a layer 64 to the formed partial cone 62′, as shown in a view 60c in FIG. 6. The curing as part of the “Cure Sub-Area” step 58 avoid curing the cavity 66, allowing for resin fluid to be passed through, allowing for similarly forming of the next layer. A fully formed cone is shown in a view 60e and a vertical cut view 60d, are shown in FIG. 6a. The completed cone 65 is formed on the build platform 28, and may include the cavity 66. A partially formed cone-shaped 3D object 62 being fabricated on the build platform 28 is shown in a view 60f in FIG. 6b, and a fully-formed cone-shaped 3D object 65 being fabricated on the build platform 28 is shown in a view 60g in FIG. 6c.

A view 60h in FIG. 6d is based on a view 60f in FIG. 6b that shows a partially formed cone-shaped 3D object 62 being fabricated on the build platform 28, with added vertical lines showing various vertical levels. The dashed line 61a represents the vertical level of the top surface of the build platform 28, and the dashed line 61 represents the vertical level of the top of the in-process 3D object, such as the half-cone 62, shown to be distant by a height difference ‘h1’ 67a. A dashed line 61b represents the vertical level of the lens 23a, from which the light beam 33 is emitted. The distance gap from the lens 23a output at the level 61b to the top layer level 61 of the 3D object 62 is shown as ‘h2’ 67b. The total vertical distance between the light beam 33 source level 61b to the dashed line 61a that represents the vertical level of the top surface of the build platform 28 is calculated as the sum of the height values ‘h1’ 67a and ‘h2’ 67b. For the sake of clarity, the cables or connections 15a-15e are not shown in FIGS. 6b and 6d. In one example, an efficient resin usage is obtained, since the resin fluid is directly applied to the location required for curing, such as flowing inside the partly printed object, requiring only an amount of resin roughly equal to the actual printed object. As such, large 3D objects may be printed using only resin fluid amount actually required for making the 3D object (such as limited to the actual volume of the 3D object), obviating the need for large enclosed resin volume container that serves as build chamber in which the objects or parts are fabricated or made. Further, the separation of the 3D actual printing location and the resin container allows for printing on any surface, such as metal and plastic surfaces, without any pre-treatment such as heating.

In traditional bottom-up resin-based printing, a separation is required of the printed layer from the resin-fluid container, which may be time-consuming and energetically inefficient. The 3D printer 20 may use a mechanism of curing resin at the top of the formed 3D object, thus eliminating the need for such a separation and providing faster printing. Further, while traditional top-down resin printing may suffer from inefficient resin flow, the 3D printer 20 is based on directing resin accurately to the printed 3D object, as it flows through it. While common FDM printing is limited by the speed and acceleration of the printer head, the optical-based 3D printer 20 is both time and energetically efficient. Further, since the printing area in the 3D printer 20 is separated from the resin container 25, the 3D object to be printed is not restricted or confined by any container size, or by any gantry size such as FDM-based printing. Further, the system may be smaller than the 3D object that is to be printed. In addition, while traditional SLA printing typically requires the use of a large resin liquid vat in which the printed object is submerged, the size of the 3D object to be printed may not restrict or confine the structure or dimensions of the 3D printer 20, as such vat is not required. Furthermore, the 3D printer 20 may provide faster, more accurate, more flexible, easier to program or operate, portable, scalable, non-dimension limited 3D object size, or resin-economic, additive manufacturing method or apparatus. In one example, the 3D printer 20 may be used for quickly fabricating a scale model of a physical part or assembly, such as for rapid prototyping, where 3-dimensional prototypes of a product or feature may be created and tested to optimize characteristics like shape, size, and overall usability. Further, using the 3D printer 20 may reduce material waste and production costs by eliminating the need for multiple manufacturing processes and assembly, and streamlining the production line for efficiency and sustainability.

In the 3D printer 20, the obtained resolution, such as a dimensional accuracy of or surface finish of the printed 3D object are at least in part affected by the size of the light spot (such as the laser light spot 33a) that cure the resin liquid, such as the size and shape of the light beam 33 at the surface height 61 when reaching the added layer 63 to cure it, to form the cured layer 64. A smaller optical spot size (also known as horizontal resolution), a better resolution may be achieved.

The spot 33a size is affected by absorption, diffusion, dispersion, and refraction, associated with the optical structure and components that generate the light beam 33, such as the light source 22, the light director 23, and the lens 23a, as shown in the view 60h in FIG. 6d. In one example, the spot size may be controlled by the optical gap ‘h2’ 67b between the lens 23a and the surface level 61 of the added resin liquid (or fluid) to be cured. Such distance ‘h2’ 67b may be controlled by vertically moving the build platform 28 by the linear actuator 17 that is moved by the electrical motor 18. Preferably, the height ‘h2’ 67b is controlled, such as by the linear actuator 17, to be at the focus of the lens 23a, where the light beam 33 originating from the lens 23a converges on the level 61, such as where the height ‘h2’ 67b is equal, or close to, the focal length of the lens 23a.

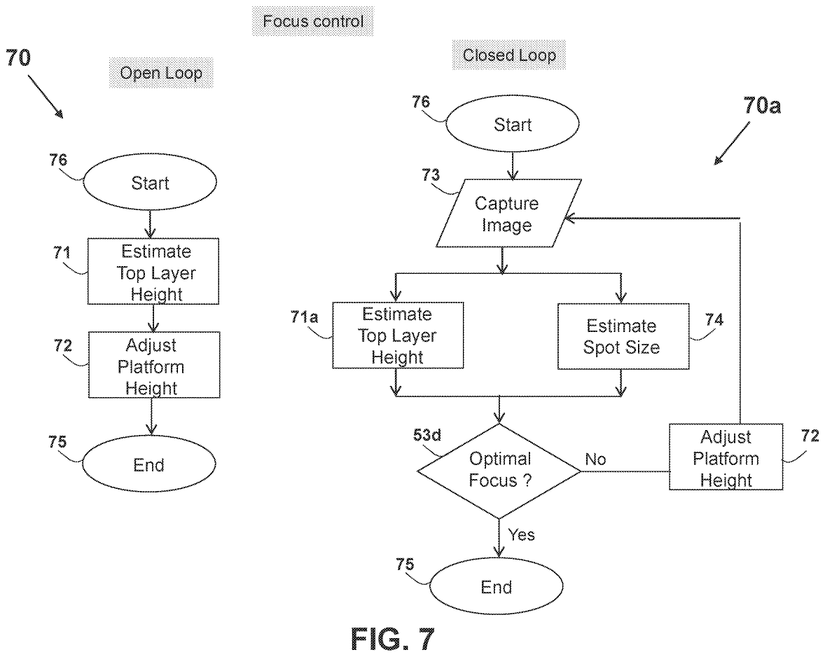

An open-loop control flow chart 70 of the spot size, such as the light spot 33a that is shown in FIG. 6, is shown in FIG. 7. Such flow chart 70 may be stored as part of the “Instructions” 42b that are stored in the memory 43 and executed by the processor 44 in the controller 41. As part of an “Estimate Top Layer Height” step 71, initiated after a “Start” step 76, the controller 24 estimates or calculates the optical gap ‘h2’ 67b between the lens 23a at level 61b and the top 3D object level 61. In one example, the level 61b of the lens 23a is known to the controller 24 as being fixed based on the mechanical structure of the 3D printer 20. The height level 61a of the top surface of the build platform 28 is estimated based on the vertical position of the linear actuator 17, such as by the interface circuitry 47d that in part of the linear actuator interface 46d, by the processor 44 in an exemplary controller 41.

In one example, the vertical distance ‘h’ 67 may be calculated or estimated based on the difference between the beam output level 61b (from the lens) and the estimated or calculated top surface level 61a. In another example, the height ‘h1’ 67a of the 3D object 62 is taken into account for higher accuracy. In such a case, the controller 24 further estimates or calculates, in addition to the total vertical distance ‘h’ 67, the height ‘h1’ 67a of the 3D object 62. Then the actual gap ‘h2’ 67b between the top surface level 61 of the 3D object 62 and the lens 23a level 61b may be calculated as h2=h−h1.

The calculated or estimated height ‘h’ 67 or the calculated or estimated height ‘h2’ 67b may be used, by the controller 24, for adjusting the vertical position of the build platform 28 (such as by controlling the motor 18 that affects the vertical linear actuator 17), as part of an “Adjust Platform Height” step 72. For example, the controller 24 controls the motor 18 such that the calculated or estimated height ‘h2’ 67b (or the calculated or estimated height ‘h’ 67) is equal to, the focal length of the lens 23a. In a case of a calculated or estimated height that is longer than a target height (such as the focal length of the lens 23a), the motor 18 is controlled to elevate the build platform 28 in an amount required to reduce for reaching the target height. Similarly, in a case of a calculated or estimated height that is shorter than a target height (such as the focal length of the lens 23a), the motor 18 is control to lower the build platform 28 in an amount required to increase for reaching the target height. Upon ending of the adjusting as part of the “Adjust Platform Height” step 72, the process ends at an “End” step 75. The focusing process renders the resin liquid layer as a focal plane.

Alternatively or in addition, a closed-loop control may be used, such as a flow chart 70a that is shown in FIG. 7. Such flow chart 70 may be stored as part of the “Instructions” 42b that are stored in the memory 43 and executed by the processor 44 in the controller 41. As part of an “Capture Image” step 73, initiated after a “Start” step 76, an image is captured by the camera 29 under control of the controller 24. For example, the camera 29 may be controlled to capture an image and provide the captured image as part of the “Capture Image” step 73 to the processor 44 for image processing. As part of a “Estimate Top Layer Height” step 71a, the calculated or estimated height ‘h2’ 67b (or the calculated or estimated height ‘h’ 67) are obtained similar to the “Estimate Top Layer Height” step 71, based on image processing (such as by the processor 44) of the image that was captured as part of the “Capture Image” step 73.

Alternatively or in addition, the size, dimensions, shape, or any combination thereof, of the light spot is estimated or calculated based on the image of the light spot itself that is captured in the captured image as part of the “Capture Image” step 73, as part of an “Estimate Spot Size” step 74. In such a case, the camera 29 may be configured to capture an image as part of the “Capture Image” step 73 that is in the spectrum of light of the light beam 33 emitted by the light source 22. For example, in case of UV laser, the camera 29 may be a UV camera. The image processing as part of the “Estimate Spot Size” step 74 may be stored as part of the “Instructions” 42b that are stored in the memory 43 and executed by the processor 44 in the controller 41.

The calculated or estimated height ‘h2’ 67b (or the calculated or estimated height‘h’ 67) are compared to a required height (or target gap, such as focal distance), as part of an “Optimal Focus?” step 53d. In the case the required height is achieved (or is close enough, such as when there is neglectable gap that is below a pre-determined threshold), then the process ends at an “End” step 75. Similarly, in case the required spot size (or any other spot characteristics) is checked as part of the “Optimal Focus?” step 53d. In case where the optimal spot related value, such as the spot size, is obtained (such as below a pre-determined size or upon achieving minimum value), then the process ends at an “End” step 75.

In a case where the optimal or target height or the optimal or target spot size (or other characteristics) is not obtained when checked as part of the “Optimal Focus?” step 53d, the build platform 28 height is adjusted towards reaching the optimal or target value, as part of the “Adjust Platform Height” step 72, similar to, or identical to, the “Adjust Platform Height” step 72 that is part of the open-loop flow chart 70 in FIG. 7. A formula 68a for calculating a spot size, a formula 68b for calculating a beam diameter, and a formula 68c for calculating depth of field are provided as part of a view 60i in FIG. 6e.

In one example, the light spot is circular, and the target or obtained diameter of such light spot on the cured resin liquid (such as at the height level 61) may be more than 1, 2, 5, 10, 15, 20, 50, 100, 120, 150, 200, 300, 500, or 1,000 microns. Alternatively or in addition, the target or obtained diameter of such circular light spot on the cured resin liquid (such as at the height level 61) may be more than 2, 5, 10, 15, 20, 50, 100, 120, 150, 200, 300, 500, 1,000, or 2,000 microns. In another example, the light spot may be circular or another shape, such as ellipsoid, and the target or obtained area of such light spot on the cured resin liquid (such as at the height level 61) may be more than 0.001, 0.002, 0.005, 0.01, 0.02, 0.05, 0.1, 0.2, 0.5, 1.0, 1.2, 1,5, 2.0, or 5.0 millimeter-square (mm²). Alternatively or in addition, the target or obtained area of such light spot on the cured resin liquid (such as at the height level 61) may be less than 0.002, 0.005, 0.01, 0.02, 0.05, 0.1, 0.2, 0.5, 1.0, 1.2, 1,5, 2.0, 5.0, or 10.0 millimeter-square (mm²).

In one example, the open-loop light spot control flow chart 70, or the closed-loop light spot control flow chart 70a shown in FIG. 7, initiated at the “Start” step 76, is performed once per printing session, such as upon powering up of the 3D printer 20, by a request of a user, or as part of starting a printing process, such as part of the printing flow chart 50a. For example, the “Start” step 76 may be initiated as part of the “Receive 3D Model” step 51 or the “Print Layers” step 53b. Alternatively or in addition, the “Start” step 76 may be initiated once before or after printing of a single layer, such as being part of the “Print Layer” step 55. Alternatively or in addition, the light spot control may be initiated periodically, where the “Start” step 76 is initiated after a time interval that follows the “End” step 75 of a former light spot control process. Such time interval may be above than 0.1, 0.2, 0.5, 1.0, 1.2, 1.5, 2.0, 3.0, 5.0, 10, 15, 20, 50, 100, 120, 150, 200, 500, or 1,000 seconds. Alternatively or in addition, the time interval may be below than 0.2, 0.5, 1.0, 1.2, 1.5, 2.0, 3.0, 5.0, 10, 15, 20, 50, 100, 120, 150, 200, 500, 1,000 or 2,000 seconds. Alternatively or in addition, the light spot control may be continuously, where the “Start” step 76 is initiated immediately (as practical) after the “End” step 75 of the former light spot control process.

While the open loop focus control flow-chart 70 and the closed-loop focus control flow chart 70a in FIG. 7 are described achieving focus by adjusting the height of the printed object (such as by adjusting the height of the platform 28), any other focus control mechanism may be equally used, as an alternative or in addition. In one example, the focus is controlled by using a 3-axis scan-head as part of the light director 23. In such a case, the “Adjust Platform Height” step 72 is supplemented with, or is replaced with, controlling the Z-axis (height) of the scan head. Such third axis control may use the control functionality 47b of the interface 46b, which is part of the controller 41.

An example of a 3-Axis galvo scan head is XG330-Y1 that is part of a VantagePro® Galvo System Scan Heads family available from Thorlabs, Inc. of Newton, NJ, U.S.A., described in a data sheet entitled: “Dynamic Focusing 3-Axis Galvo Scan Head THREE-AXIS VANTAGEPRO® GALVO SYSTEM SCAN HEADS”, downloaded December 2023 from https://www.thorlabs.com/newgrouppage9.cfm?objectgroup_id=14125, which is incorporated in its entirety for all purposes as if fully set forth herein. The XG330-Y1 is a 3-Axis scan head with XY Galvo Scanning with Dynamic Z-Axis Focusing, and is suitable for large field sizes and small spot sizes. These 3-Axis VantagePro® Galvo System Scan Heads include XY scanning mirrors and Z-axis focusing elements in order to achieve a large, three-dimensional field of view. Rather than a standard f-theta scanning lens, these scan heads use translating focusing elements to adjust the focal point of the system and maintain a flat scan area. The Dynamic Focusing Scan Heads are capable of achieving field sizes up to 1000×1000 mm² or spot sizes down to Ø22 μm, offering flexibility and making them suitable for many applications. The dynamic lens translator continuously adjusts the focus distance via a combination of manual and motorized actuators to produce a flat or contoured field; manual adjustment of the lens position determines the working distance and field size, while fine motorized adjustment provides focal correction while scanning. These scan heads are available with mirrors for Nd:YAG (1064 nm) or CO2 (10.6 μm) lasers.

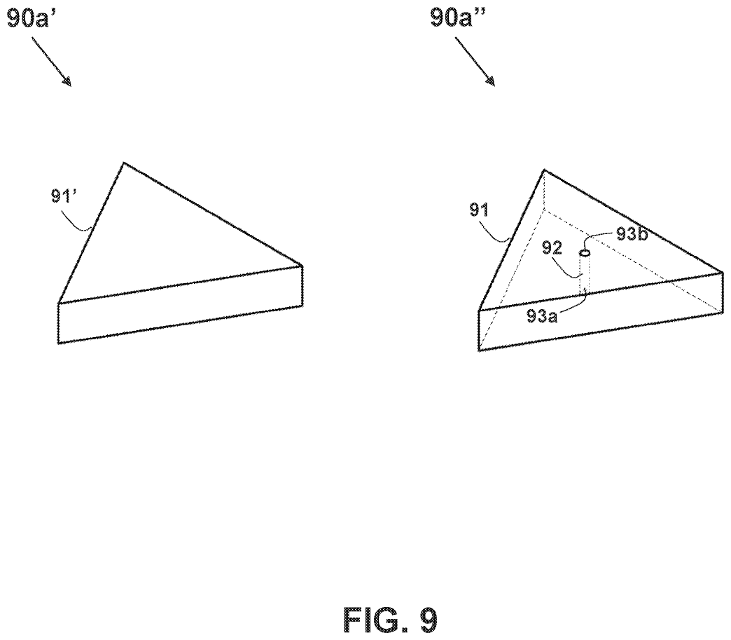

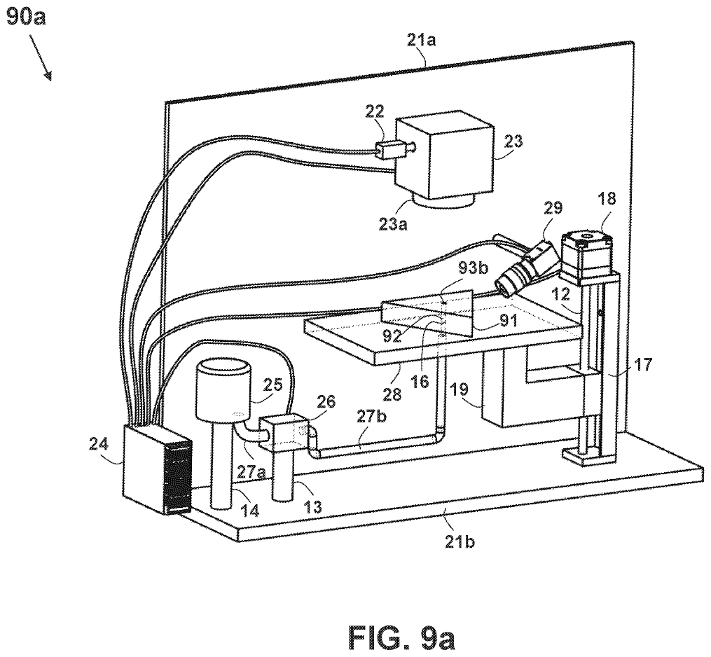

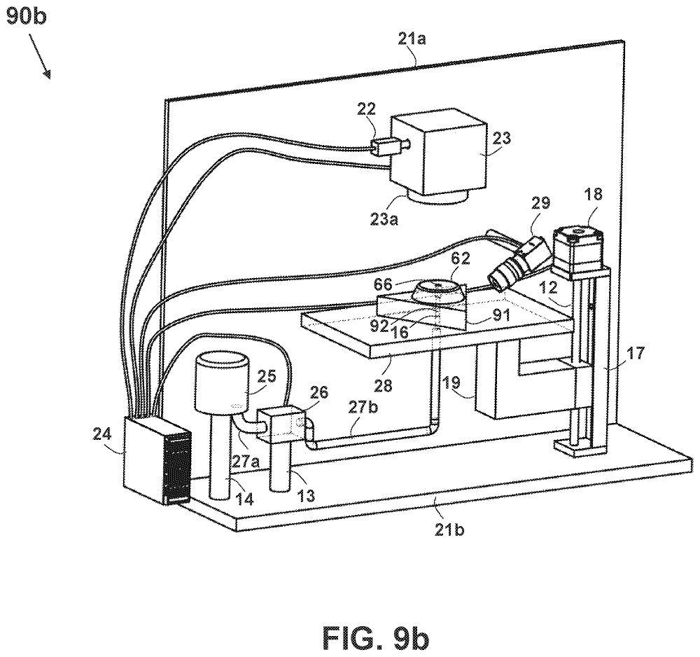

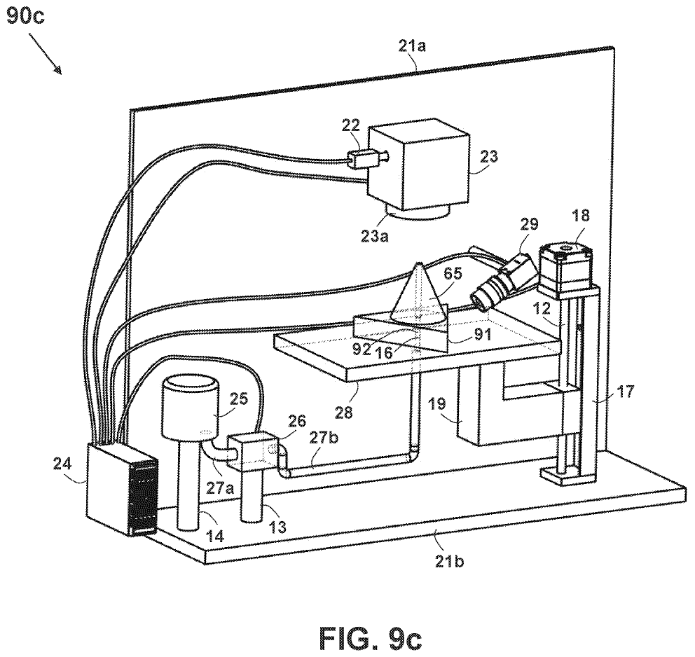

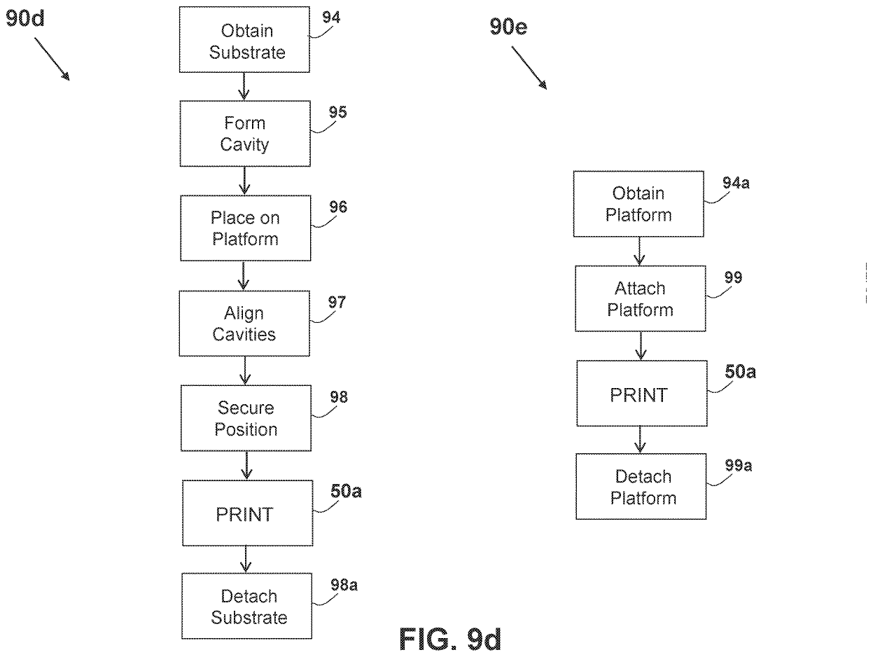

The view 60f in FIG. 6b is an example that schematically illustrates a fabrication of a cone, shown as an in-process cone 62 (and as a complete cone 65 in the view 60g in FIG. 6c), where the fabrication of the 3D object is performed directly on the platform 28. The fabrication makes use a process of curing, using a light beam 33, the resin liquid that is pushed from the container 25 by the pump 26 via the pipe 27b, and is output and spread via the top opening 16 in the platform 28, so that the cavity 66 serves as a pathway for the resin liquid. Alternatively or in addition, the fabrication of the 3D object may be on top another 3D object that is located on the platform 28. An example of an external perspective isometric view 90a′ of a triangular-shaped 3D object 91′, that may be used for printing another 3D object thereon, is shown in FIG. 9. In order to an object to serve as a substrate on which a 3D object is to be formed, the substrate object need to include a cavity through which the resin liquid may be passed, to be cured above the substrate object. Such a vertical cavity 92, having a top opening 93b and a bottom opening 93a, as part of a triangular-shaped object 91, in shown in a view 90a″ in FIG. 9. In one example, the cavity 92 of the substrate object 91 may be formed as part of the manufacturing of the object 91, such as when being manufactured by the 3D printer 20 shown in FIG. 2. Alternatively or in addition, the cavity (such as the cavity 92) may be formed after the manufacturing of the object, such as by drilling or by any other hole or cavity making technique. A view 90a in FIG. 9a schematically depicts the 3D printer 20, with the triangular-shaped substrate 91 located on the platform 28. The substrate 91 is placed on the platform 28 so that the opening 16 or nozzle is aligned with the lower opening 93a of the substrate 91, so that a continuous cavity is formed by the vertical cavity 32a in the platform 28 and the cavity 92 in the substrate 91. Such alignment allows for the resin liquid to pass from the container 25 via the pump 26 and the hose 27b, through the cavity 32a in the platform 28 and the cavity 92 in the substrate 91, and then to be spread over the top surface of the substrate 91, so it can be cured thereon. In one example, the substrate is secured to the platform 28, such as by any detachable mechanical attaching technique, to resist any movement that may affect the alignment, to ensure uninterrupted flow of the resin liquid throughout the printing process. A view 90b in FIG. 9b schematically depicts the in-process cone 62 being formed on the substrate 91 (that is mounted on the platform 28), and a view 90c in FIG. 9c schematically depicts the completed formed cone 65 on the substrate 91, after the printing process of the cone 65 is completed. After completing the printing, the substrate 91, with the printed 3D object (such as the cone 65), may be separated from the platform 28, allowing for a new printing cycle to commence.

Printing directly on another object, such as on the substrate 91, may provide enhanced customization by tailoring to specific user requirements or functionalities, such as enabling precise modifications and supporting personalization. Such scheme may further support adding intricate features or functionalities on any substrate, without compromising the basic structural integrity, or requiring extensive redesign, of the substrate. For example, such modification of a substrate may promote sustainability or may extend the lifecycle of products by enabling repairs, upgrades, or enhancements, without the need for complete replacement, contributing to a reduction in overall waste and encouraging more responsible consumption patterns. In addition, such modification may be used for plating, marking, or coating, of the substrate (such as the substrate 91), such as for the purpose of adding a decorative or a functional (or both) material.

A flow chart 90d for printing on a substrate is shown in FIG. 9d. As part of an “Obtain Substrate” step 94, the substrate on which the 3D object is to be printed is obtained, such as the triangular-shaped substrate 91 shown in FIG. 9. In case the substrate obtained as part of the “Obtain Substrate” step 94 does not include any internal cavity, a cavity is formed in the obtained substrate as part of a “Form Cavity” step 95. For example, the substrate may be drilled on punched to create the required cavity, such as the cavity 92 in the triangular-shaped substrate 91 shown in FIG. 9. The substrate is placed on the platform 28 as part of a “Place on Platform” step 96, and the top opening of the cavity in the platform 28 is aligned with the bottom cavity of the placed substrate, as part of a “Align Cavities” step 97. For example, the bottom cavity 93a of the substrate 91 is aligned to the top opening of the platform 28, so that a continuous cavity is formed by the cavity 32a in the platform 28 and the cavity 92 in the substrate 91. The substrate is them mechanically secured to the platform 28, as part of a “Secure Position” step 98, to avoid mis-alignment of the cavities during the printing, and for ensuring that a secured watertight sealing is formed between the cavity 32a and the substrate cavity 92. The printing flow-chart 50a shown in FIG. 5 then follows as part of the “PRINT” step 50a, during which the 3D object is printed on the secured substrate. Upon completion of the printing as part of the printing flow-chart 50a, the substrate that was attached and secured as part of the “Secure Position” step 98, is separated from the platform 28 as part of a “Detach Substrate” step 98a.

The material of a substrate, such as of the substrate 91, may be the same as the material of the formed 3D object (based on cured resin). Alternatively or in addition, the material of the substrate may be similar to, or different from, the material of the formed 3D object (based on cured resin). The substrate (such as the substrate 91) may be made of metal, such as an iron; an alloy such as stainless steel; or a molecular compound such as polymeric sulfur nitride. Further, the substrate may be made of a metallic iron alloy such steel, stainless steel, cast iron, tool steel, alloy steel, as well as of Aluminum, Titanium, Copper, and Magnesium. Alternatively or in addition, the substrate may be made of synthetic or semi-synthetic materials that use polymers as a main ingredient, such as plastics, may be made of a non-crystalline solid that is often transparent, brittle and chemically inert, such as glass, or may be made of hard, brittle, heat-resistant, and corrosion-resistant materials made, such as ceramics, for example earthenware, porcelain, or brick. Alternatively or in addition, the substrate may be made of cement-based materials, such as concrete or plaster, wood-based materials (such as oak or pine), wood products (such as MDF or plaster), or composite materials (such as carbon fiber or fiberglass). The shape of a substrate, such as of the substrate 91, may be the same as, similar to, or different from, the shape of the formed 3D object. For example, the substrate may be shaped as a cone, a cylinder, an ellipsoid, a sphere, a hyperboloid, a paraboloid, a box, a plate, a torus, a polytope, or any combination thereof.

The securing the substrate to the platform 28 as part of the “Secure Position” step 98, may use an adhesive material such as glue or adhesive stickers. Alternatively, releasable mechanical attachment can be achieved by using so called “hook and loop” fasteners, such as VELCRO, or any other releasably joined surfaces. In this approach mating Velcro strips are attached to both surfaces to be attached (e.g., by means of adhesives) on opposing and contacting surfaces, such that mechanical attachment is formed by juxtaposing the mating strips. The elements may be separated from the outlet by applying enough force to release the VELCRO fastener. Alternatively or in addition, the securing may use suction; adhesive; stickers; glue; magnetic force; and ‘hook-and loop’ fastening, as well as a movable bar, a protruding ridge, a securing strap or band; a spring clamp; and eccentric levers.

The 3D printer 20 shown FIG. 2 is shown as including the platform 28 as part of the printer 20 itself, where the platform 28 is permanently mechanically attached to the printer 20 mechanical structure 21b via the right-angled bar 19, attached to the linear actuator 17. In one example, the platform 28 may be a separated component, which may be attachable to, and detachable from, the 3D printer 20. The platform 28 is described as having a surface on which the 3D object is formed, by curing the resin liquid. In one example, the 3D object may be formed on another object, such as the substrate 91 shown in the views 90a-90c in FIG. 9a 9c. In such a scenario, the substrate itself may be used as a surface to be printed on, obviating the need for the platform 28. Alternatively or in addition, various platforms may be used, each suitable (such as by size, dimensions, or shape) to the specific 3D object to be printed. Further, having a separated platform 28 may contribute to lighter and smaller 3D printer 20.

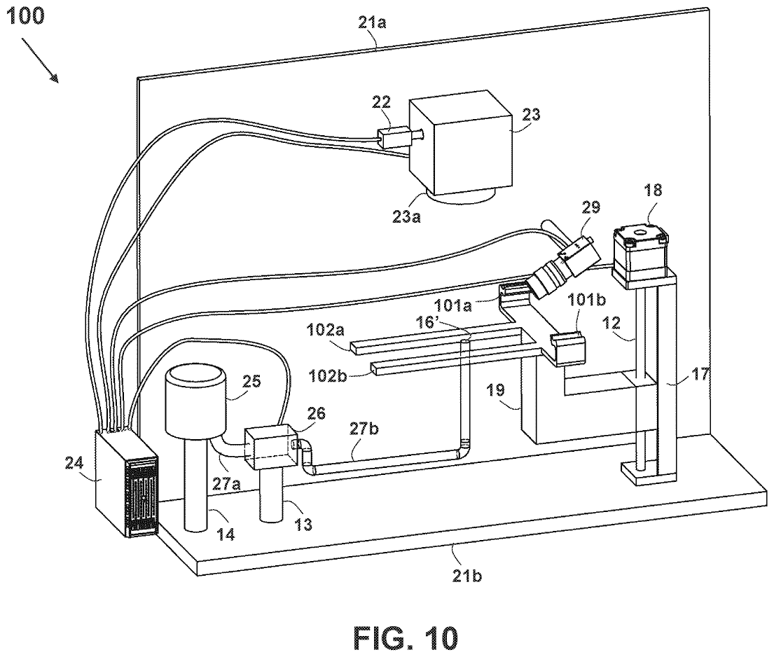

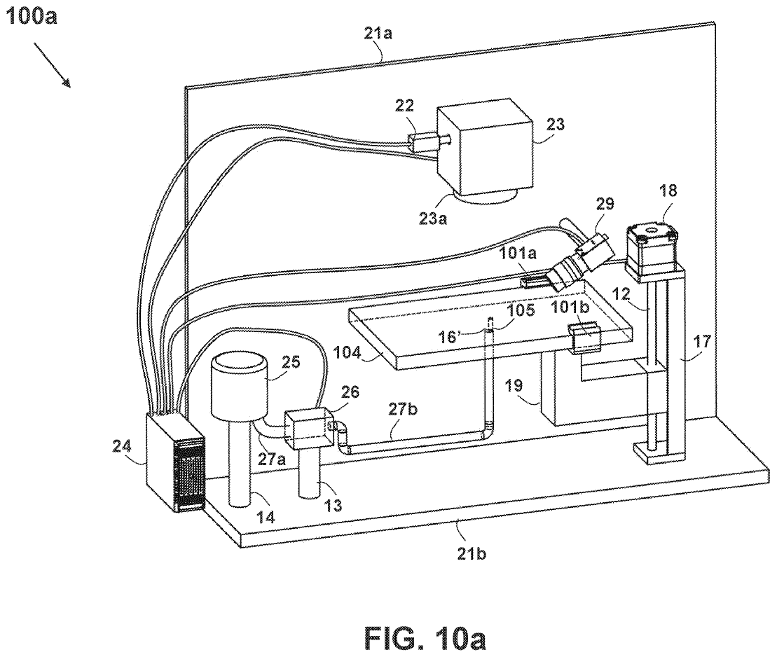

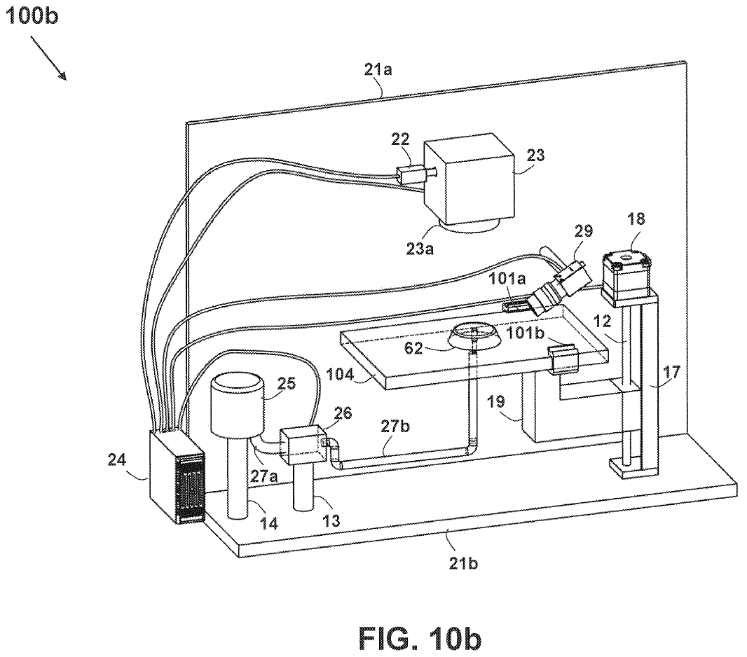

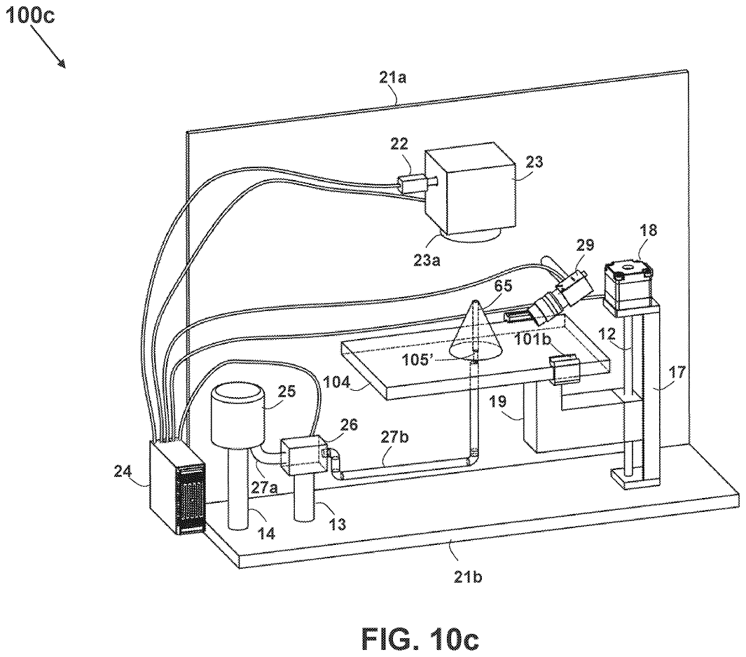

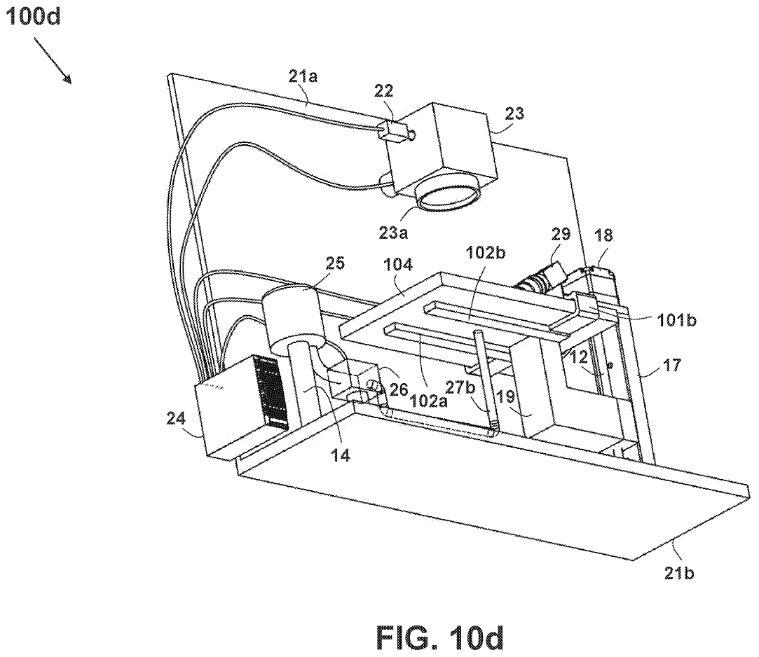

An example of a 3D printer 100 that is suitable for use with a detachable platform is shown in FIG. 10. The printer 100 is shown without the platform 28, but includes a mechanism for attached and detaching such a platform 28. The printer 100 includes two elongated bars 102a and 102b, permanently mechanically attached, or being part of, the right-angled bar 19, on which the platform 28 may be placed. The elongated bars 102a and 102b provides a vertical support for the platform 28, when placed on them. Two fasteners 101a and 101b are part of the 3D printer 100, and are used to hold the platform 28 in place, and to secure it not to be moved (such as horizontally) during the printing process. A detachable platform 104, that serves as a replacement to the permanent platform 28, is shown in a view 100a in FIG. 10a. The detachable platform 104 is placed on the elongated bars 102a and 102b (not shown), and secured in position by the fasteners 101a and 101b. The resin liquid is supplied via the pipe 27b that ends at an opening 16′. Similar to the platform 28, the detachable platform 104 includes a vertical cavity for passing a resin liquid therethrough, that should be aligned with the opening 16′ for passing the resin liquid therethrough. A formed in-process cone 62, formed on the detachable platform 104, is shown in a view 100b shown in FIG. 10b, and a fully formed cone 65, having a vertical cavity with a lower opening 105′, is shown in a view 100c in FIG. 10c. A bottom perspective view 100d that pictorially depicts the 3D printer 100 with the detachable platform 104 installed, is shown in FIG. 10d.

A detachable platform provides streamlines the 3D printing process, making it more efficient, versatile, and user-friendly, and further enhances an operational efficiency by means of allowing continuous printing cycles for by easily removing and replacing it without disrupting the workflow of the 3D printer. Avoiding such disruptions reduces downtime between consecutive printing cycles, leading to higher productivity and throughput. Further, such providing a stable and level printing surface may be critical for achieving high-precision and quality outcomes, as well as for improving printing quality. Furthermore, the fully formed 3D objects may be easily removed and cleaned without requiring direct access to the 3D printer interior, facilitating flexible and easier post-processing of the printed 3D objects, while preserving the integrity of both the object and the printer. In addition, such detachability of the platform provides versatility by quickly adapting the 3D printer to support different materials or printing requirements, by swapping platforms prepared with specific coatings or textures tailored to each printing process. The use of a detachable platform may further enhance safety of the 3D printing process by minimizing the risk of injury when removing printed 3D objects, by avoiding direct contact or exposure to the potentially harmful light beam 33 or any moving parts.

In addition, as exampled in FIGS. 9-9c the forming of the 3D objects on a detachable platform, eliminates the need for post-processing assembly, and enhances product customization. A direct forming of bespoke 3D objects with integrated features on the platform itself further streamlines production, by merging the manufacturing and finalization stages. It significantly optimizes workflow efficiency by ensuring higher precision, and by reducing the risk of any post-production damage,

A flow chart 90e for printing using the detachable platform 104 is shown in FIG. 9d. As part of an “Obtain Platform” step 94a, the detachable platform 104 on which the 3D object is to be printed is obtained. The detachable platform 104 is mechanically attached to the 3D printer 100, and secured into place to avoid unrequired movement, as part of a “Attach Platform” step 99. The printing flow-chart 50a shown in FIG. 5 then follows as part of the “PRINT” step 50a, during which the 3D object is printed on the secured substrate. Upon completion of the printing as part of the printing session flow-chart 50a, the detachable platform 104 that was attached and secured as part of the “Attach Platform” step 99, is detached, typically with the formed 3D object above its surface, and separated from the 3D printer 100 as part of a “Detach Platform” step 99a.

While the attachment means of the detachable platform 104 was exampled in the view 100 in FIG. 10 to include the two horizontal elongated bars 102a and 102b, working in conjunction with the two horizontal fasteners 101a and 101b, any means, mechanisms, hardware components, or techniques that mechanically non-permanently joins or affixes two or more objects together, may be equally used for fastening and securing the detachable platform 104. Preferable, the attaching and detaching means are designed to be easy to use by a person, intuitive, may not require excessive force, and may not require any tools, and the removal or dismantling should not cause any damaging to the detachable platform 104 or to the formed 3D object on it. In one example, the attaching means may include crimping, welding, soldering, brazing, taping, gluing, cement, or the use of other adhesives. Further, magnets, vacuum (like suction cups), or friction may be used.

The platform 28 is shown in the view 30a in FIG. 3 to include a single cavity 32 that ends with a single top opening 16, through which the resin liquid is output and spread for curing. However, multiple opening may be equally used, allowing for fabrication of multiple 3D objects, each on a respective opening, thus allowing concurrent forming of the multiple 3D objects. Further, the multiple opening may be used to form one wide 3D object, by concurrently printing separated parts of this wide 3D object, which are then joined into a single wide 3D object.

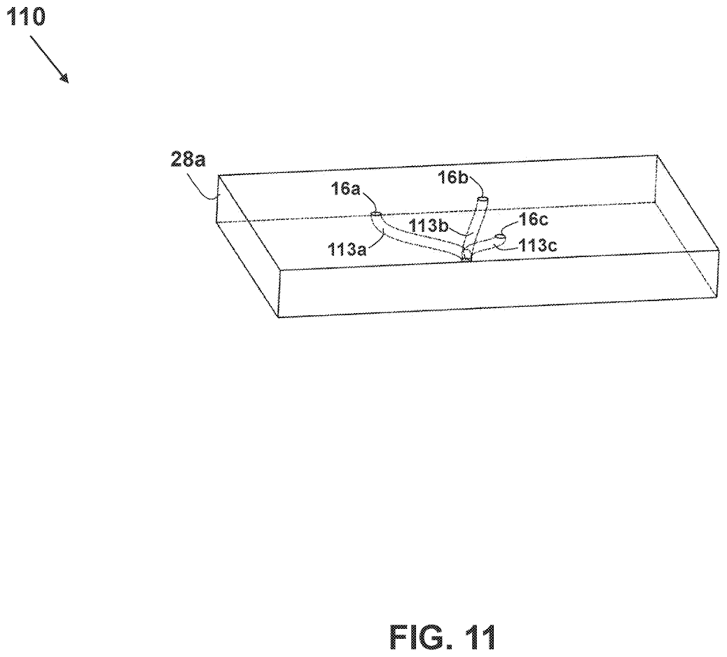

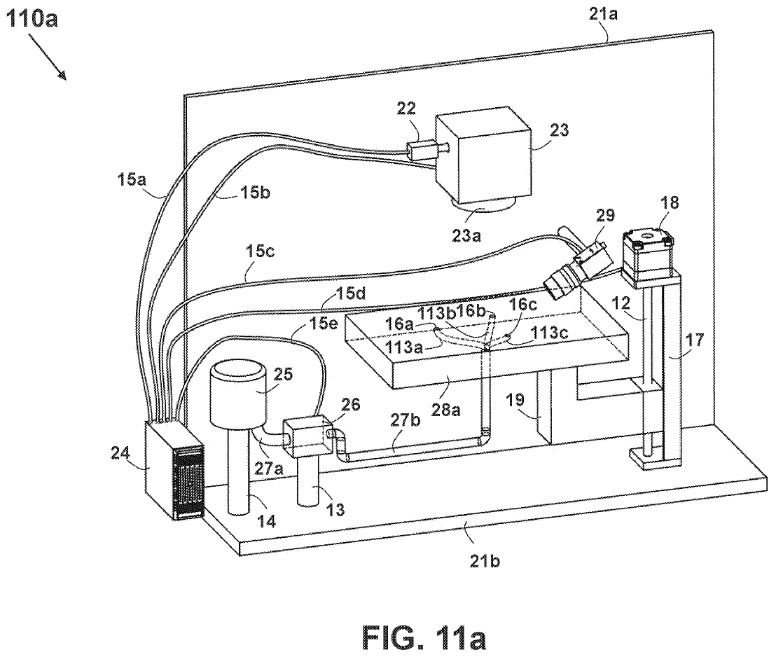

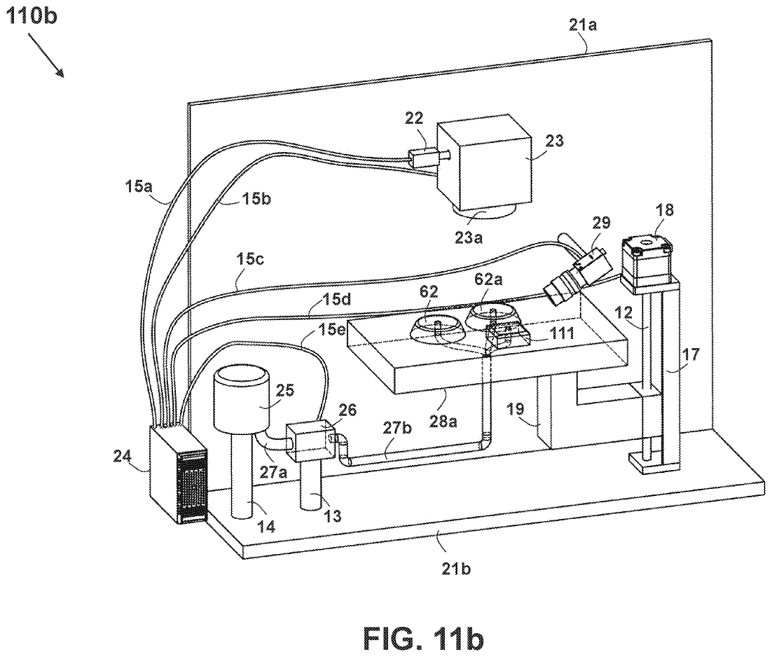

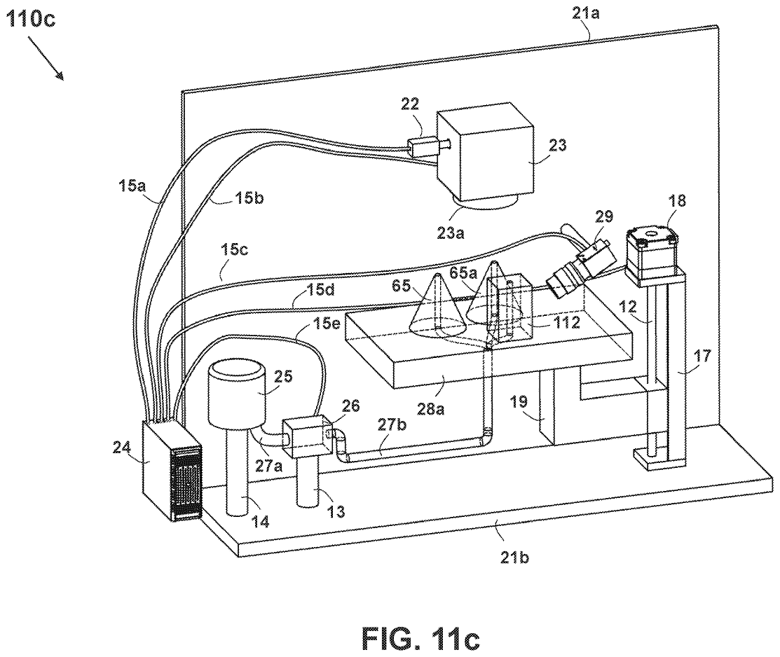

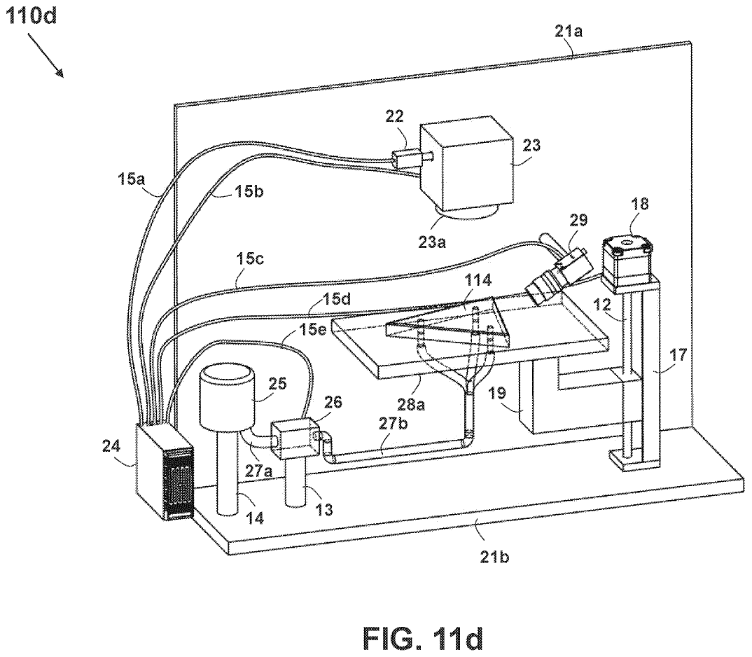

An example of such multiple-openings platform 28a is shown in a view 110 in FIG. 11. While a single bottom is used, three cavities are used, split at the bottom opening or inside the platform 28a. A first cavity 113a ends at a first top opening 16a, a second cavity 113b ends at a second top opening 16b, and a third cavity 113c ends at a third top opening 16c. The pump 26 pushes the resin liquid via the pipe 27b to the bottom opening, so that the resin liquid is output and spread concurrently from the three top openings 16a, 16b, and 16c, to be then cured as described herein. An example of a 3D printer 110a that uses such a three-openings platform 28a is shown in FIG. 11a. An example of in-process fabrication of separated three 3D objects is shown in a view 110b in FIG. 11b, where a first in-process cone 62 is formed by a resin liquid output from the top opening 16a (via the cavity 113a), a second in-process cone 62a is formed by a resin liquid output from the top opening 16b (via the cavity 113b), and an in-process rectangular cuboid 111 is formed by a resin liquid output from the top opening 16c (via the cavity 113c). An example of a completed fabrication of the separated three 3D objects that are shown in-process in the view 110b, is shown in a view 110c in FIG. 11c, depicting the first completed cone 65, the second completed cone 65a, and the completed rectangular cuboid 112. Using multiple openings allows for operational efficiency and enhancing productivity by reusing and simultaneously forming of multiple 3D objects by a single 3D printer, such as for batch production.

While the platform 28a is exampled in the views 110-110d in FIGS. 11-11d as having three top openings 16a, 16b, and 16c, any number of openings may be equally used. For example, such a platform 28a may provide at least 2, 3, 4, 5, 7, 10, 12, 15, 20, 30, or 50 openings. Alternatively or in addition, such a platform 28a may provide less than 3, 4, 5, 7, 10, 12, 15, 20, 30, 50, or 100 openings. In one example, the 3D objects formed at the various openings may be identical, such as having the same shape, structure, and dimensions. In such a case, the 3D printer having the multiple-opening platform is used for better productivity, such as efficiently fabricating multiple identical 3D objects. In another example, the 3D objects formed at the various openings may be different and distinct from each other. Further, part of the openings may be used to fabricate identical products, while other one or more openings are used for fabrication of different or distinct 3D objects. In the example of the view 110c shown in FIG. 11c, the two cones 65 and 65a may be identical, but are different from the cuboid 112. It is noted that the printing and curing process, such as according to the flow charts 50a, 50b, and 50c shown in FIG. 5, may be equally applied to each of the formed multiple objects on the multiple-openings platform 28a.

While the view 110c in FIG. 11c depicts the forming of three separated 3D objects, the two cones 65 and 65a and the cuboid 112, the 3D printer 110a may equally be used to form a single 3D object, by using the three top openings 16a, 16b, and 16c. For example, such arrangement may be used to for three separated parts of a single large or wide 3D object, such as for forming a single triangular-shaped 3D object 114, as shown in a view 110d in FIG. 11d. Such an arrangement may allow for faster printing by supplying the resin liquid via the three openings, forming in parallel different parts of the 3D object 114. Such forming of a single 3d object by using multiple opening allows for quick printing time and for efficient resin liquid flow rate. Further, the required resin liquid travels shorter distance for reaching the target sub-areas, thus improving a print time and forming precision.

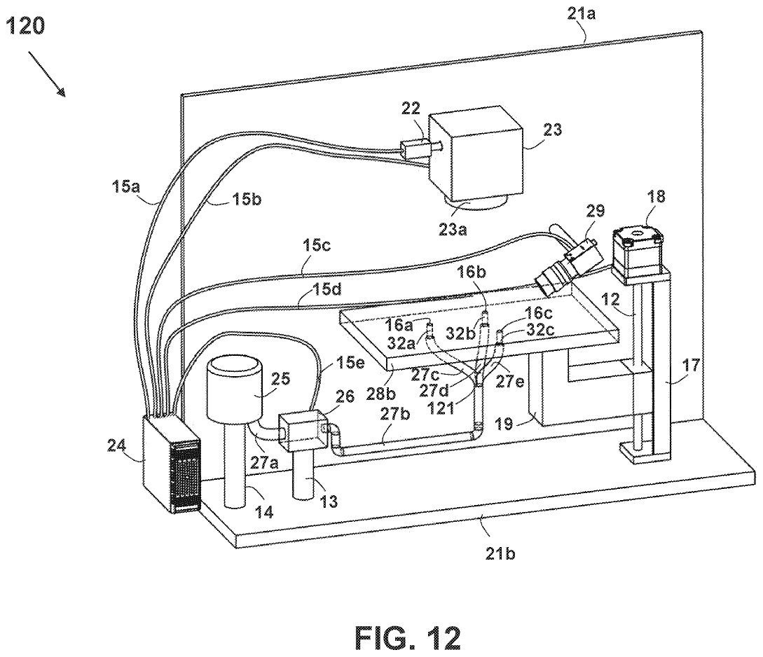

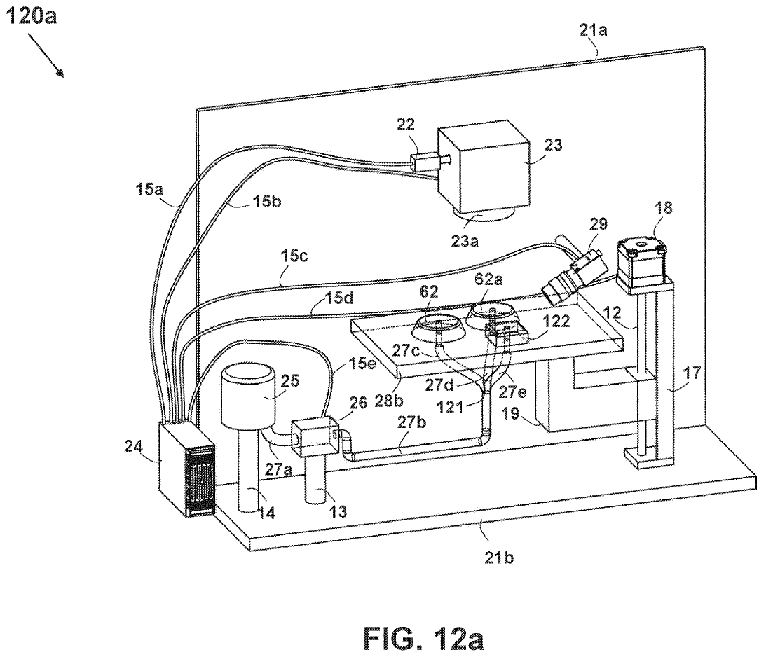

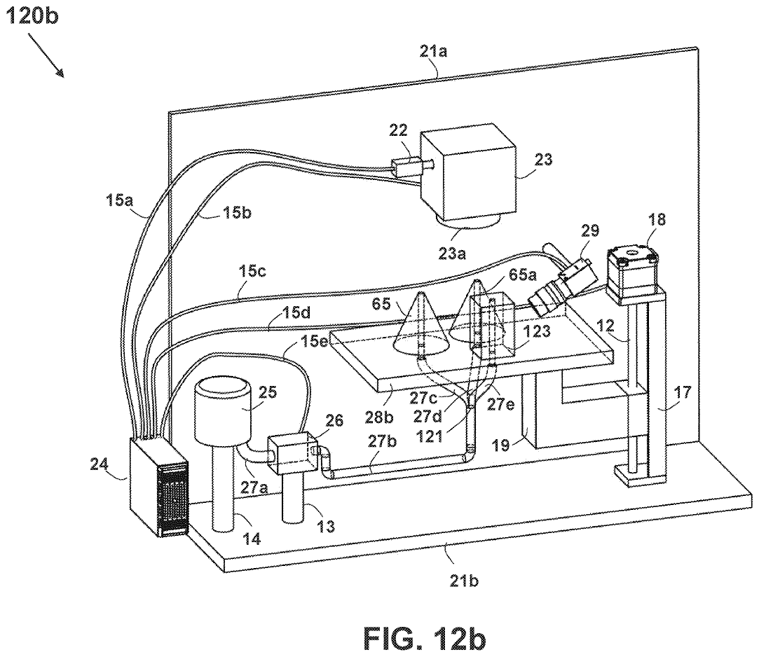

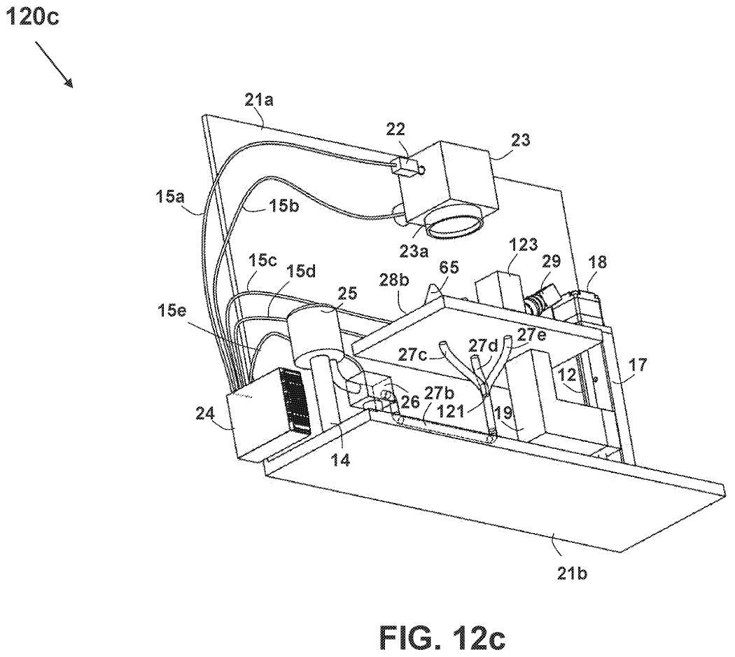

The platform 28a is shown in the view 110 in FIG. 11 to include three cavities, split at the single bottom opening or inside the platform 28a. A first cavity 113a ends at a first top opening 16a, a second cavity 113b ends at a second top opening 16b, and a third cavity 113c ends at a third top opening 16c. In one example, the split of the resin liquid into multiple cavities is performed external to the platform 28. An example of a 3D printer 120 that uses such a multiple separated cavities platform 28b is shown in FIG. 12. The platform 28b includes 3 separate and independent vertical cavities, each can be identical or similar to the cavity 32a shown for the platform 28. A first vertical cavity 32a is having a top opening 16a and is fed via a resin liquid pipe 27c, a second vertical cavity 32b is having a top opening 16b and is fed via a resin liquid pipe 27d, and a third vertical cavity 32c is having a top opening 16c and is fed via a resin liquid pipe 27e. In a split point 121 the resin fluid received from the pipe (or hose) 27b is split to three pipes 27c, 27d, and 27e. In such a case, a resin liquid pushed by the pump 26 via the pipe 27b is split into the three openings, and output and spread (to be cured) at the three top openings 16a, 16b, and 16c. Such splitting reduced the 3D printer complexity by better and straightforward management of the resin liquid split to the required openings. Further, improved flexibility is obtained since the openings to be used may be individually selected as required by the printing process.

An example of in-process fabrication of separated three 3D objects using the multiple separated cavities platform 28b is shown in a view 120a in FIG. 12a, where a first in-process cone 62 is formed by a resin liquid output from the top opening 16a (via the cavity 32b), a second in-process cone 62a is formed by a resin liquid output from the top opening 16b (via the cavity 32b), and an in-process rectangular cuboid 122 is formed by a resin liquid output from the top opening 16c (via the cavity 32c). An example of a completed fabrication of the separated three 3D objects that are shown in-process in the view 120a, is shown in a view 120b in FIG. 12b, depicting the first completed cone 65, the second completed cone 65a, and the completed rectangular cuboid 123. A perspective bottom view of the 3D printer 120b with the completed objects is shown in a view 120c in FIG. 12c.

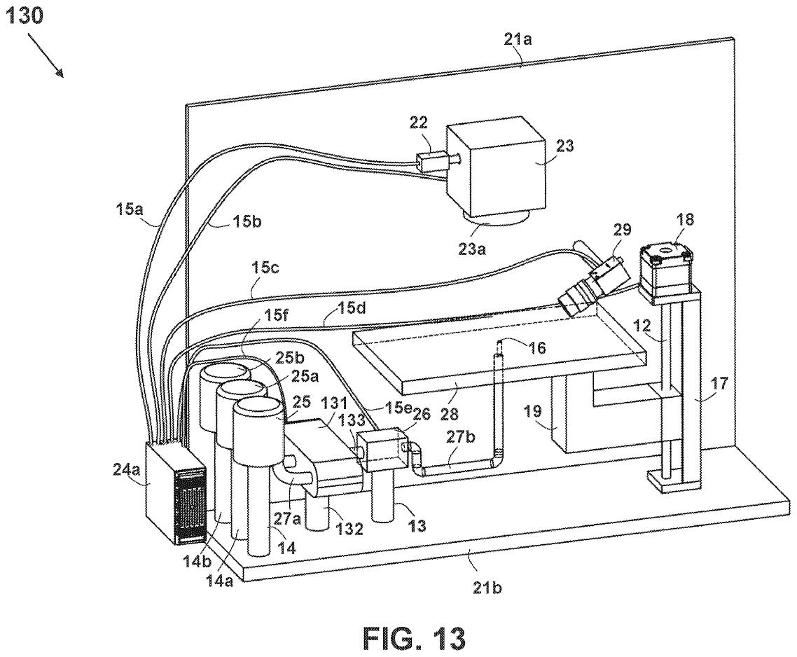

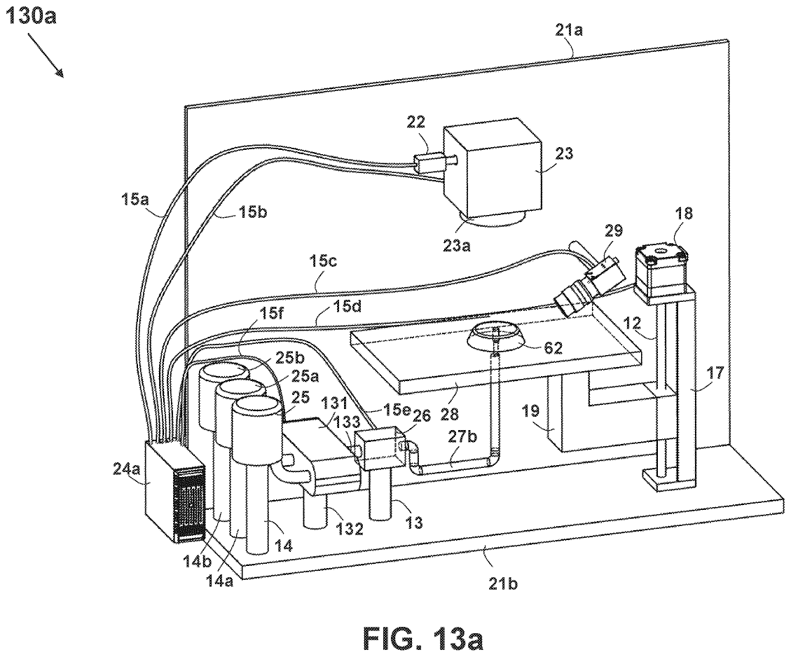

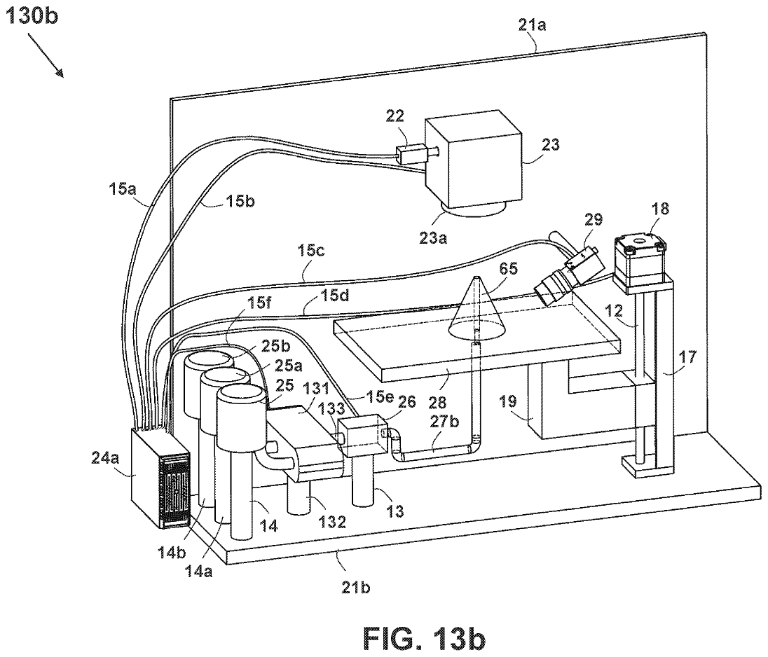

A single container 25 that store a single type of a resin liquid is shown as part of the 3D printer 20 in FIG. 2. In one example, multiple containers may be used, each storing a different type of resin liquid, allowing for printing using the different types of the resin liquid. For example, different resin colors may be used, enabling printing of a multicolor 3D objects. In another example, one of the resin types may be conductive type, allowing for printing of conductive paths in a 3D object. An example of a multi-resin 3D printer 130 is shown in FIG. 13, that comprises a first type of a resin liquid in a first resin liquid container 25 mounted on a pole 14, a second type of a resin liquid in a second resin liquid container 25a mounted on a pole 14a, and a third type of a resin liquid in a third resin liquid container 25b mounted on a pole 14b. Each of the resin liquid containers feeds the stored resin liquid via a respective pipe (such as a pipe 27a for the container 25) to a resin selector 131 (mounted on a support pole 132), which select from which container the resin liquid is streamed via a pipe 133 to the pump 26, from which it is then fed via the pipe 27b to the platform 28, to be output via the top opening 16, as described above. Each of the containers may store different resin liquid type, which may differ by color type, watertightness level, strength value, hygroscopic value, conductivity value, and solubility. Such usage of multi-resin types provides enhancing product functionality and enabling innovative solutions for complex challenges across industries, by supporting the production of 3D objects with complex geometries and localized properties, such as variable flexibility, conductivity, and strength within a single 3D object. Further, such scheme provides extensive customization, such as personalized aesthetics, and streamlines the manufacturing process by reducing the need for post-processing steps, thereby lowering production time and costs.

An example of in-process fabrication of an in-process cone 62 is formed by a resin liquid output from the top opening 16 is shown in a view 130a in FIG. 13a, and an example of a completed fabrication of the completed cone 65 is shown in a view 130b in FIG. 13b. The cone 65 may be made of the three resin types. In general, any layer formed, or any part thereof, may be formed by curing different type of the resin liquid from any one of the containers 25, 25a, or 25b. While three containers are exampled in the view 130 shown in FIG. 13, any other number of containers may be equally used, and each may store distinct or different resin liquid type, such as different color or different property (such as conductivity). For example, at least 2, 3, 4, 5, 7, 10, 12, 15, 20, 30, or 50 containers may be used. Alternatively or in addition, less than 3, 4, 5, 7, 10, 12, 15, 20, 30, 50, or 100 containers may be used.

The selector 131 may comprise, may consists of, or may be based on, any multi-port valve that allows fluids to be directed between multiple inlet/outlet ports. In one example, ball and plug valve types are used for such multiport design. In the example of the 3D printer 130, the selector 131 provides three inlet ports (for receiving resin fluids from the containers 25, 25a, and 25b), and direct one of the inlets to the outlet port to the pump 26 via the pipe or hose 132. Such selector that controls the direction and flow of fluids (liquids or gases) from the multiple inlet ports to the single outlet port may be referred to as a fluidic or hydraulic multiplexer.

Such multiplexer may selectively allow fluid from one or more of the input ports to be directed to an output port, based on an externally provided control signal, such as from the controller 24a, via the cable or connection 15f. This control is typically implemented by using a series of electronically operated valves or gates, which can be opened or closed to enable or obstruct the flow of fluid from specific input channels.

Any flow control component herein may be selected from various controlled flow components that are described in a 2023 product catalog by Elveflow headquartered in Paris, France, downloaded January 2024 from https://www.elveflow.com/wp-content/uploads/2023/02/ELVEFLOW_PRODUCT_CATALOG_2023.pdf, which is incorporated in its entirety for all purposes as if fully set forth herein. In one example, the selector 131 may comprises, or may be based on, a 12-way controlled valve “MUX DISTRIB—12-WAY BIDIRECTIONAL VALVE”′ available from Elveflow headquartered in Paris, France, and described in the 2023 product catalog downloaded January 2024 from https://www.elveflow.com/wp-content/uploads/2023/02/ELVEFLOW_PRODUCT_CATALOG_2023.pdf, which is incorporated in its entirety for all purposes as if fully set forth herein. This Sequential Injection Valve is a bidirectional 13-port/12 way with no cross contamination, and can control the sequential injection of one solution into twelve different lines or twelve solutions into one line, and provides typical mechanical response time for port-to-port movement of 156 ms, an easy setup of standard ¼-28 fluidic fittings, supports lowest internal volume of 3.5 μL with high chemical compatibility (wetted materials: PCTFE, PTFE), and further supports a possibility to choose the sense of rotation.

Alternatively or in addition, the selector 131 may use, may comprise, or may be based on, one or more valves, that are arranged and integrated to control the flow of fluids from the several input ports into the single output port. This arrangement allows for selective and controlled distribution of fluids based on specific requirements or commands. In one example, the selector 131 may use, may comprise, or may be based on, multiple electrically controlled valves (such as solenoid valves or motorized valves), each controlling the flow from one of the inlet ports, and pass the fluid from a selected inlet port/valve to the outlet port. An example for an electrically controlled solenoid valve is the D299DVL by Rotork Instruments, described in a datasheet “D299DVL valve” downloaded January 2024 from https://www.rotork.com/uploads/documents-versions/44544/1/pub124-003-00-0519.pdf which is incorporated in its entirety for all purposes as if fully set forth herein. Solenoid valves are described in a catalogue PUB124-003-00 issued May 2019 by Rotork Instruments Italy Srl headquartered in Italy, entitled: “Solenoid Valves”, which is incorporated in its entirety for all purposes as if fully set forth herein.

Alternatively or in addition, the selector 131 may use, may comprise, or may be based on, an electric rotary valve, such as a PG SwitchEZ™ Electric Rotary Valve available from PreciGenome LLC of San Jose, California, U.S.A., described in a manual entitled: “PG SwitchEZ™ Electric Rotary Valve Manual—Version 1.4” downloaded January 2024 from www.precigenome.com, which is hereby incorporated herein by reference in its entirety. The SwitchEZ™ rotary valve is an electric multi-channel selection/switching valve designed for automated fluidic/microfluidic applications. Fast, reliable geared switching ensures long life, while the valve heads provide leak-free connections to 1/32″, 1/16″, or smaller OD capillary tubing. SwitchEZ valves are constructed with PCTFE and sapphire crystal as wetted materials, suitable for use with a wide variety of chemicals, and features several design elements ensure high valve reliability and accuracy. The SwitchEZ valves are corrosion resistant and use Sapphire valve core and blended PCTFE/PPS valve head, have a spool structure of multi-directional self-adaptive plane fitting method, are controlled by RS232/RS485/CAN bus, and powered by a gear motor. The SwitchEZ valves provides optical encoder positioning, include two-phase bipolar stepper motor driver, and support fluidic interface of 1/4-28UNF female threads.

Any valve that is part of the selector 131 may be used to control, regulate, or direct flow of liquids, such as the resin fluid. Further any valve herein valve that is part of the selector 131 may be used for starting or stopping any flow based on the valve state, regulating flow and pressure within any piping system herein, controlling the direction of any flow herein, throttling flow rates within a piping system, may be used for improving safety through relieving pressure or vacuum in any piping system herein, or any combination thereof. Alternatively or in addition, any valve herein valve that is part of the selector 131 may be a manual valve, an actuated valve, an automatic vale, or any combination thereof. Alternatively or in addition, any valve herein valve that is part of the selector 131 may comprise, or may be based on, a ball valve, butterfly valve, check valve, gate valve, knife gate valve, globe valve, needle valve, pinch valve, plug valve, pressure relief valve, or any combination thereof. Alternatively or in addition, any valve herein valve that is part of the selector 131 may comprise, or may be based on, an electrically controlled valve, such as a solenoid valve or a motorized valve. Alternatively or in addition, any valve herein valve that is part of the selector 131 may comprise, or may be based on, a stopper type closure, a vertical slide, a rotary type, a flexible body, or any combination thereof.

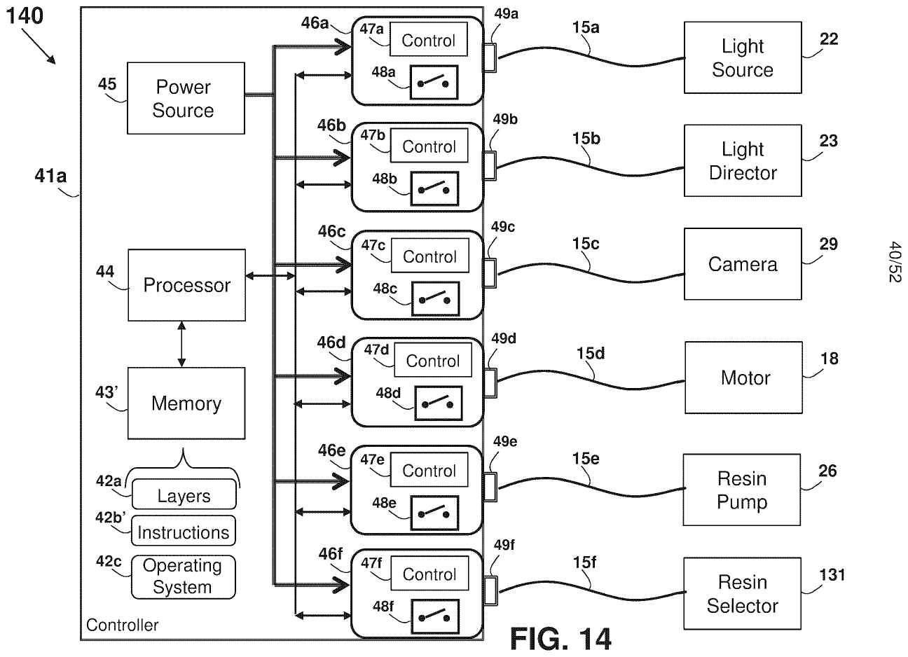

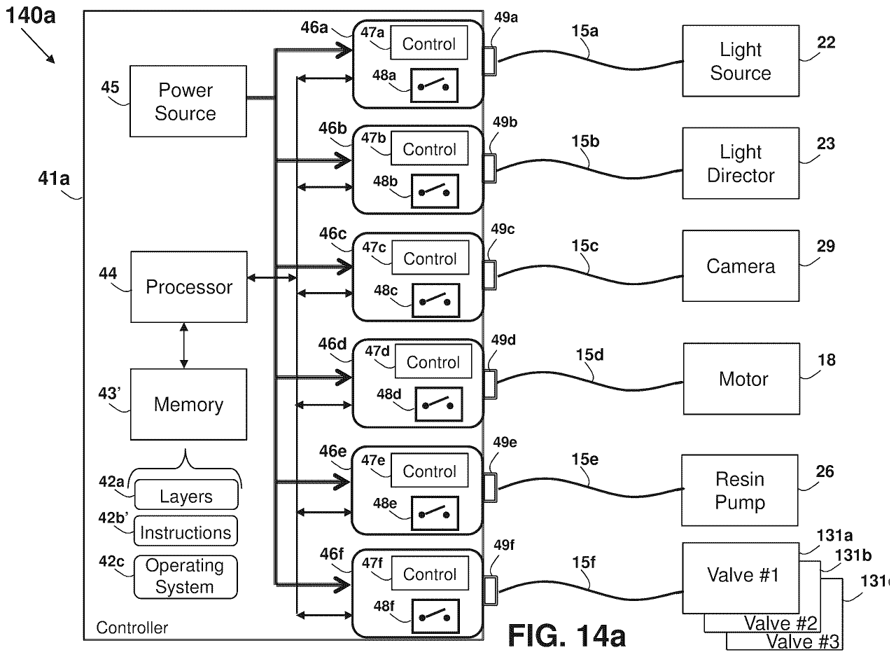

A schematic block diagram 140 of the power and control of the 3D printer 130 is shown in FIG. 14. A schematic block diagram 41a is based on the schematic block diagram 41 shown in FIG. 4, adapted to further control the selector 131, and may refer to the controller 24a of the 3D printer 130 shown in FIG. 13. The memory 43′ is based on the memory 43 shown as part of the controller 41, adapted to include instructions 42b′, that include the controlling functionality of the selector 131. The controller 41 connects to the resin selector 131 by the cable 15f via a connector 49f, the electric power may be switched from the power source 45 to the selector 131 using a controlled switch 48f that may be part of a selector interface 46f, and a control functionality 47f may be part of the interface 46f for controlling the resin selector 131.

In one example, the selector 131 may use, may be based on, or may be implemented using three valves, each controlling a different input from a respective resin fluid container. Preferably, each of these valves include a check valve or a check valve directionality functionality, to avoid contamination between the different resin types. For example, a valve #1 131a may be used to stop or pass resin fluid from the container 25 to the pump 26, a valve #2 131b may be used to stop or pass resin fluid from the container 25a to the pump 26, and a valve #3 131b may be used to stop or pass resin fluid from the container 25b to the pump 26. In such a scenario, the cable 15f may be used to carry power and control signals from the interface 46f to the three valves, as shown in a view 140a in FIG. 14a.

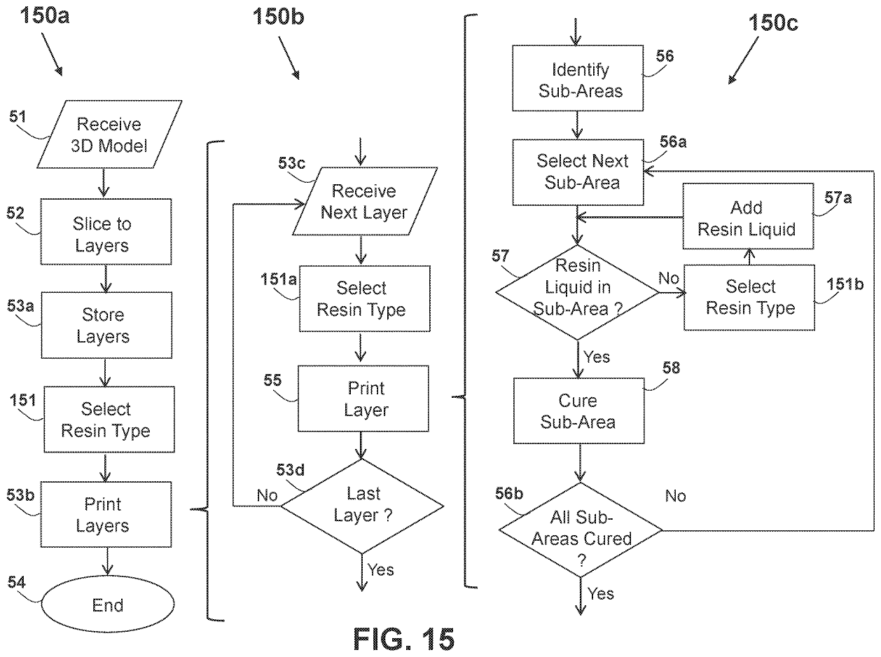

Examples of flow charts 150a, 150b, and 150c, are shown in FIG. 15, are based on the respective flow charts 50a, 50b, and 50c shown in FIG. 5, adapted for using multiple resin types, as exampled in the view 130 in FIG. 13, using the control system shown in the view 140 in FIG. 14. In one example, a different resin type may be selected for each 3D object printed, as shown in the flow-chart 150a shown in FIG. 15. Before starting the printing as part of the “Print Layers” step 53b, the required resin type to be used, such as defined in the 3D model identified in the “Receive 3D Model” step 51, is selected as part of a “Select Resin Type” step 151. For example, the resin type stored in the resin fluid container 25a shown in the view 130 may be selected, and the processor 44 of the controller 41a (that may implement the controller device 24a), instruct the selector 131, by using the interface 46f that controls the selector 131 via the cable 15f connected to the connector 49f, to pass only the resin fluid from the container 25a to the pump 26. In one example, only the valve #2 131b that is coupled to the container 25a is powered or controlled to pass the resin liquid via the cable 15f shown in the arrangement 140a in FIG. 14a, while the valve #1 131a and the valve #3 131c are controlled to stop any resin liquid flow therethrough.

Alternatively or in addition, a different resin type may be layer-based selected, such as for each layer of the 3D object printed, as shown in the flow-chart 150b shown in FIG. 15. Before starting the printing of a layer as part of the “Print Layer” step 55, such as defined in the layer identified as part of the “Receive Next Layer” step 53c, the required resin type to be used is selected as part of a “Select Resin Type” step 151a. For example, when printing one layer as part of the “Print Layer” step 55, the resin type stored in the resin fluid container 25a shown in the view 130 may be selected, and the processor 44 of the controller 41a (that may implement the controller device 24a), instruct the selector 131, by using the interface 46f that controls the selector 131 via the cable 15f connected to the connector 49f, to pass only the resin fluid from the container 25a to the pump 26. In one example, only the valve #2 131b that is coupled to the container 25a is powered or controlled to pass the resin liquid via the cable 15f shown in the arrangement 140a in FIG. 14a, while the valve #1 131a and the valve #3 131c are controlled to stop any resin liquid flow therethrough. When a next layer is printed as part of the “Print Layer” step 55, the resin type stored in the resin fluid container 25a shown in the view 130 may be selected, and the processor 44 of the controller 41a (that may implement the controller device 24a), instruct the selector 131, by using the interface 46f that controls the selector 131 via the cable 15f connected to the connector 49f, to pass only the resin fluid from the container 25b to the pump 26. In one example, only the valve #2 131b that is coupled to the container 25a is powered or controlled to pass the resin liquid via the cable 15f shown in the arrangement 140a in FIG. 14a, while the valve #1 131a and the valve #3 131c are controlled to stop any resin liquid flow therethrough.

Alternatively or in addition, a different resin type may be sub-area-based selected, such as for each sub-area (or multiple sub-areas) of the 3D object printed, as shown in the flow-chart 150c shown in FIG. 15. Before starting the printing of a sub-area as part of the “Cure Sub-Area” step 58, such as defined in the sub-area identified as part of the “Identify Sub-Areas” step 56, additional resin liquid may be added as part of the “Add Resin Liquid” step 57a. The required resin type to be added and used is selected as part of a “Select Resin Type” step 151b. For example, when printing one sub-area as part of the “Cure Sub-Area” step 58, the resin type stored in the resin fluid container 25a shown in the view 130 may be selected, and the processor 44 of the controller 41a (that may implement the controller device 24a), instruct the selector 131, by using the interface 46f that controls the selector 131 via the cable 15f connected to the connector 49f, to pass only the resin fluid from the container 25a to the pump 26. In one example, only the valve #2 131b that is coupled to the container 25a is powered or controlled to pass the resin liquid via the cable 15f shown in the arrangement 140a in FIG. 14a, while the valve #1 131a and the valve #3 131c are controlled to stop any resin liquid flow therethrough. When a next sub-area is printed as part of the “Cure Sub-Area” step 58, the resin type stored in the resin fluid container 25a shown in the view 130 may be selected, and the processor 44 of the controller 41a (that may implement the controller device 24a), instruct the selector 131, by using the interface 46f that controls the selector 131 via the cable 15f connected to the connector 49f, to pass only the resin fluid from the container 25b to the pump 26. In one example, only the valve #2 131b that is coupled to the container 25a is powered or controlled to pass the resin liquid via the cable 15f shown in the arrangement 140a in FIG. 14a, while the valve #1 131a and the valve #3 131c are controlled to stop any resin liquid flow therethrough.

A single container 25 that store a single type of a resin liquid is shown as part of the 3D printer 20 in FIG. 2. In one example, multiple containers may be used, each storing a different type of resin liquid, allowing for printing using the different types of the resin liquid. For example, different resin colors may be used, enabling printing of a multicolor 3D objects. In another example, one of the resin types may be conductive type, allowing for printing of conductive paths in a 3D object. Using multiple containers 25, 25a, and 25b is shown in an arrangement 130 in FIG. 13, that comprises a first type of a resin liquid in a first resin liquid container 25 mounted on a pole 14, a second type of a resin liquid in a second resin liquid container 25a mounted on a pole 14a, and a third type of a resin liquid in a third resin liquid container 25b mounted on a pole 14b.

An example of such multiple-openings platform 28a is shown in a view 110 in FIG. 11. While a single bottom is used, three cavities are used, split at the bottom opening or inside the platform 28a. A first cavity 113a ends at a first top opening 16a, a second cavity 113b ends at a second top opening 16b, and a third cavity 113c ends at a third top opening 16c. The pump 26 pushes the resin liquid via the pipe 27b to the bottom opening, so that the resin liquid is output and spread concurrently from the three top openings 16a, 16b, and 16c, to be then cured as described herein. An example of a 3D printer 110a that uses such a three-openings platform 28a is shown in FIG. 11a. In one example, the multiple-openings platform 28a may be used in conjunction with multiple containers 25, 25a, and 25b. In one example, multiple containers may be used, each storing a different type of resin liquid, allowing for printing using the different types of the resin liquid. In another example, one of the resin types may be conductive type, allowing for printing of conductive paths in a 3D object. Multiple 3D objects may thus be formed sequentially or concurrently, each by curing a different resin liquid from one of the multiple containers.

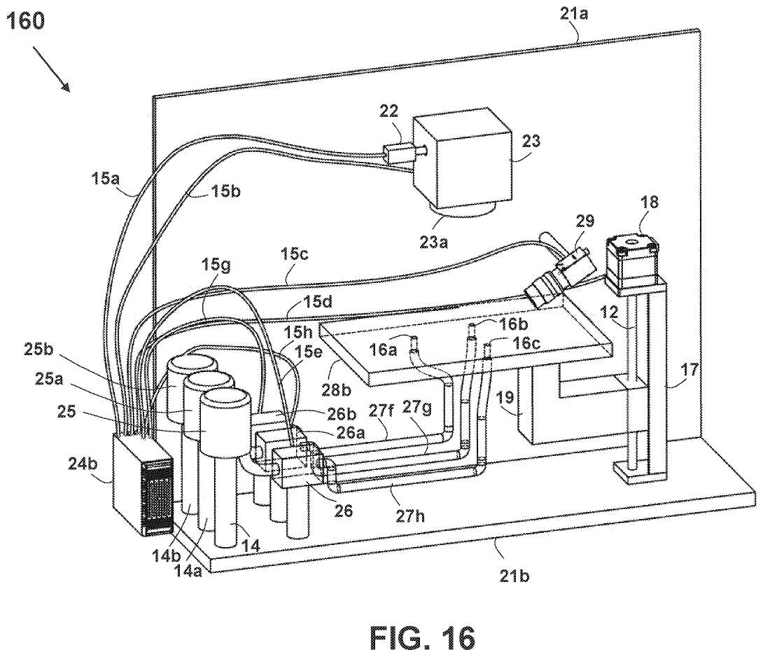

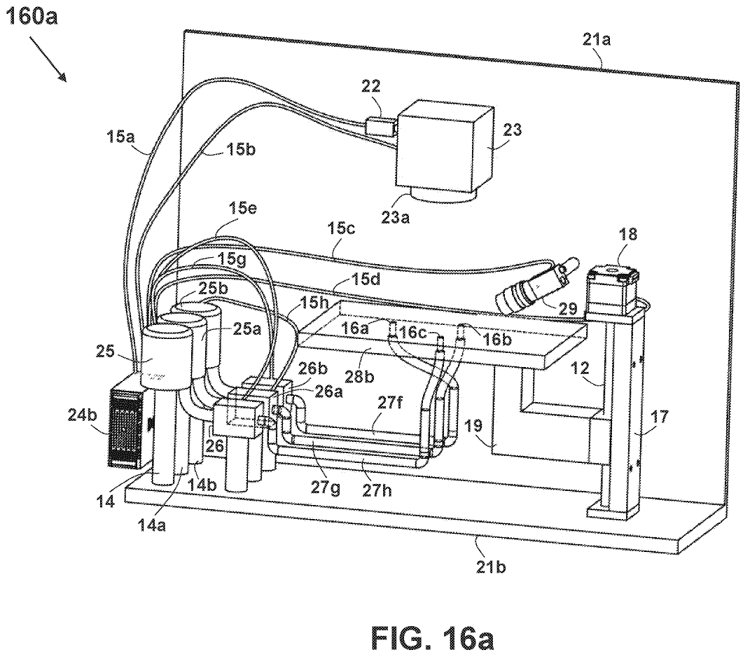

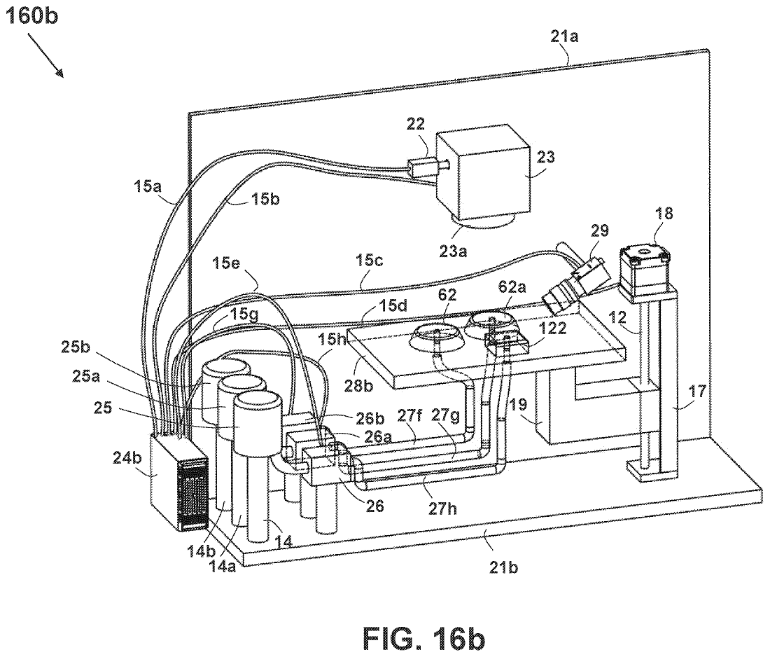

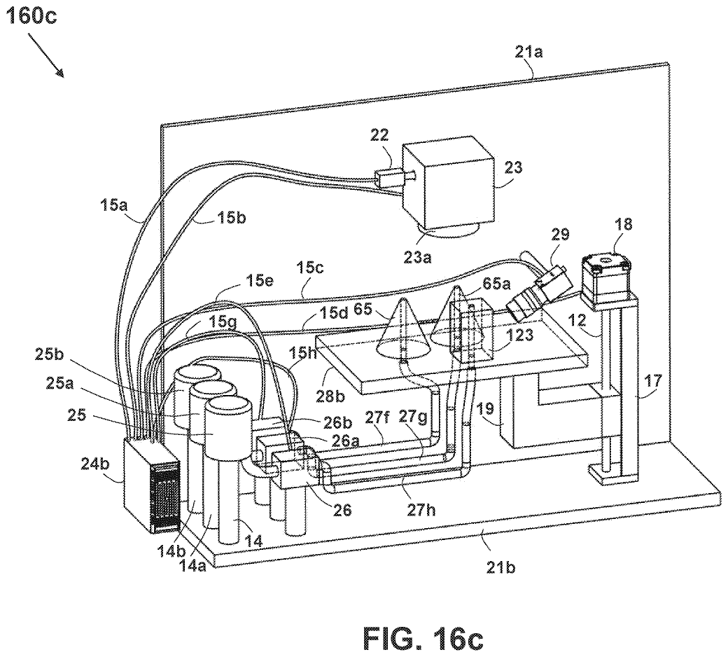

An example of a view of a multi-resin and multiple openings 3D printer 160 is shown in FIG. 16, and a different perspective view 160a in shown in FIG. 16a. The first resin liquid container 25 may store a first type of a resin liquid, and feeds this resin liquid via the pump 26 (controlled by a controller 24b via a cable or connection 15e) and a pipe 27h to the top opening 16c, allowing for forming a first 3D object thereon. The second resin liquid container 25a may store a second type of a resin liquid (that may be identical to, similar to, or different from, the resin liquid stored in the first container 25), and feeds this resin liquid via the pump 26a (controlled by a controller 24b via a cable or connection 15h) and a pipe 27g to the top opening 16b, allowing for forming a first 3D object thereon. Similarly, the third resin liquid container 25b may store a third type of a resin liquid (that may be identical to, similar to, or different from, the resin liquid stored in the first container 25 or in the second container 25a), and feeds this resin liquid via the pump 26b (controlled by a controller 24b via a cable or connection 15g) and a pipe 27f to the top opening 16a, allowing for forming a first 3D object thereon. Using multiple cavities as exampled in FIGS. 12-12b, using multiple resin liquid types as exampled in FIGS. 13-13b, using multiple pumps as exampled in FIGS. 16-16c, or any combination thereof, facilitates sequential printing by addressing productivity challenges by providing one-at-a-time printing, which may be particularly useful in scenarios where the light beam energy is limited. Moreover, such structure simplifies the fabrication of complex, multi-material, single-body objects, and further supports creating structures with soluble materials for bridging, embedding conductors within non-conducting matrices, or achieving more intricate aesthetic designs, thereby expanding the scope and efficiency of multi-material 3D printing.

An example of in-process fabrication of separated three 3D objects using the multiple separated cavities platform 28b is shown in a view 160b in FIG. 16b, where a first in-process cone 62 is formed by a resin liquid output from the top opening 16a (via the cavity 32a), a second in-process cone 62a is formed by a resin liquid output from the top opening 16b (via the cavity 32b), and an in-process rectangular cuboid 122 is formed by a resin liquid output from the top opening 16c (via the cavity 32c). An example of a completed fabrication of the separated three 3D objects that are shown in-process in the view 160b, is shown in a view 160c in FIG. 16c, depicting the first completed cone 65, the second completed cone 65a, and the completed rectangular cuboid 123.

While three resin liquid containers and three top openings in the platform 28b are exampled in the view 160 shown in FIG. 16, any other number of containers and respective openings may be equally used, and each may store distinct or different resin liquid type, such as different color or different property (such as conductivity). For example, at least 2, 3, 4, 5, 7, 10, 12, 15, 20, 30, or 50 containers may be used. Alternatively or in addition, less than 3, 4, 5, 7, 10, 12, 15, 20, 30, 50, or 100 containers may be used. While the 3D printer is exampled in the view 160c in FIG. 16c as forming three separated and independent 3D object, the multiple openings and the multiple containers (aided with the respective multiple pumps) may be used to form a single 3D object, such as the triangular shaped 3D object 114 shown in the view 110d in FIG. 11d.

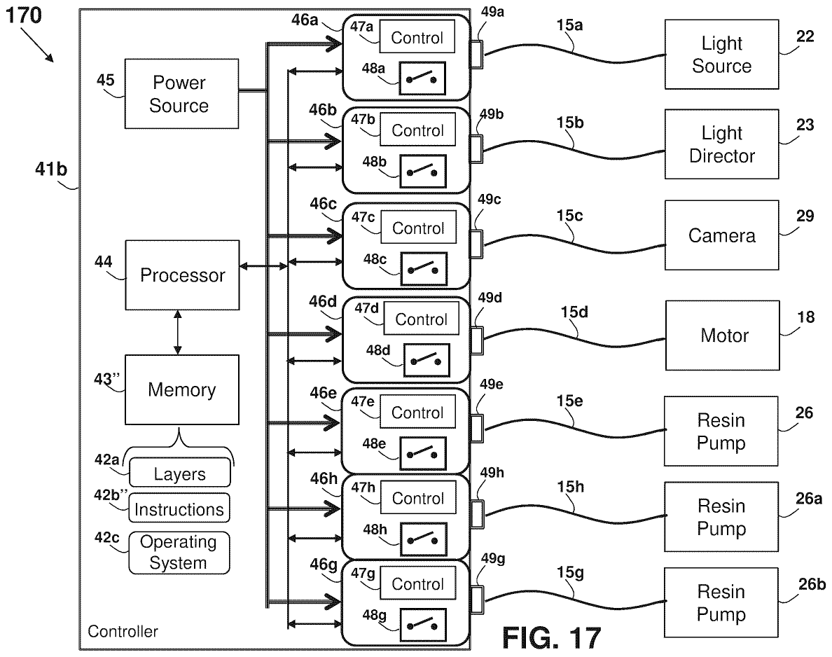

A schematic block diagram 170 of the power and control of the 3D printer 160 is shown in FIG. 17. A schematic block diagram 41b is based on the schematic block diagram 41 shown in FIG. 4, adapted to further control the three pumps 26, 26a, and 26b, and may refer to the controller 24b of the 3D printer 160 shown in FIG. 16. The memory 43″ is based on the memory 43 shown as part of the controller 41, adapted to include instructions 42b″, that include the controlling functionality of the added two pumps 26a and 26b.

Similar to the controller 41, the controller 41b connects to the resin pump 26 by the cable 15e via the connector 49e, the electric power may be switched from the power source 45 to the pump 26 using a controlled switch 48e that may be part of the pump interface 46e, and a control functionality 47e may be part of the interface 46e for controlling the resin pump 26. The controller 41b connects to the additional resin pump 26a by the cable 15h via a connector 49h, the electric power may be switched from the power source 45 to the pump 26a using a controlled switch 48h that may be part of the pump interface 46h, and a control functionality 47h may be part of the interface 46h for controlling the resin pump 26a. Similarly, the controller 41b connects to the additional resin pump 26b by the cable 15g via a connector 49g, the electric power may be switched from the power source 45 to the pump 26b using a controlled switch 48g that may be part of the pump interface 46g, and a control functionality 47g may be part of the interface 46g for controlling the resin pump 26b.

In addition to the flexibility of using different types of resin liquids, the arrangement 160 in FIG. 16, the multiple openings may allow for fabrication of multiple 3D objects, each on a respective opening, thus allowing concurrent forming of the multiple 3D objects. Further, the multiple opening may be used to form one wide 3D object, by concurrently printing separated parts of this wide 3D object, which are then joined into a single wide 3D object.

In one example, the 3D objects formed by the 3D printer 160 shown in FIG. 16, such as the separated three 3D objects that are shown in the view 160c in FIG. 16c that depicts the first completed cone 65, the second completed cone 65a, and the completed rectangular cuboid 123, are produced sequentially, such as one after the other, where only one 3D object is being formed at a time. In such a case, the producing flow chart 50a shown in FIG. 5 (that includes the layer forming flow chart 50b and the sub-areas forming flow chart 50c), is repeated for each of the objects produced, where the relevant pump is controlled at a time as part of the “Add Resin Liquid” step 57a.

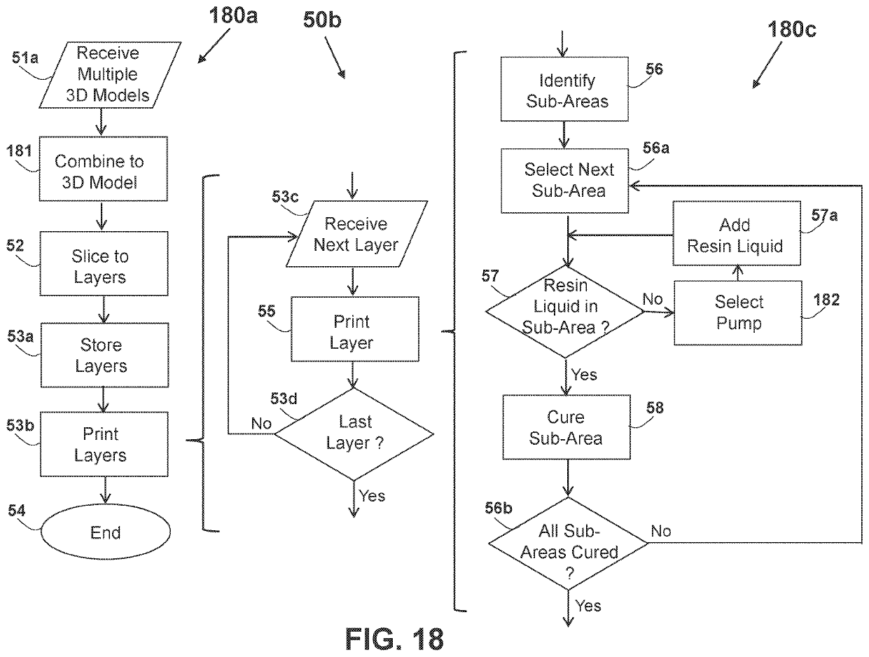

Alternatively or in addition, the 3D objects are formed in parallel, such as printing the layers one at a time for each of the 3D objects. For example, the first layer will be formed for each of the 3D objects, followed by a second layer in each of the 3D objects, and so on. Examples of such flow charts 180a, 50b, and 180c, are shown in FIG. 18, are based on the respective flow charts 50a, 50b, and 50c shown in FIG. 5, adapted for using multiple resin types fed via multiple openings, as exampled in the view 160 in FIG. 16, using the control system shown in the view 170 in FIG. 17.

As part of a “Receive Multiple 3D Models” step 51a that starts the flow chart 180a, the 3D models of all the multiple 3D objects to be formed are obtained, similar to the single 3D model obtained as part of the “Receive 3D Model” step 51 in the flow chart 50a in FIG. 5. In the example of three 3D objects, such as shown in the view 160c in FIG. 16c, the 3D models of the cone 65, the second cone 65a, and the completed rectangular cuboid 123 are obtained as part of the “Receive Multiple 3D Models” step 51a. As part of a “Combine to 3D Model” step 181, the multiple 3D objects are combined into a single 3D model, that comprises the multiple objects side-by-side according to the locations of the top openings on the platform 28b, thus the system refers to a single 3D model (that includes the multiple separated objects that are received as part of the “Receive Multiple 3D Models” step 51a. The flow chart 50c is adapted as a flow chart 180c to use multiple pumps. When resin liquid is to be added, as determined in the “Resin Liquid in Sub-Area?” step 57, one of the pumps, that is associated with the relevant sub-area, is selected as part of a “Select Pump” step 182. In the example of the arrangement 160c shown in FIG. 16c, the pump 26b is selected when curing sub-areas that are part of the forming of the cone 65, such as by activating the pump 26b by the controller 41b via the cable or connection 15g and the associated pump interface 46g. Similarly, the pump 26 is selected when curing sub-areas that are part of the forming of the cube 123, such as by activating the pump 26 by the controller 41b via the cable or connection 15e and the associated pump interface 46e.

Using multiple separated cavities or using multiple separated top openings is exampled in the 3D printer 120 shown in FIG. 12, which examples a platform 28b having three separated cavities 32a, 32b, and 32c, respectively having top openings 16a, 16b, and 16c, and fed by three separated respective resin liquid pipes 27c, 27d, and 27e. Such separately fed multiple top openings 16a, 16b, and 16c provides improved productivity by forming three separated 3D objects (sequentially or in parallel), such as the cones 65 and 65a, and the box-shaped object 123 shown in the arrangement 120b in FIG. 12b. Alternatively or in addition, such structure may be used to form a single larger 3D object, such as the triangle shaped object 114 shown in the view 110f in FIG. 11d.

Using multiple containers, that may store different, similar, or different types of resin liquids is exampled in the 3D printer 130 shown in FIG. 13, which examples the use of three resin liquid containers 25, 25a, and 25b. In the arrangement 130 in FIG. 13, a resin selector 131 is used for selecting a specific resin type by selecting a specific resin liquid container to pass therethrough. Alternatively or in addition, a specific resin type may be selected by using multiple pumps, each connected to pass (or stop) resin liquid from a specific resin container, similar to the arrangement 160 shown in FIG. 16. The first resin liquid container 25 may store a first type of a resin liquid, and feeds this resin liquid via the pump 26 (controlled by a controller 24b via a cable or connection 15e) and a pipe 27j. The second resin liquid container 25a may store a second type of a resin liquid (that may be identical to, similar to, or different from, the resin liquid stored in the first container 25), and feeds this resin liquid via the pump 26a (controlled by a controller 24b via a cable or connection 15h) and a pipe 27b. Similarly, the third resin liquid container 25b may store a third type of a resin liquid (that may be identical to, similar to, or different from, the resin liquid stored in the first container 25 or in the second container 25a), and feeds this resin liquid via the pump 26b (controlled by a controller 24b via a cable or connection 15g) and a pipe 27i. The control system 170 shown in FIG. 17 may be used to control the three pumps, allowing one pump at a time to pass the resin liquid from a respective container towards the platform 28b. In one example, employing multiple pumps as opposed to a single pump equipped with a selector, offers distinct advantages in contexts where contamination prevention is paramount. Such a scheme mitigates the risk of cross-contamination between materials, which may be crucial in applications requiring high purity levels.

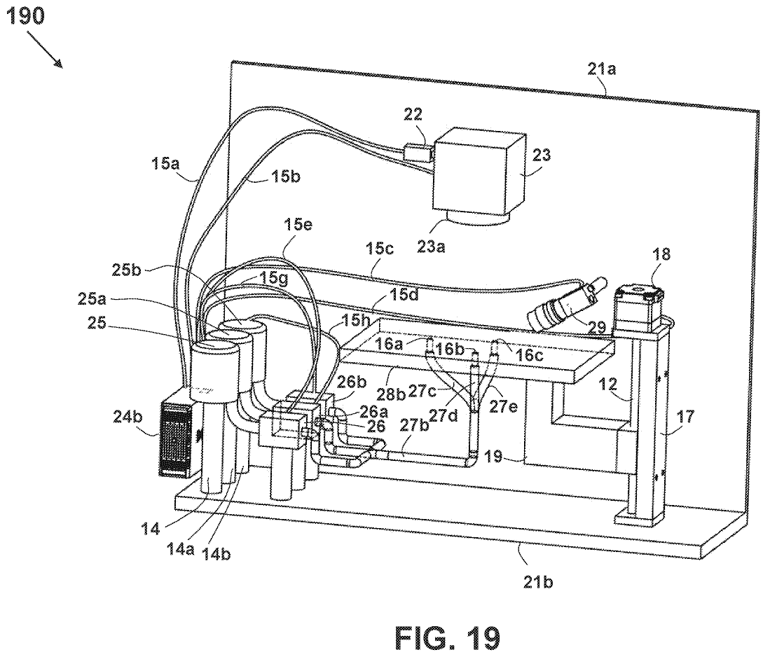

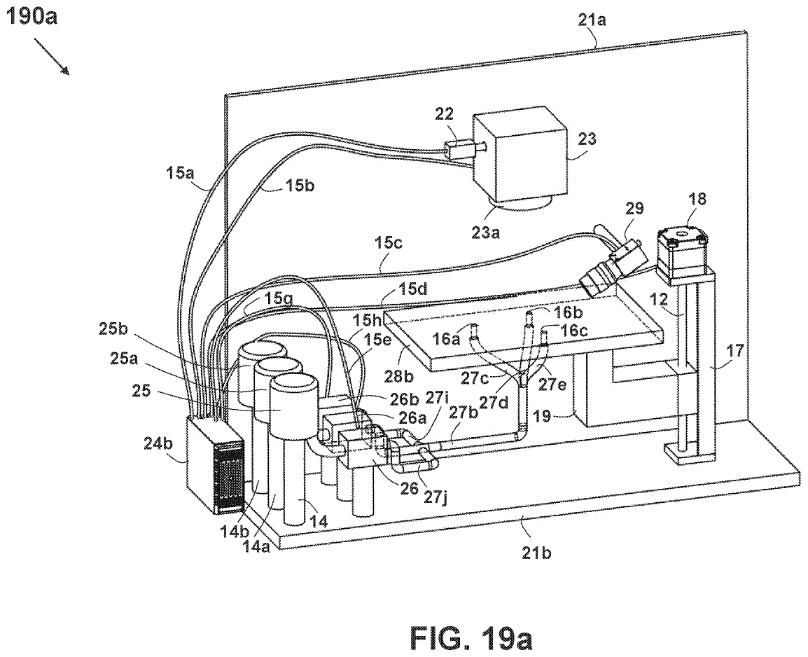

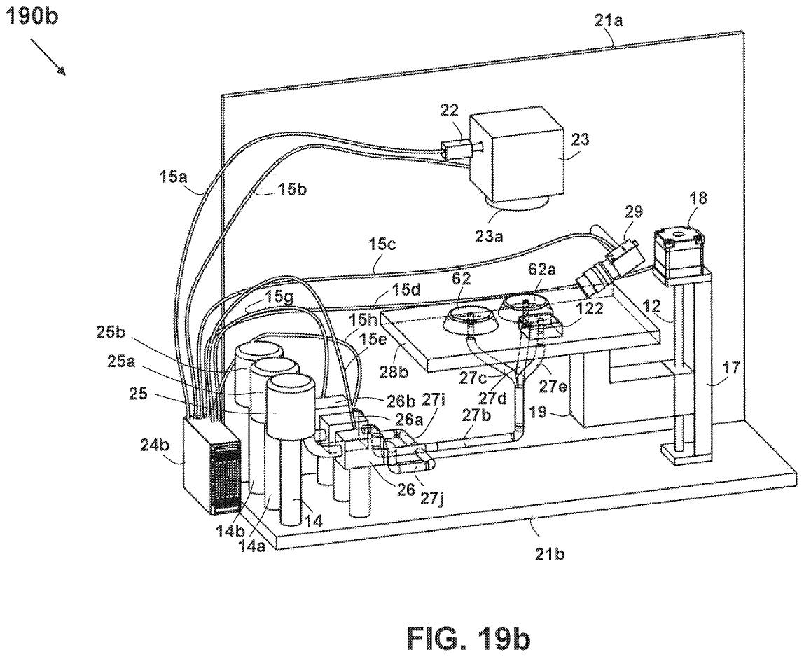

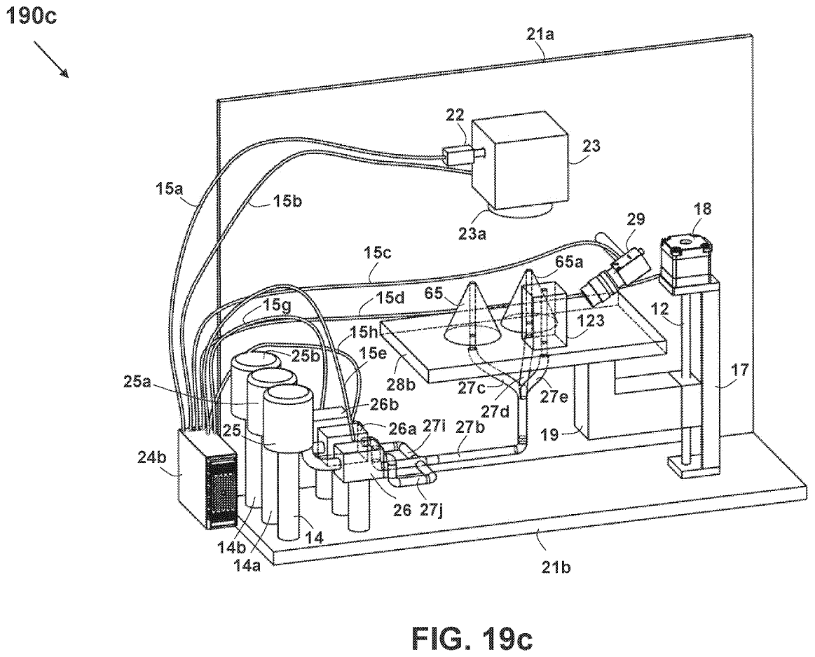

An example of a view of a multi-resin types and multiple openings fed via a single pipe 3D printer 190 is shown in FIG. 19, and a different perspective view 190a in shown in FIG. 19a, using three pumps 26, 26a, and 26b that may provide resin liquids from the respective containers 25, 25a, and 25b. The three pumps 26, 26a, and 26b are exampled in the arrangement 160 as providing resin liquids from the respective containers 25, 25a, and 25b, to the respective top openings 16c, 16b, and 16a, via respective separated pipes 27h, 27g, and 27f. Unlike the arrangement 160 shown in FIG. 16, the 3D printer 190 examples combining the output pipe 27j from the pipe 26, the output pipe 27i from the pump 26b, with the output pipe 27b from the pump 26a, so that a single pipe 27b passes the resin liquid from any of the resin liquid containers to the platform 28b, to be concurrently output from the three top openings 16a, 16b, and 16c.

An example of in-process fabrication of separated three 3D objects using the multiple separated cavities platform 28b is shown in a view 190b in FIG. 19b, where a first in-process cone 62 is formed by a resin liquid output from the top opening 16a (via the cavity 32a), a second in-process cone 62a is formed by a resin liquid output from the top opening 16b (via the cavity 32b), and an in-process rectangular cuboid 122 is formed by a resin liquid output from the top opening 16c (via the cavity 32c). An example of a completed fabrication of the separated three 3D objects that are shown in-process in the view 190c, is shown in a view 190c in FIG. 19c, depicting the first completed cone 65, the second completed cone 65a, and the completed rectangular cuboid 123.

Any light source, light reflector, laser source, or photodiode herein, such as the light source 22 (or ant part thereof), may comprise, may be based on, or may use, any of the components and devices described in U.S. Pat. No. 11,255,663 to Binder entitled: “Method and apparatus for cooperative usage of multiple distance meters”, which is incorporated in its entirety for all purposes as if fully set forth herein.

Any sensor herein, that includes any component or device herein that provides an electrical output signal (such as voltage or current), or changing a characteristic (such as resistance or impedance) in response to a measured or detected physical phenomenon, such as the image sensor 29, may comprise, may be based on, or may use, any of the respective sensors and actuators described in U.S. Pat. No. 11,240,311 to Binder entitled: “System and method for server based control”, which is incorporated in its entirety for all purposes as if fully set forth herein. Any sensors herein may be identical, similar or different from each other, and may measure or detect the same or different phenomena. Two or more sensors may be connected in series or in parallel. In the case of a changing characteristic sensor or in the case of an active sensor, the unit may include an excitation or measuring circuits (such as a bridge) to generate the sensor electrical signal. Any sensor output signal may be conditioned by a signal conditioning circuit. The signal conditioner may involve time, frequency, or magnitude related manipulations. The signal conditioner may be linear or non-linear, and may include an operation or an instrument amplifier, a multiplexer, a frequency converter, a frequency-to-voltage converter, a voltage-to-frequency converter, a current-to-voltage converter, a current loop converter, a charge converter, an attenuator, a sample-and-hold circuit, a peak-detector, a voltage or current limiter, a delay line or circuit, a level translator, a galvanic isolator, an impedance transformer, a linearization circuit, a calibrator, a passive or active (or adaptive) filter, an integrator, a deviator, an equalizer, a spectrum analyzer, a compressor or a de-compressor, a coder (or decoder), a modulator (or demodulator), a pattern recognizer, a smoother, a noise remover, an average or RMS circuit, or any combination thereof. In the case of analog sensor, an analog to digital (A/D) converter may be used to convert the conditioned sensor output signal to a digital sensor data. The unit may include a computer for controlling and managing the unit operation, processing the digital sensor data and handling the unit communication. The unit may include a modem or transceiver coupled to a network port (such as a connector or antenna), for interfacing and communicating over a network.

Any actuator herein, that includes any component or device herein that affects or generates a physical phenomenon in response to an electrical command, which can be an electrical signal (such as voltage or current), or by changing a characteristic (such as resistance or impedance) of a device, such as the light source 22, the light director 23, the motor 18, the linear actuator 17, or the pump 26, may comprise, may be based on, or may use, any of the respective sensors and actuators described in U.S. Pat. No. 11,240,311 to Binder entitled: “System and method for server based control”, which is incorporated in its entirety for all purposes as if fully set forth herein. Any actuators herein may be identical, similar or different from each other, and may affect or generate the same or different phenomena. Any two or more actuators may be connected in series or in parallel. Any actuator command signal may be conditioned by a signal conditioning circuit. Any signal conditioner may involve time, frequency, or magnitude related manipulations, and may be linear or non-linear, and may include an amplifier, a voltage or current limiter, an attenuator, a delay line or circuit, a level translator, a galvanic isolator, an impedance transformer, a linearization circuit, a calibrator, a passive or active (or adaptive) filter, an integrator, a deviator, an equalizer, a spectrum analyzer, a compressor or a de-compressor, a coder (or decoder), a modulator (or demodulator), a pattern recognizer, a smoother, a noise remover, an average or RMS circuit, or any combination thereof. In the case of analog actuator, a Digital-to-Analog (D/A) converter may be used to convert the digital command data to analog signals for controlling the actuators.

Any mechanical attachment of joining two parts herein refers to attaching the parts with sufficient rigidity to prevent unwanted movement between the attached parts. Any type of fastening means may be used for the attachments, including chemical material such as an adhesive or a glue, or mechanical means such as screw or bolt. An adhesive (used interchangeably with glue, cement, mucilage, or paste) is any substance applied to one surface, or both surfaces, of two separate items that binds them together and resists their separation. Adhesive materials may be reactive and non-reactive adhesives, which refers to whether the adhesive chemically reacts in order to harden, and their raw stock may be of natural or synthetic origin.

Any valve herein may be used to control, regulate, or direct flow of liquids, such as the resin fluid. Further any valve herein may be used for starting or stopping any flow based on the valve state, regulating flow and pressure within any piping system herein, controlling the direction of any flow herein, throttling flow rates within a piping system, may be used for improving safety through relieving pressure or vacuum in any piping system herein, or any combination thereof. Alternatively or in addition, any valve herein may be a manual valve, an actuated valve, an automatic vale, or any combination thereof. Alternatively or in addition, any valve herein may comprise, or may be based on, a ball valve, butterfly valve, check valve, gate valve, knife gate valve, globe valve, needle valve, pinch valve, plug valve, pressure relief valve, or any combination thereof. Alternatively or in addition, any valve herein may comprise, or may be based on, an electrically controlled valve, such as a solenoid valve or a motorized valve. Alternatively or in addition, any valve herein may comprise, or may be based on, a stopper type closure, a vertical slide, a rotary type, a flexible body, or any combination thereof.

Any image processing functions herein may include adjusting color balance, gamma and luminance, filtering pattern noise, filtering noise using Wiener filter, changing zoom factors, recropping, applying enhancement filters, applying smoothing filters, applying subject-dependent filters, and applying coordinate transformations. Other enhancements in the image data may include applying mathematical algorithms to generate greater pixel density or adjusting color balance, contrast, and/or luminance. Further, any video or image processing may use, or be based on, the algorithms and techniques disclosed in the book entitled: “Handbook of Image & Video Processing”, edited by Al Bovik, by Academic Press, ISBN: 0-12-119790-5, which is incorporated in its entirety for all purposes as if fully set forth herein.

The steps described herein may be sequential, and performed in the described order. For example, in a case where a step is performed in response to another step, or upon completion of another step, the steps are executed one after the other. However, in case where two or more steps are not explicitly described as being sequentially executed, these steps may be executed in any order or may be simultaneously performed. Two or more steps may be executed by two different network elements, or in the same network element, and may be executed in parallel using multiprocessing or multitasking.

A ‘nominal’ value herein refers to a designed, expected, or target value. In practice, a real or actual value is used, obtained, or exists, which varies within a tolerance from the nominal value, typically without significantly affecting functioning. Common tolerances are 20%, 15%, 10%, 5%, or 1% around the nominal value.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Throughout the description and claims of this specification, the word “couple”, and variations of that word such as “coupling”, “coupled”, and “couplable”, refers to an electrical connection (such as a copper wire or soldered connection), a logical connection (such as through logical devices of a semiconductor device), a virtual connection (such as through randomly assigned memory locations of a memory device) or any other suitable direct or indirect connections (including combination or series of connections), for example for allowing the transfer of power, signal, or data, as well as connections formed through intervening devices or elements.

Unless otherwise dictated by the context or specifically disclosed in the text, any of the steps, functions, operations, or processes herein, such as any of the steps in any of the flow-charts herein, is performed automatically, typically by a processor under software or firmware control, in the respective device, without any intervention by a human operator or user. Further, any shifting between states, steps, functions, operations, or processes herein, such as shifting between any of the steps in any of the flow-charts herein, is performed automatically, typically by a processor under software or firmware control in the respective device, without any intervention by a human operator or user.

The arrangements and methods described herein may be implemented using hardware, software or a combination of both. The term “integration” or “software integration” or any other reference to the integration of two programs or processes herein refers to software components (e.g., programs, modules, functions, processes etc.) that are (directly or via another component) combined, working or functioning together or form a whole, commonly for sharing a common purpose or a set of objectives. Such software integration can take the form of sharing the same program code, exchanging data, being managed by the same manager program, executed by the same processor, stored on the same medium, sharing the same GUI or other user interface, sharing peripheral hardware (such as a monitor, printer, keyboard and memory), sharing data or a database, or being part of a single package. The term “integration” or “hardware integration” or integration of hardware components herein refers to hardware components that are (directly or via another component) combined, working or functioning together or form a whole, commonly for sharing a common purpose or set of objectives. Such hardware integration can take the form of sharing the same power source (or power supply) or sharing other resources, exchanging data or control (e.g., by communicating), being managed by the same manager, physically connected or attached, sharing peripheral hardware connection (such as a monitor, printer, keyboard and memory), being part of a single package or mounted in a single enclosure (or any other physical collocating), sharing a communication port, or used or controlled with the same software or hardware. The term “integration” herein refers (as applicable) to a software integration, a hardware integration, or any combination thereof.

The term “port” refers to a place of access to a device, electrical circuit or network, where energy or signal may be supplied or withdrawn. The term “interface” herein refers to a physical interface or a logical interface (e.g., a portion of a physical interface or sometimes referred to in the industry as a sub-interface-for example, such as, but not limited to a particular VLAN associated with a network interface) allowing for proper electrical connecting of two components or devices, including any electrical circuitry for exchanging electrical power or signals therebetween. As used herein, the term “independent” relating to two (or more) elements, processes, or functionalities, refers to a scenario where one does not affect nor preclude the other. For example, independent communication such as over a pair of independent data routes means that communication over one data route does not affect nor preclude the communication over the other data routes.

The term “processor” is meant to include any integrated circuit or other electronic device (or collection of devices) capable of performing an operation on at least one instruction including, without limitation, Reduced Instruction Set Core (RISC) processors, CISC microprocessors, Microcontroller Units (MCUs), CISC-based Central Processing Units (CPUs), and Digital Signal Processors (DSPs). The hardware of such devices may be integrated onto a single substrate (e.g., silicon “die”), or distributed among two or more substrates. Furthermore, various functional aspects of the processor may be implemented solely as software or firmware associated with the processor.

A non-limiting example of a processor may be 80186 or 80188 available from Intel Corporation located at Santa-Clara, California, USA. The 80186 and its detailed memory connections are described in the manual “80186/80188 High-Integration 16-Bit Microprocessors” by Intel Corporation, which is incorporated in its entirety for all purposes as if fully set forth herein. Other non-limiting example of a processor may be MC68360 available from Motorola Inc. located at Schaumburg, Illinois, USA. The MC68360 and its detailed memory connections are described in the manual “MC68360 Quad Integrated Communications Controller—User's Manual” by Motorola, Inc., which is incorporated in its entirety for all purposes as if fully set forth herein. While exampled above regarding an address bus having an 8-bit width, other widths of address buses are commonly used, such as the 16-bit, 32-bit and 64-bit. Similarly, while exampled above regarding a data bus having an 8-bit width, other widths of data buses are commonly used, such as 16-bit, 32-bit and 64-bit width. In one example, the processor consists of, comprises, or is part of, Tiva™ TM4C123GH6PM Microcontroller available from Texas Instruments Incorporated (Headquartered in Dallas, Texas, U.S.A.), described in a data sheet published 2015 by Texas Instruments Incorporated [DS-TM4C123GH6PM-15842.2741, SPMS376E, Revision 15842.2741 June 2014], entitled: “Tiva™ TM4C123GH6PM Microcontroller—Data Sheet”, which is incorporated in its entirety for all purposes as if fully set forth herein, and is part of Texas Instrument's Tiva™ C Series microcontrollers family that provide designers a high-performance ARM® Cortex™-M-based architecture with a broad set of integration capabilities and a strong ecosystem of software and development tools. Targeting performance and flexibility, the Tiva™ C Series architecture offers an 80 MHz Cortex-M with FPU, a variety of integrated memories and multiple programmable GPIO. Tiva™ C Series devices offer consumers compelling cost-effective solutions by integrating application-specific peripherals and providing a comprehensive library of software tools which minimize board costs and design-cycle time. Offering quicker time-to-market and cost savings, the Tiva™ C Series microcontrollers are the leading choice in high-performance 32-bit applications. Targeting performance and flexibility, the Tiva™ C Series architecture offers an 80 MHz Cortex-M with FPU, a variety of integrated memories and multiple programmable GPIO. Tiva™ C Series devices offer consumers compelling cost-effective solutions.

The terms “memory” and “storage” are used interchangeably herein and refer to any physical component that can retain or store information (that can be later retrieved) such as digital data on a temporary or permanent basis, typically for use in a computer or other digital electronic device. A memory can store computer programs or any other sequence of computer readable instructions, or data, such as files, text, numbers, audio and video, as well as any other form of information represented as a string or structure of bits or bytes. The physical means of storing information may be electrostatic, ferroelectric, magnetic, acoustic, optical, chemical, electronic, electrical, or mechanical. A memory may be in a form of an Integrated Circuit (IC, a.k.a. chip or microchip). Alternatively or in addition, a memory may be in the form of a packaged functional assembly of electronic components (module). Such module may be based on a Printed Circuit Board (PCB) such as PC Card according to Personal Computer Memory Card International Association (PCMCIA) PCMCIA 2.0 standard, or a Single In-line Memory Module (SIMM) or a Dual In-line Memory Module (DIMM), standardized under the JEDEC JESD-21C standard. Further, a memory may be in the form of a separately rigidly enclosed box such as an external Hard-Disk Drive (HDD). Capacity of a memory is commonly featured in bytes (B), where the prefix ‘K’ is used to denote kilo=2¹⁰=1024¹=1024, the prefix ‘M’ is used to denote mega=2²⁰=1024²=1,048,576, the prefix ‘G’ is used to denote Giga=2³⁰=1024³=1,073,741,824, and the prefix ‘T’is used to denote tera=2⁴⁰=1024⁴=1,099,511,627,776.

As used herein, the term “Integrated Circuit” (IC) shall include any type of integrated device of any function where the electronic circuit is manufactured by the patterned diffusion of trace elements into the surface of a thin substrate of semiconductor material (e.g., Silicon), whether single or multiple die, or small or large scale of integration, and irrespective of process or base materials (including, without limitation Si, SiGe, CMOS and GAs) including, without limitation, applications specific integrated circuits (ASICs), field programmable gate arrays (FPGAs), digital processors (e.g., DSPs, CISC microprocessors, or RISC processors), so-called “system-on-a-chip” (SoC) devices, memory (e.g., DRAM, SRAM, flash memory, ROM), mixed-signal devices, and analog ICs.

The term “computer-readable medium” (or “machine-readable medium”) as used herein is an extensible term that refers to any medium or any memory, that participates in providing instructions to a processor for execution, or any mechanism for storing or transmitting information in a form readable by a machine (e.g., a computer). Such a medium may store computer-executable instructions to be executed by a processing element and/or software, and data that is manipulated by a processing element and/or software, and may take many forms, including but not limited to, non-volatile medium, volatile medium, and transmission medium. Transmission media includes coaxial cables, copper wire and fiber optics. Transmission media can also take the form of acoustic or light waves, such as those generated during radio-wave and infrared data communications, or other form of propagating signals (e.g., carrier waves, infrared signals, digital signals, etc.). Common forms of computer-readable media include, for example, a floppy disk, a flexible disk, hard disk, magnetic tape, or any other magnetic medium, a CD-ROM, any other optical medium, punch-cards, paper-tape, any other physical medium with patterns of holes, a RAM, a PROM, and EPROM, a FLASH-EPROM, any other memory chip or cartridge, a carrier wave as described hereinafter, or any other medium from which a computer can read.

The term “computer” is used generically herein to describe any number of computers, including, but not limited to personal computers, embedded processing elements and systems, software, ASICs, chips, workstations, mainframes, etc. Any computer herein may consist of, or be part of, a handheld computer, including any portable computer that is small enough to be held and operated while holding in one hand or fit into a pocket. Such a device, also referred to as a mobile device, typically has a display screen with touch input and/or miniature keyboard. Non-limiting examples of such devices include Digital Still Camera (DSC), Digital video Camera (DVC or digital camcorder), Personal Digital Assistant (PDA), and mobile phones and Smartphones. The mobile devices may combine video, audio and advanced communication capabilities, such as PAN and WLAN. A mobile phone (also known as a cellular phone, cell phone and a hand phone) is a device which can make and receive telephone calls over a radio link whilst moving around a wide geographic area, by connecting to a cellular network provided by a mobile network operator. The calls are to and from the public telephone network, which includes other mobiles and fixed-line phones across the world. The Smartphones may combine the functions of a personal digital assistant (PDA), and may serve as portable media players and camera phones with high-resolution touch-screens, web browsers that can access, and properly display, standard web pages rather than just mobile-optimized sites, GPS navigation, Wi-Fi and mobile broadband access. In addition to telephony, the Smartphones may support a wide variety of other services such as text messaging, MMS, email, Internet access, short-range wireless communications (infrared, Bluetooth), business applications, gaming and photography.

As used therein, the term “identifying” generally refers to the process of recognizing one or more of: the identity of an object, the nature of an object, a number of an object, a unique information or value assigned to the object, or any other information relating to the object which characterizes or identifies the object. As an example, identifying an object may include reading a number attached or assigned to the object which can uniquely identify the object or characterize the object. Thus, an entity of objects may be provided, each having a unique identifier, wherein the process of identifying the object can imply reading the unique identifier. As further used herein and in the following, an “identifier” can generally refer to an information carrier which can be capable of carrying information that uniquely identifies an object to which the identifier can be attached or assigned.

As used herein, the terms “program”, “programmable”, and “computer program” are meant to include any sequence or human or machine cognizable steps, which perform a function. Such programs are not inherently related to any particular computer or other apparatus, and may be rendered in virtually any programming language or environment, including, for example, C/C++, Fortran, COBOL, PASCAL, assembly language, markup languages (e.g., HTML, SGML, XML, VoXML), and the likes, as well as object-oriented environments such as the Common Object Request Broker Architecture (CORBA), Java™ (including J2ME, Java Beans, etc.) and the like, as well as in firmware or other implementations. Generally, program modules include routines, programs, objects, components, data structures, etc., that perform particular tasks or implement particular abstract data types.

The terms “task” and “process” are used generically herein to describe any type of running programs, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of reading the value, processing the value: the value must be obtained prior to processing it, although some of the associated processing may be performed prior to, concurrently with, and/or after the read operation). Any system, device, or method herein, may also be practiced in distributed computing environments where tasks are performed by remote processing devices that are linked through a communications network. In a distributed computing environment, program modules may be located in both local and remote memory storage devices.

Operating system. An Operating System (OS) is software that manages computer hardware resources and provides common services for computer programs. The operating system is an essential component of any system software in a computer system, and most application programs usually require an operating system to function. For hardware functions such as input/output and memory allocation, the operating system acts as an intermediary between programs and the computer hardware, although the application code is usually executed directly by the hardware and will frequently make a system call to an OS function or be interrupted by it. Common features typically supported by operating systems include process management, interrupts handling, memory management, file system, device drivers, networking (such as TCP/IP and UDP), and Input/Output (I/O) handling. Examples of popular modern operating systems include Android, BSD, iOS, Linux, OS X, QNX, Microsoft Windows, Windows Phone, and IBM z/OS.

As used herein, the term “data” means any indicia, signals, marks, symbols, domains, symbol sets, representations, and any other physical form or forms representing information, whether permanent or temporary, whether visible, audible, acoustic, electric, magnetic, electro-magnetic, or otherwise manifested. The term “data” is used to represent predetermined information in one physical form, encompassing any and all representations of corresponding information in a different physical form or forms.

As used herein, the term mechanical “attachment” or “connection” means and includes affixers, adherers, assemblers, bolts, bonds, buttons, carriers, cinches, clamps, clasps, clenchers, clinches, clips, connectors, contacts, couplers, epoxy, fasteners, fitters, fixers, glue, hangers, harnesses, interconnects, joiners, latches, leads, links, mounts, nails, paste, pegs, pins, reaffixers, reattachments, refasteners, refixers, resecurers, rivets, rods, screws, securers, staples, sticks, straps, solder, tabs, tacks, ties, uniters, or any other structure for attaching known in the art. Accordingly, the term mechanically “attach” or “connect” as used herein, means and includes affix, adhere, assemble, bolt, bond, button, carry, cinch, clamp, clasp, clench, clinch, clip, connect, contact, couple, epoxy, fasten, fit, fix, glue, hang, harness, interconnect, join, latch, lead, link, mount, nail, paste, peg, pin, reaffix, reattach, refasten, refix, resecure, rivet, screw, secure, solder, staple, stick, strap, tab, tack, tie, unite, or other technique or action for attaching known in the art.

Any software or firmware herein may comprise an operating system that may be a mobile operating system. The mobile operating system may consist of, may comprise, may be according to, or may be based on, Android version 2.2 (Froyo), Android version 2.3 (Gingerbread), Android version 4.0 (Ice Cream Sandwich), Android Version 4.2 (Jelly Bean), Android version 4.4 (KitKat)), Apple iOS version 3, Apple iOS version 4, Apple iOS version 5, Apple iOS version 6, Apple iOS version 7, Microsoft Windows® Phone version 7, Microsoft Windows® Phone version 8, Microsoft Windows® Phone version 9, or Blackberry® operating system. Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

Any apparatus herein, may be a client device that may typically function as a client in the meaning of client/server architecture, commonly initiating requests for receiving services, functionalities, and resources, from other devices (servers or clients). Each of the these devices may further employ, store, integrate, or operate a client-oriented (or end-point dedicated) operating system, such as Microsoft Windows® (including the variants: Windows 7, Windows XP, Windows 8, and Windows 8.1, available from Microsoft Corporation, headquartered in Redmond, Washington, U.S. A.), Linux, and Google Chrome OS available from Google Inc. headquartered in Mountain View, California, U.S. A. Further, each of the these devices may further employ, store, integrate, or operate a mobile operating system such as Android (available from Google Inc. and includes variants such as version 2.2 (Froyo), version 2.3 (Gingerbread), version 4.0 (Ice Cream Sandwich), Version 4.2 (Jelly Bean), and version 4.4 (KitKat), iOS (available from Apple Inc., and includes variants such as versions 3-7), Windows® Phone (available from Microsoft Corporation and includes variants such as version 7, version 8, or version 9), or Blackberry® operating system (available from BlackBerry Ltd., headquartered in Waterloo, Ontario, Canada). Alternatively or in addition, each of the devices that are not denoted herein as a server, may equally function as a server in the meaning of client/server architecture. Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure.

All publications, standards, patents, and patent applications cited in this specification are incorporated herein by reference as if each individual publication, patent, or patent application were specifically and individually indicated to be incorporated by reference and set forth in its entirety herein.

1. An additive manufacturing method for adding a layer to a Three-Dimensional (3D) object that includes a vertical cavity that defines top and bottom openings and that serves as a pathway for a light-cured resin fluid, the method comprising:
obtaining a layer data that defines an area to be added onto the 3D object;
dispensing, using a pump, the light-cured resin fluid to the bottom opening for outputting and spreading from the top opening; and
curing, by a light beam, at least part of the output and spread light-cured resin fluid according to the area, while keeping the top opening non-cured, so that resin can be passed via the cavity, so that the layer is added after the curing.

2. The method according to claim 1, wherein an 3D object data or the layer data is in STereoLithography (STL), Additive Manufacturing File Format (AMF), G-code, Standard for the Exchange of Product model data (STEP), or Initial Graphics Exchange Specification (IGES) format.

3. The method according to claim 1, wherein the curing comprises photopolymerization of the resin fluid.

4. The method according to claim 1, wherein the 3D object is formed by curing the resin fluid by a light source.

5. The method according to claim 1, wherein at least part of, or whole of, the 3D object is not formed by curing the resin fluid by the light source.

6. The method according to claim 1, further for adding an additional layer, the method comprising:
obtaining an additional layer data that defines an additional area to be added onto the 3D object;
dispensing, using a pump, an additional light-cured resin fluid to the bottom opening to be output from the top opening; and
curing, by the light beam, at least part of the output and spread light-cured resin fluid according to the additional area, while keeping the top opening non-cured, so that resin can be passed via the cavity, so that the additional layer is added after the curing.

7. The method according to claim 1, wherein the resin fluid is of a first type and that is stored in a first container, for use with an additional resin fluid of a second type that is stored in second container, for use with an additional vertical cavity that defines an additional top opening and an additional bottom opening, wherein the dispensing comprises:
dispensing, the resin fluid of the first type from the first container to the bottom opening, and
dispensing, the additional resin fluid of the second type from the second container to the additional bottom opening.

8. (canceled)

9. The method according to claim 1, wherein the resin fluid is of a first type and that is stored in a first container, and for use with an additional resin fluid of a second type that is stored in second container, wherein the dispensing comprises:
dispensing, the resin fluid of the first type from the first container to the bottom opening, and
dispensing, the additional resin fluid of the second type from the second container to the bottom opening.

10-17. (canceled)

18. The method according to claim 1, further for use with multiple types of light-cured resin fluids, wherein the dispensing comprises dispensing at least two types of the light-cured resin fluids.

19. The method according to claim 1, further for use with multiple types of light-cured resin fluids, the method further comprising selecting a first type from the multiple types, and wherein the dispensing comprises dispensing the selected first type of the light-cured resin fluid.

20-33. (canceled)

34. The method according to claim 1, further for use with a 3D model data by a Computer-Aided Design (CAD) system.

35-37. (canceled)

38. The method according to claim 1, further comprising partitioning the obtained layer data into multiple overlapping or non-overlapping area parts.

39-58. (canceled)

59. The method according to claim 1, wherein the curing comprises generating the light beam for the curing.

60-78. (canceled)

79. The method according to claim 1, wherein the curing comprises generating the light beam for the curing and forming a light spot on the area of the resin fluid output.

80-84. (canceled)

85. The method according to claim 1, wherein the 3D object is placed on an upper flat horizontal surface of a plate.

86-112. (canceled)

113. The method according to claim 1, wherein the 3D object further comprises an additional vertical cavity that defines additional top and additional bottom openings, the method further comprising:
obtaining an additional layer data that defines an additional area to be added onto the 3D object;
dispensing, using the pump, an additional light-cured resin fluid to the additional bottom opening for outputting and spreading from the additional top opening; and
curing, by the light beam, at least part of the output and spread additional light-cured resin fluid according to the additional area, while keeping the additional top opening non-cured, so that the additional resin can be passed via the additional cavity, so that the additional layer is added after the curing.

114. The method according to claim 1, wherein the 3D object further comprises multiple vertical cavities, each defines a respective top opening and a respective bottom opening, the method further comprising:
obtaining a respective layer data that defines a respective area to be added onto each of the 3D object;
dispensing, using the pump, light-cured resin fluid to the multiple bottom openings for outputting and spreading from the multiple top openings; and
curing, by the light beam, at least part of the output and spread light-cured resin fluid according to the respective areas, while keeping the multiple top openings non-cured, so that the resin can be passed via the multiple cavities, so that the respective layer is added after the curing.

115. The method according to claim 1, further for adding a layer to an additional object that includes an additional vertical cavity that defines additional top and additional bottom openings, the method further comprising:
obtaining an additional layer data that defines an additional area to be added onto the additional 3D object;
dispensing, using the pump, an additional light-cured resin fluid to the additional bottom opening for outputting and spreading from the additional top opening; and
curing, by the light beam, at least part of the output and spread additional light-cured resin fluid according to the additional area, while keeping the additional top opening non-cured, so that the additional resin can be passed via the additional cavity, so that the additional layer is added after the curing.

116. The method according to claim 1, further for adding a layer to each of multiple objects that each includes a respective vertical cavity that defines a respective top opening and a respective bottom opening, the method further comprising:
obtaining a respective layer data that defines a respective area to be added onto each of the multiple 3D objects;
dispensing, using the pump, light-cured resin fluid to the multiple bottom openings for outputting and spreading from the multiple top openings; and
curing, by the light beam, at least part of the output and spread light-cured resin fluid according to the respective areas, while keeping the multiple top openings non-cured, so that the resin can be passed via the multiple cavities, so that the respective layer is added after the curing.

117-123. (canceled)

124. The method according to claim 1, wherein the curing comprises toughening or hardening of a polymer material by cross-linking of polymer chains.

125-218. (canceled)
